(19) United States
(12) Patent Application Publication
(10) Pub. No.: US 2026/0005812 A1
(43) Pub. Date: Jan. 1, 2026

(54) Base Station Predicted Measurement Frequency Range

(71) Applicant: Ofinno, LLC, Reston, VA (US)

(72) Inventors: Muhammad Ali Kazmi, Reston, VA (US); Stanislav Filin, Chantilly, VA (US); Esmael Hejazi Dinan, McLean, VA (US); Gautham Prasad, Herndon, VA (US); Hua Zhou, Vienna, VA (US); Hyoungsuk Jeon, Centreville, VA (US); Kyungmin Park, Vienna, VA (US); Taehun Kim, Fairfax, VA (US); Ali Cagatay Cirik, Chantilly, VA (US); Jian Xu, McLean, VA (US)

(21) Appl. No.: 19/255,172

(22) Filed: Jun. 30, 2025

Related U.S. Application Data
(60) Provisional application No. 63/666,127, filed on Jun. 29, 2024.

(51) Int. Cl. H04L 5/00; H04L 41/16

(52) U.S. Cl. CPC H04L 5/0048; H04L 5/0098; H04L 41/16

(57) ABSTRACT

A method comprises transmitting, by a first node to a second node, a message indicating one or more of: a reference frequency, of a reference signal, for a reference measurement by a third node hosted by the first node, and one or more frequencies for one or more predicted measurements, by the third node, based on the reference measurement. The method further comprises receiving, by the first node from the second node, a response to the message.

### CROSS-REFERENCE TO RELATED APPLICATIONS

This application claims the benefit of U.S. Provisional Application No. 63/666,127, filed Jun. 29, 2024, which is hereby incorporated by reference in its entirety.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates an aspect of an example embodiment according to the present disclosure.

FIG. 18 illustrates an aspect of an example embodiment according to the present disclosure.

FIG. 19 illustrates an aspect of an example embodiment according to the present disclosure.

FIG. 20 illustrates an aspect of an example embodiment according to the present disclosure.

FIG. 21 illustrates an aspect of an example embodiment according to the present disclosure.

FIG. 22 illustrates an aspect of an example embodiment according to the present disclosure.

FIG. 23 illustrates an aspect of an example embodiment according to the present disclosure.

FIGS. 24A and 24B illustrate aspects of example embodiments according to the present disclosure.

FIG. 25 illustrates an aspect of an example embodiment according to the present disclosure.

FIG. 26 illustrates an aspect of an example embodiment according to the present disclosure.

FIG. 27 illustrates an aspect of an example embodiment according to the present disclosure.

FIG. 28 illustrates an aspect of an example embodiment according to the present disclosure.

FIG. 29 illustrates an aspect of an example embodiment according to the present disclosure.

FIGS. 30A and 30B illustrate aspects of example embodiments according to the present disclosure.

FIGS. 31A and 31B illustrate aspects of example embodiments according to the present disclosure.

FIGS. 32A and 32B illustrate aspects of example embodiments according to the present disclosure.

FIGS. 33A and 33B illustrate aspects of example embodiments according to the present disclosure.

FIGS. 34A and 34B illustrate aspects of example embodiments according to the present disclosure.

FIG. 35 illustrates an aspect of an example embodiment according to the present disclosure.

FIG. 36 illustrates an aspect of an example embodiment according to the present disclosure.

FIG. 37 illustrates an aspect of an example embodiment according to the present disclosure.

FIG. 38 illustrates an aspect of an example embodiment according to the present disclosure.

FIGS. 39A and 39B illustrate aspects of example embodiments according to the present disclosure.

FIGS. 40A and 40B illustrate aspects of example embodiments according to the present disclosure.

FIG. 41 illustrates an aspect of an example embodiment according to the present disclosure.

FIG. 42 illustrates an aspect of an example embodiment according to the present disclosure.

FIG. 43 illustrates a flowchart of an aspect of an example embodiment according to the present disclosure.

FIG. 44 illustrates a flowchart of an aspect of an example embodiment according to the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect or implement the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

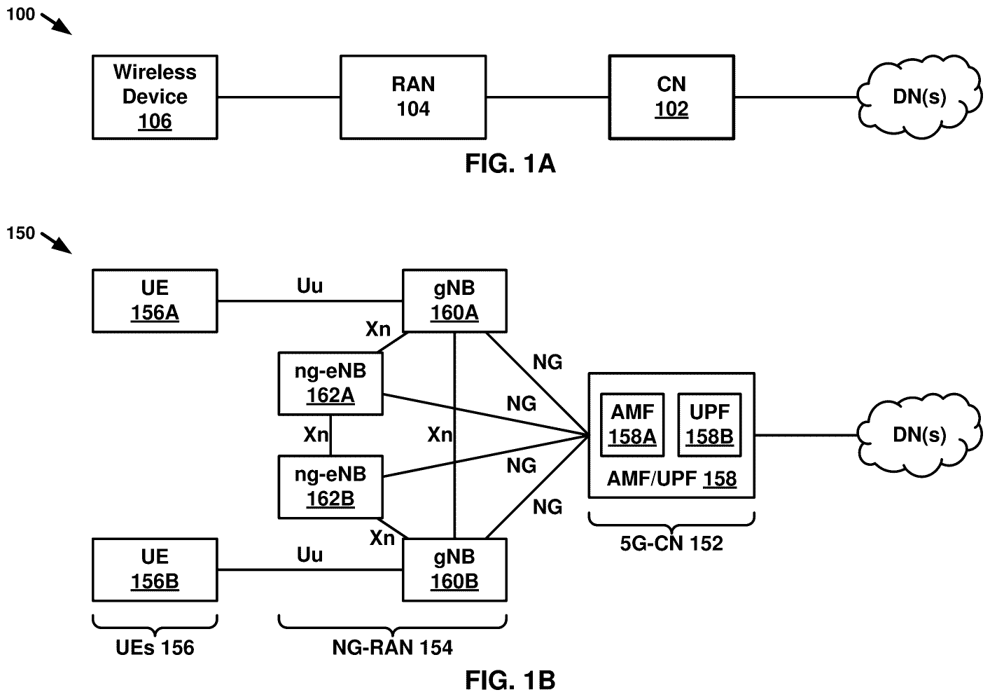

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNS), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QOS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

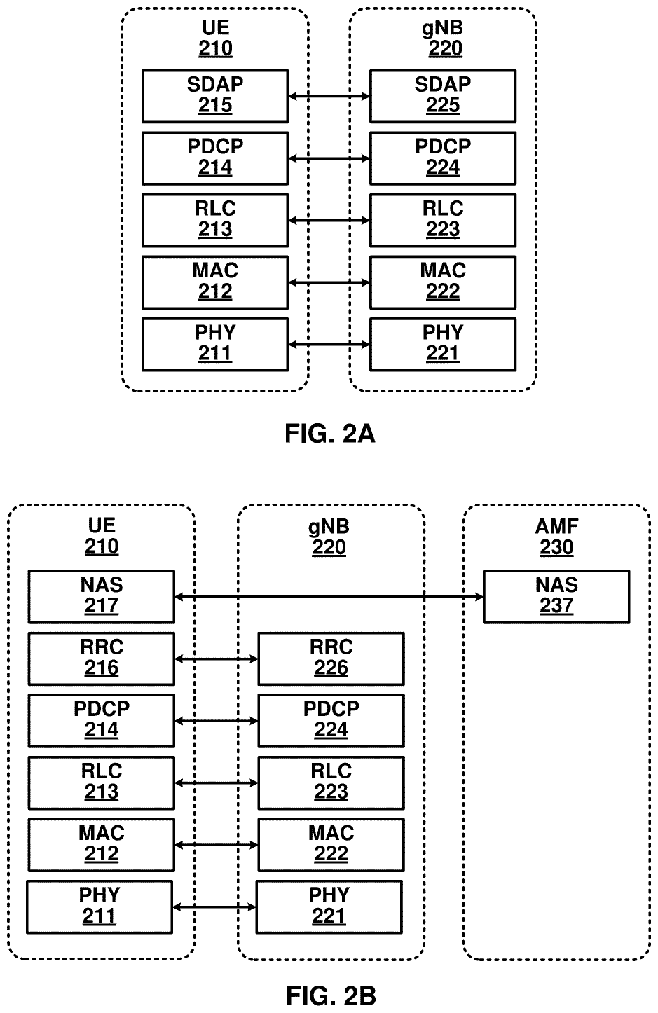

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

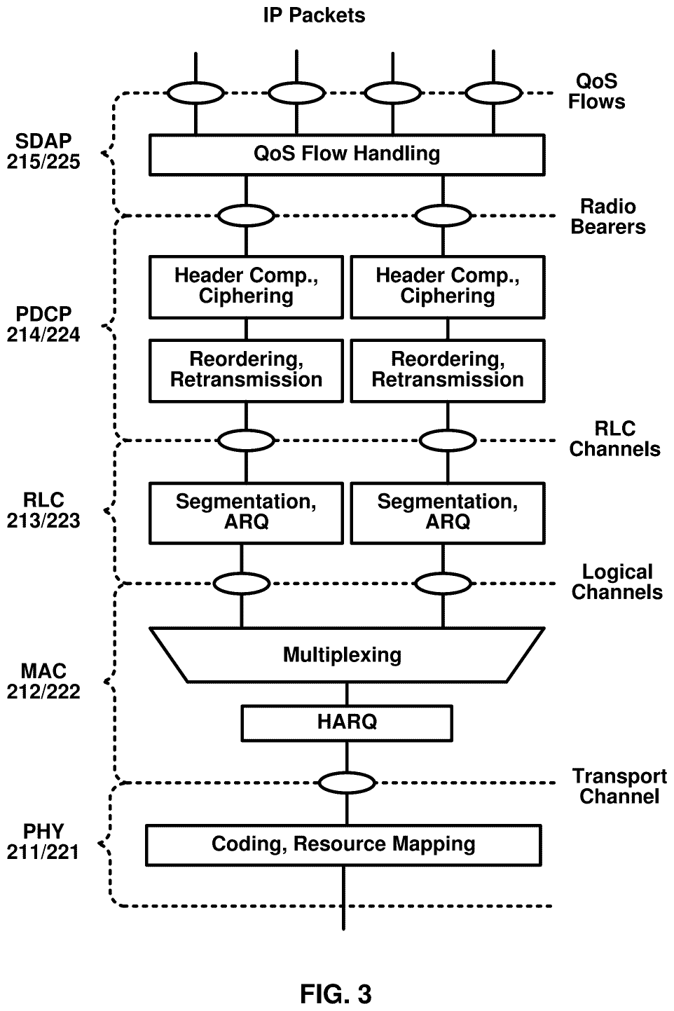

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

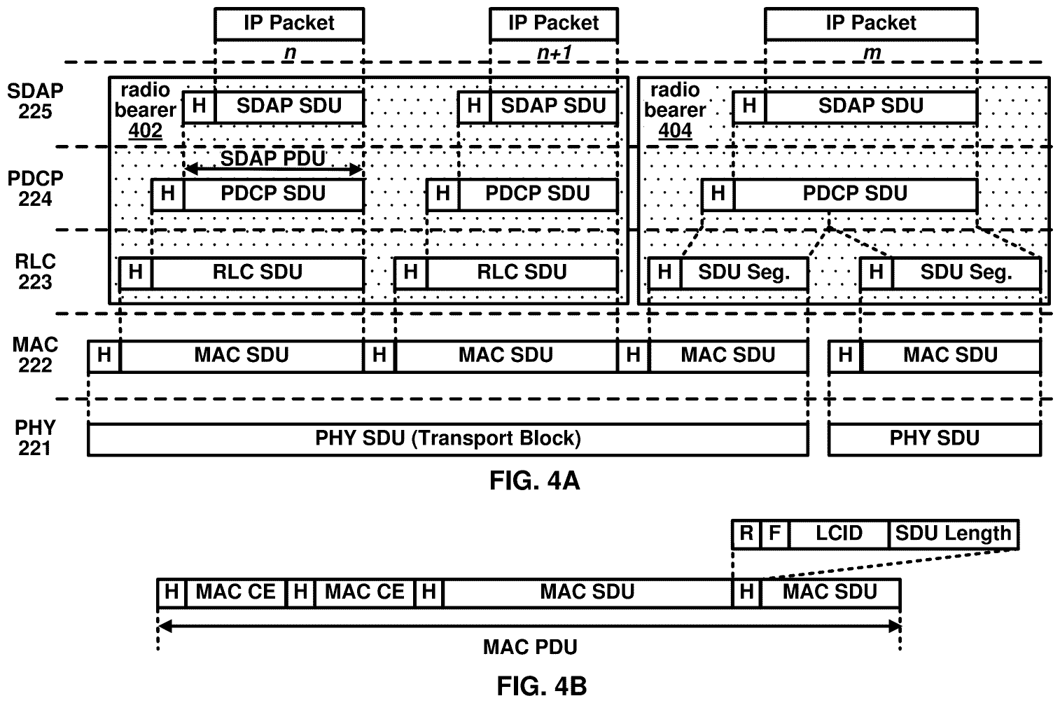

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

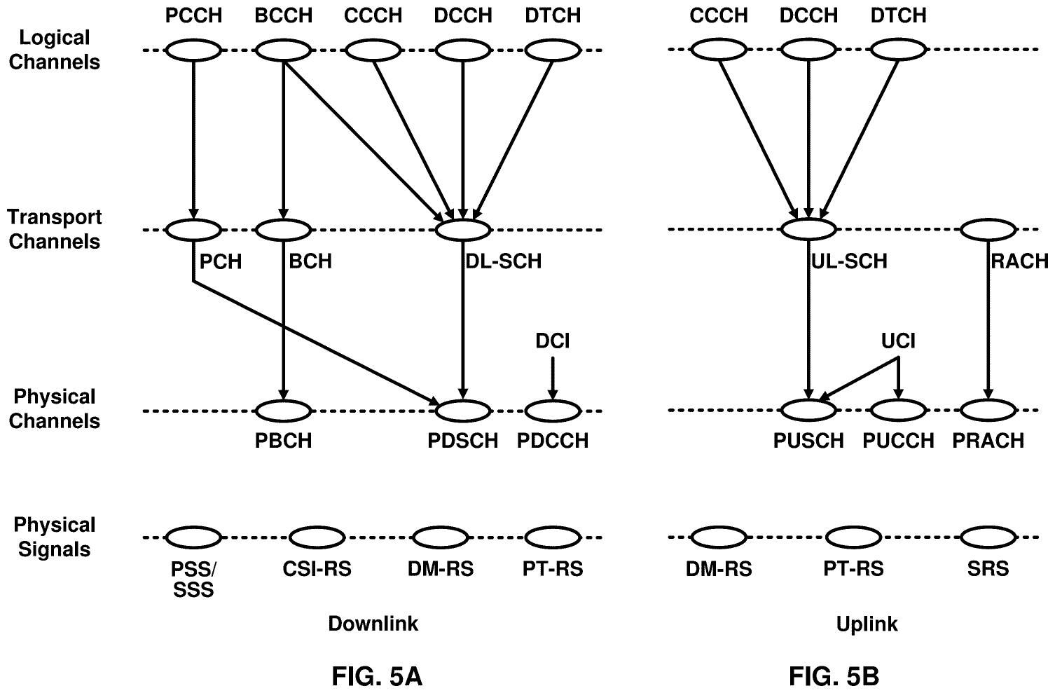

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

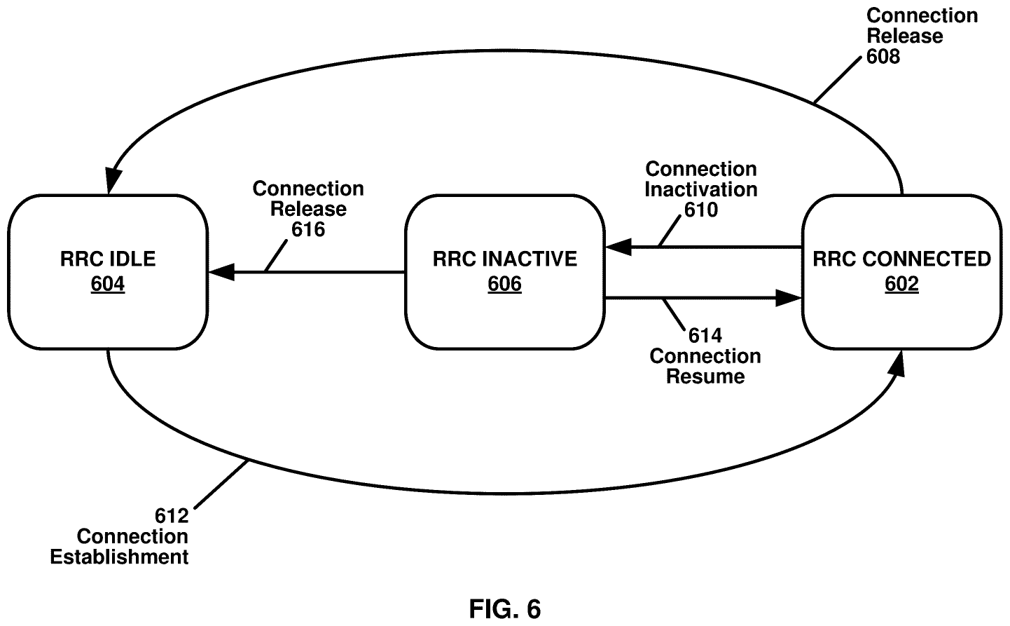

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

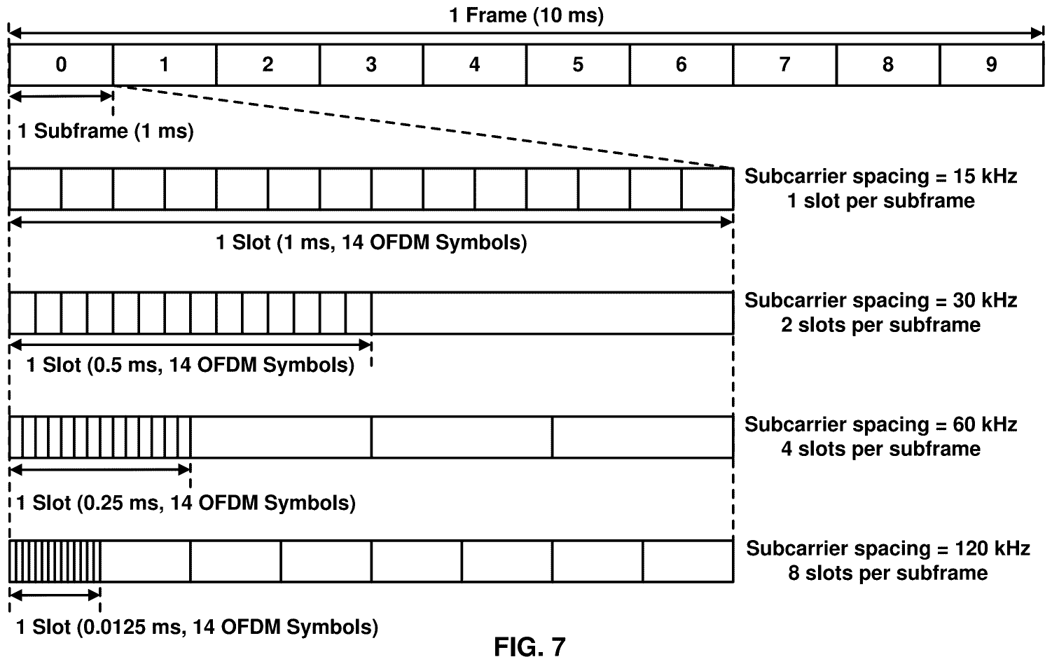

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 KHz/2.3 μs; 60 KHz/1.2 μs; 120 KHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 KHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

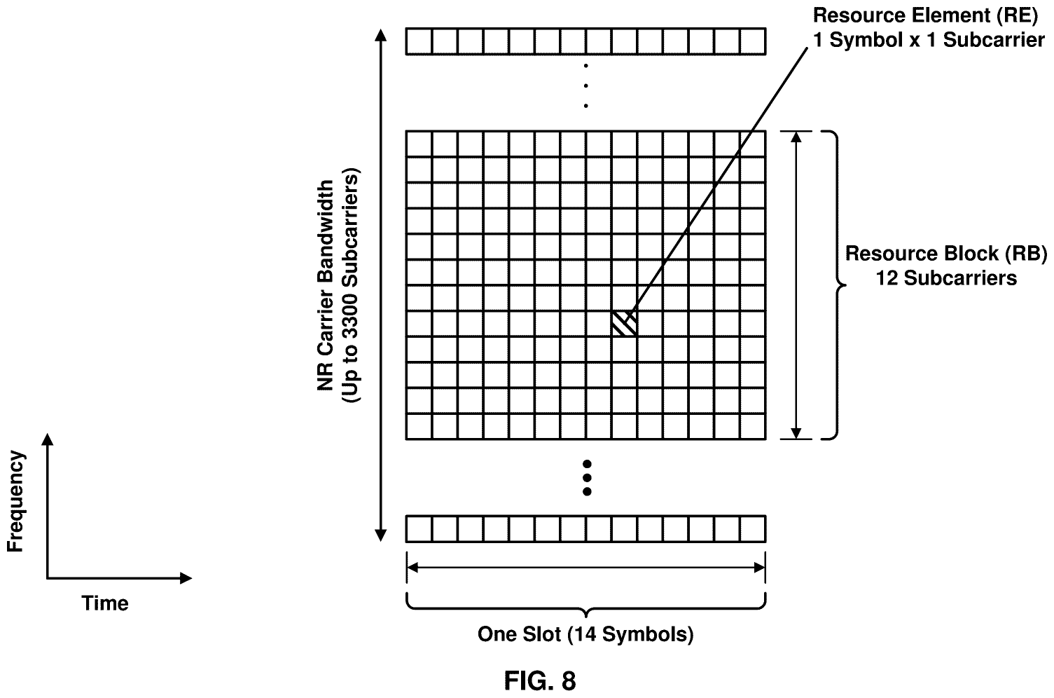

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 KHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

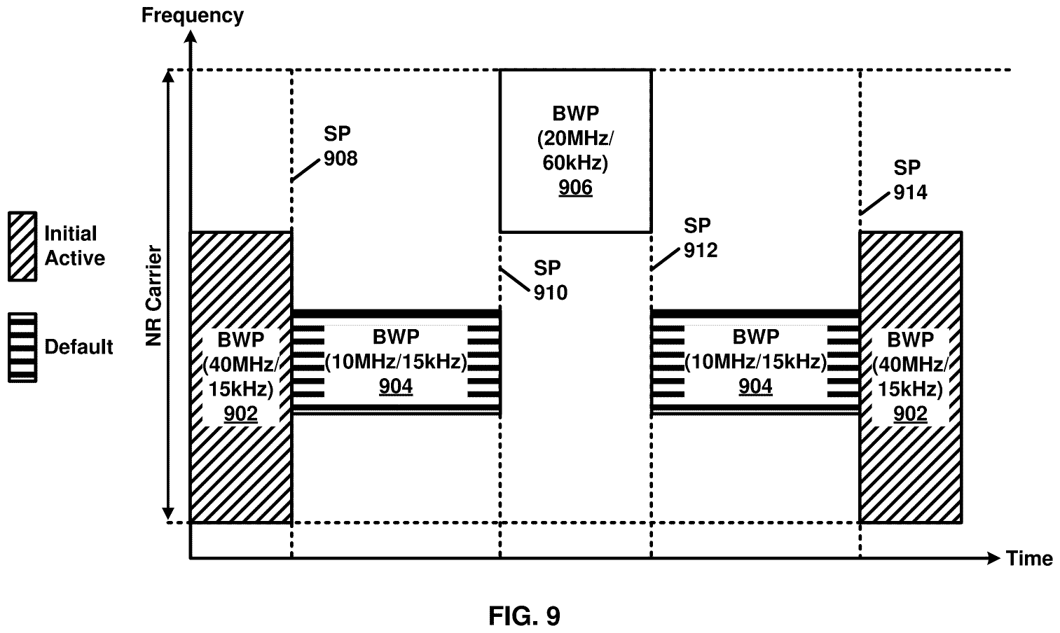

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

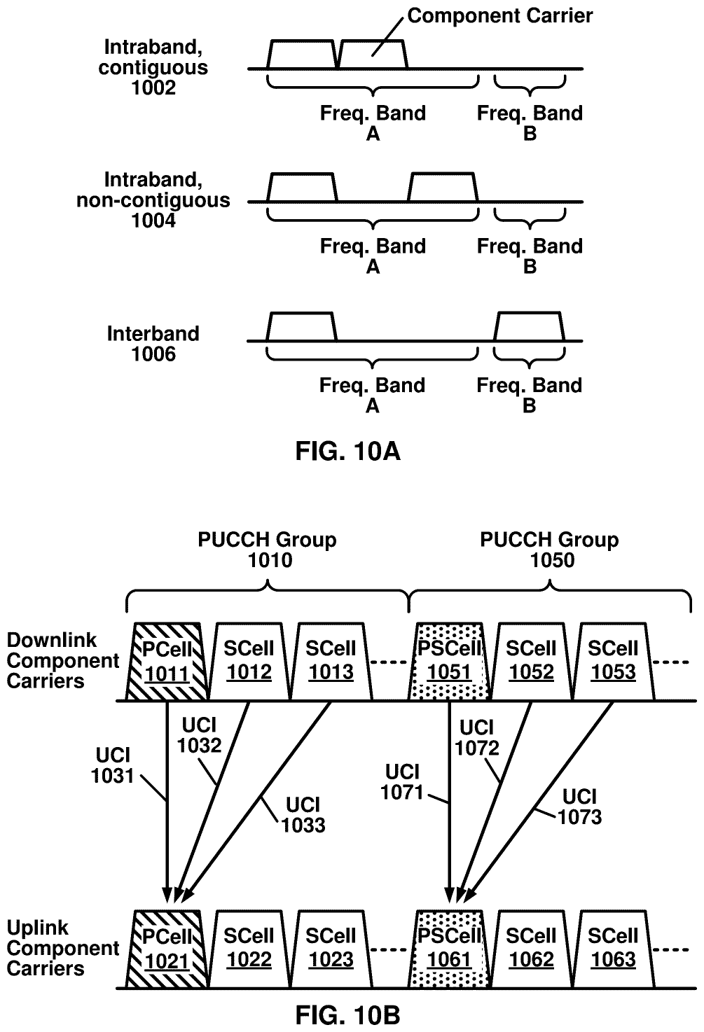

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

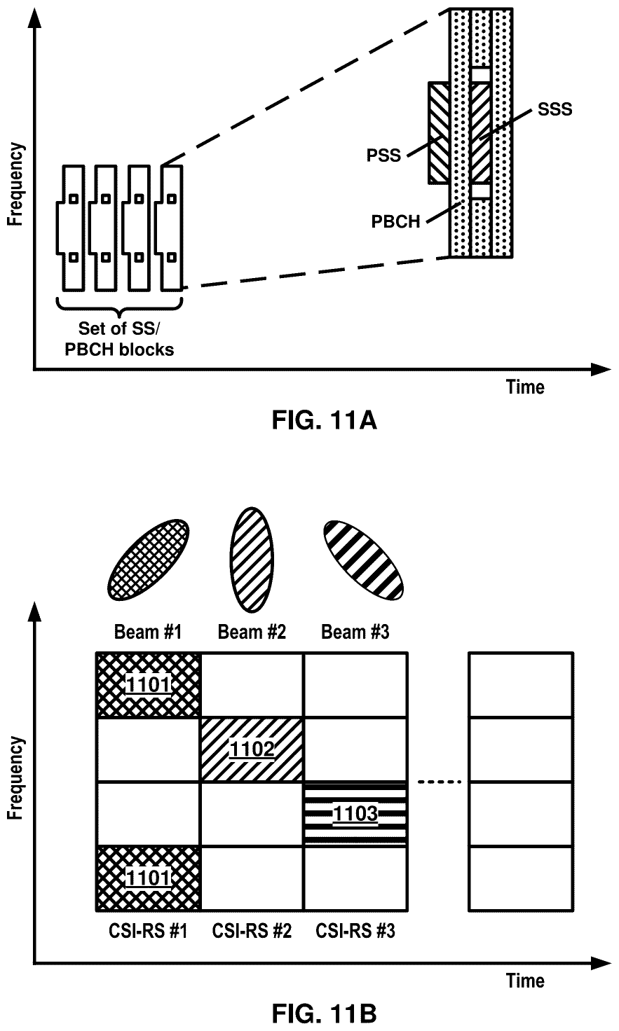

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g., a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g., maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

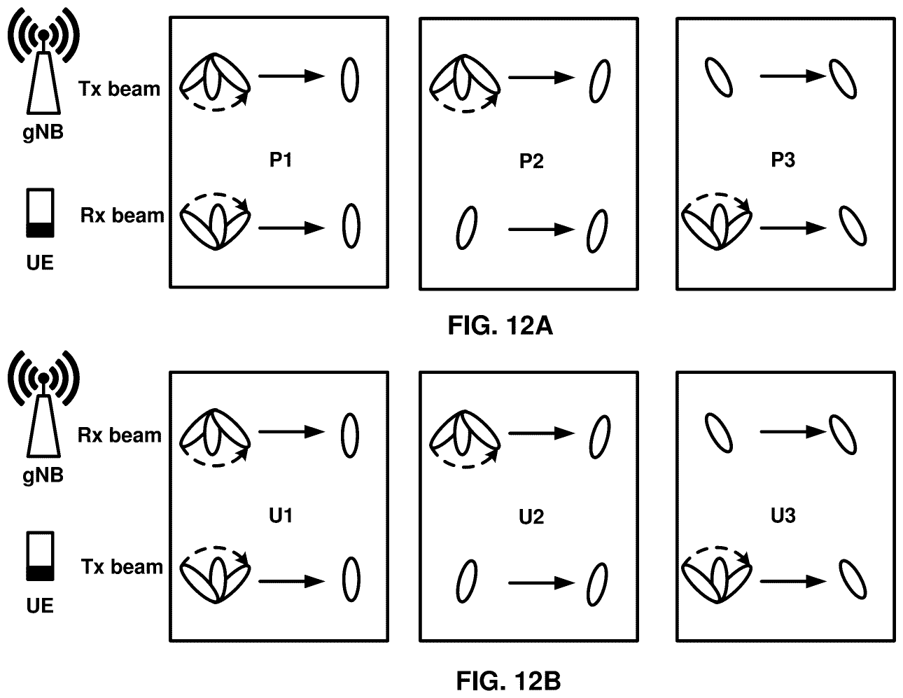

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

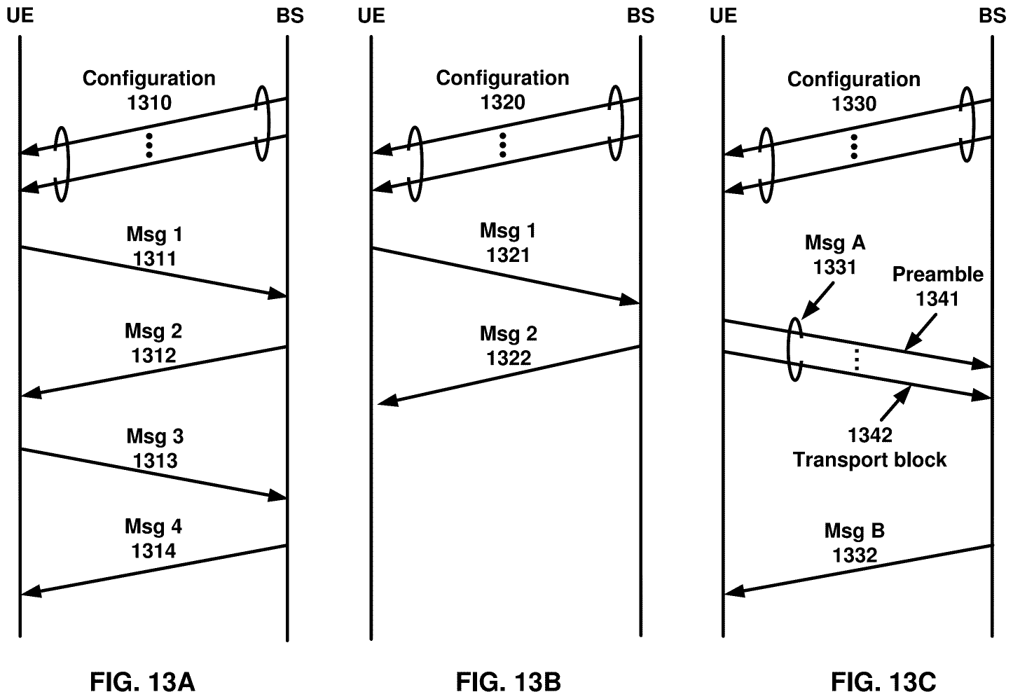

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

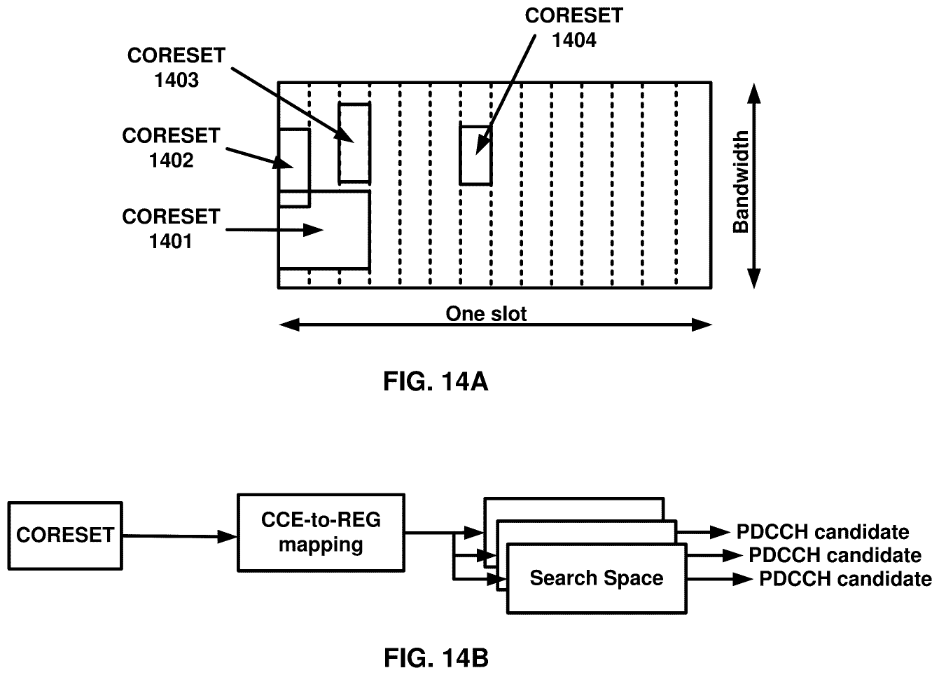

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g., a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

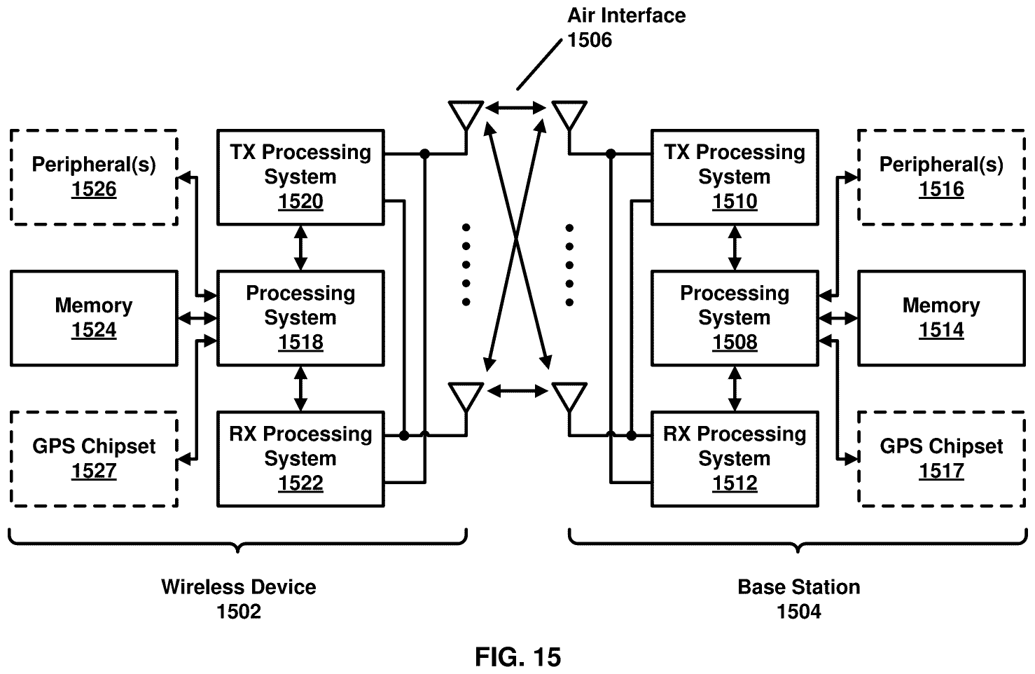

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

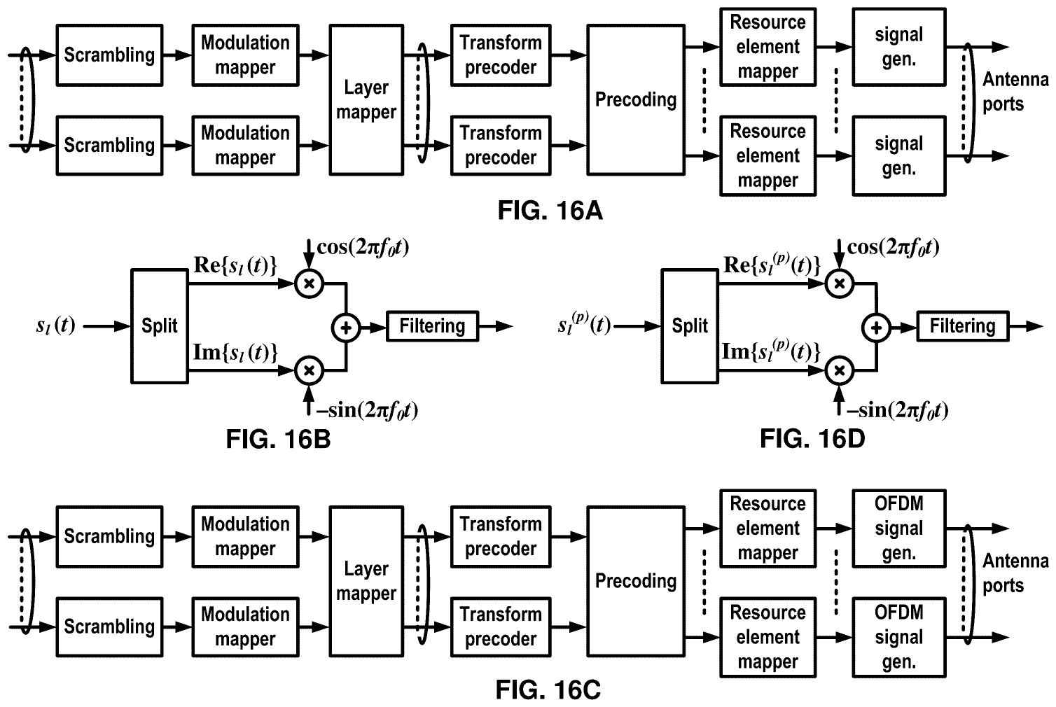

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g., RRC messages) comprising configuration parameters of a plurality of cells (e.g., primary cell, secondary cell). The wireless device may communicate with at least one base station (e.g., two or more base stations in dual connectivity) via the plurality of cells. The one or more messages (e.g., as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g., the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry (or expiration) of a random access response window timer, the time difference between two time stamps may be used. When a timer is restarted, a process for measurement of time window may be restarted. Other example implementations may be provided to restart a measurement of a time window.

Artificial intelligence (AI) and/or machine learning (ML) (AI/ML) is a data driven algorithm, scheme, or mechanism. An AI/ML model may apply one or more AI/ML techniques for generating a set of outputs based on a set of inputs. For example, a wireless device may use training data for generating a set of outputs based on the training data. The training data may also be referred to as trained data or data for training. The generating may also be referred to as producing, creating, or forming the set of outputs.

The wireless device may use the AI/ML model, e.g., based on one or more AI/ML techniques. In the present disclosure, an AI/ML model may be referred to as an ML model and AI/ML techniques may also be referred to as machine learning techniques. Examples of AI/ML techniques are federated learning, reinforcement learning, supervised learning, unsupervised learning, etc. Federated learning may also be referred to as a federated training.

In an example, a federated learning technique may train an AI/ML model across multiple decentralized nodes (e.g., wireless devices, base stations etc.). Each node may locally train a model based on local data samples. The federated learning technique may require multiple interactions of the model.

In an example, a reinforcement learning technique may train an AI/ML model from an input, and a feedback signal resulting from the AI/ML model's output.

In an example, a supervised learning technique may train an AI/ML model from an input, and labels associated with the input data.

In an example, an unsupervised learning technique may train an AI/ML model from an input without labelled data.

In an example, an AI/ML model may also be referred to as a model. In an example, an AI/ML model may also be referred to as a radio procedure. In an example, a radio procedure may also be referred to as a radio access communication (RAC), a measurement procedure, a positioning procedure, a radio link procedure. A measurement procedure may comprise a layer-3 measurement procedure, a mobility measurement procedure etc. A positioning procedure may also be referred to as a positioning measurement procedure. A radio link procedure may comprise a radio link monitoring (RLM) procedure, or a beam management (BM) procedure. A BM procedure may also be referred to as a link recovery procedure (LRP).

In an example, a wireless device may use one or more AI/ML models for inferring data based on trained data. An AI/ML model used by a wireless device for inferring data may also be referred to as a single-sided, one-sided, or a wireless device-sided model. In another example, a base station may use one or more AI/ML models for inferring data based on trained data. An AI/ML model used by a base station for inferring data may also be referred to as a single-sided, a one-sided, or a base station-sided model. In an example, the set of data for training or trained data may be a set of measurement samples. In an example, the inferring data may comprise predicting one or more data. The predicting the one or more data may also be referred to as determining, identifying or estimating the one or more data.

In an example, a base station may infer data based on an AI/ML model. An AI/ML model used by a wireless device for inferring data may be referred to as a base station-side model. A base station-side model may be referred to as a base station-based model.

In an example, a wireless device and a base station may jointly infer data based on their respective AI/ML models. An AI/ML model used by a wireless device and a base station for jointly inferring data may be referred to as a two-sided model. A two-sided model may also be referred to as a double-sided model. In an example of the two-sided model, a part of the data is inferred by a wireless device and a part of the data is inferred by a base station. In an example of a two-sided model, a wireless device may use an AI/ML model based encoder to generate data. The wireless device may transmit, to a base station, the generated data. An example of the generated data may comprise a compressed CSI. The base station may use an AI/ML model based decoder to decode the received data.

A wireless device may communicate with a base station based on the AI/ML model. For example, the wireless device may transmit one or more message to the base station based on the data inferred from the AI/ML model as discussed above.

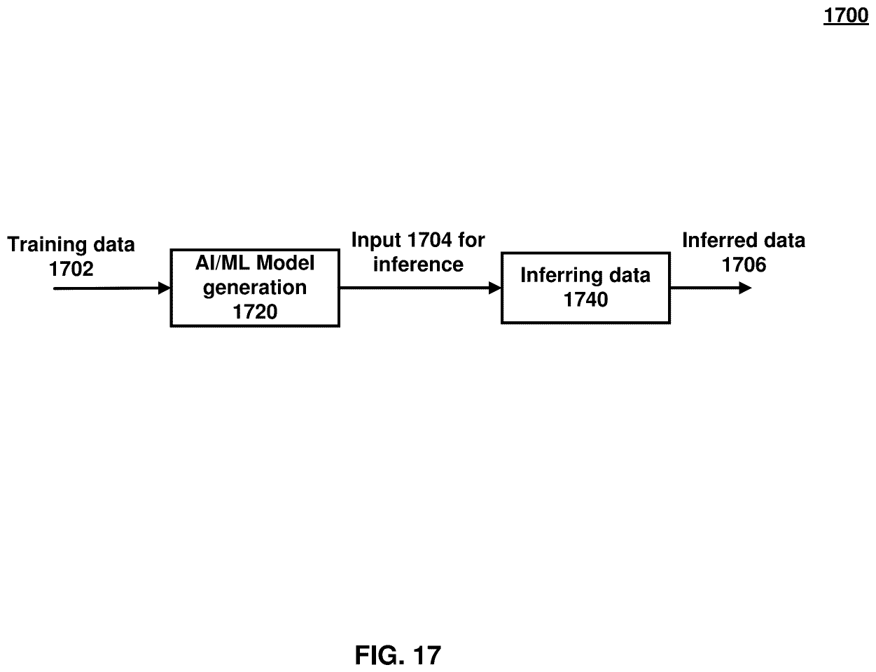

FIG. 17 illustrates an example of using an AI/ML model 1700 per an aspect of the present disclosure. For example, FIG. 17 illustrates different stages comprising, or involving, AI/ML model 1700. A stage may refer to as a mode, a level, a step, an entity, or a unit. The different stages comprising AI/ML model 1700 may also be referred to as involving, or belonging to, AI/ML model 1700. A stage of the different stages may be for generating AI/ML model 1700. A stage of the different stages may be for inference procedure for inferring data based on AI/ML model 1700.

As illustrated in FIG. 17, AI/ML model 1700 comprises an AI/ML model generation stage 1720 and an inferring data stage 1740. In an example as shown in FIG. 17, AI/ML model generation stage 1720, of AI/ML model 1700, may receive training data 1702. AI/ML model generation stage 1720 may also be referred to as an AI/ML model generating stage or an AI/ML model generating level. AI/ML model generation stage 1720 may generate an output data used for inferring data. Inferring data may also be referred to as inferring a result. Inferring data may also be referred to as predicting data, estimating data, determining data, forecasting data, or presuming data. As illustrated in FIG. 17, the output data for inferring data may be, or comprise, an input 1704 for inference. In the example in FIG. 17, inferring data stage 1708 may receive input 1704 from AI/ML model generation stage 1720. Inferring data stage 1740 may generate inferred data 1706 based on input received from AI/ML model generating stage 1720. Generating inferred data 1706 may be referred to as inferring data.

In an example, a wireless device inferring data based on the model for a radio procedure may comprise inferring a CSI e.g., a channel quality indicator (CQI), a rank indicator (RI), a precoding matrix indicator (PMI) etc. In an example, a wireless inferring or predicting the CSI may comprise predicting the CSI in time domain. In an example, a wireless inferring the CSI may comprise inferring the CSI in spatial-frequency domain. In an example, the wireless device may further transmit, to the base station, the inferred CSI.

In an example, a wireless device inferring data based on the model for a radio procedure may comprise inferring or predicting a spatial-domain downlink beam and/or a temporal downlink beam. The spatial-domain downlink beam prediction may leverage measurement outcomes from a designated set of downlink beams, denoted as ‘Set B,’ to predict the best beam within another set of downlink beams, referred to as ‘Set A,’ at the present moment. The temporal downlink beam prediction may harness historical measurement results derived from ‘Set B’ to anticipate the best beam in ‘Set A’ for one or more future time instances. In an example, an input to an AI/ML model for the spatial-domain or temporal downlink beam prediction may be layer 1 reference signal received power (L1-RSRP) measurements of beams within ‘Set B.’ In an example, an output from the AI/ML model may be the predicted top-K beams in ‘Set A.’ The AI/ML model training and inference may reside at the base station (e.g. gNB) side or at the wireless device side. In the former case, the wireless device may measure the L1-RSRP measurements for the beams within ‘Set B’. The wireless device may report, to the base station, the L1-RSRP measurements for the beams within ‘Set B’. In the latter case, the wireless device may predict the beams. The wireless device may further report, to the base station, the predicted beams.

In an example, a base station inferring data based on the model for a radio procedure may comprise inferring a measurement. Examples of the measurements may be a secondary synchronization signal (SSS) transmit power, an uplink (UL) Relative Time of Arrival (T_{UL-RTOA}), a base station Rx-Tx time difference (e.g., a gNB Rx-Tx time difference), a round trip time, an angle of arrival (AoA) (e.g., an UL AoA), an angle of departure (AoD) (e.g., a DL AoD), a reference signal received power (RSRP), a path loss, an uplink sounding reference signal-reference signal received power (UL SRS-RSRP), an UL SRS reference signal received path power (UL SRS-RSRPP), a Timing advance (T_{ADV}), a carrier phase measurement (CPP), an uplink reference signal carrier phase (UL RSCP), a channel impulse response (CIR), a delay profile (DP), a power delay profile (PDP), a signal to noise ratio (SNR), a signal to interference and noise ratio (SINR) etc. In an example, a base station inferring or predicting a measurement may comprise predicting or inferring the measurement in time domain, spatial domain, and/or frequency domain. In an example, the base station may further transmit, to another node (e.g., another base station, a location server, a core network node etc), the inferred measurement.

A life cycle management (LCM) of an AI/ML model may comprise developing, deploying, managing or maintaining an AI/ML model. In an example, an LCM of an AI/ML model involves performing one or more LCM procedures on the AI/ML model. In an example, an LCM procedure may comprise performing at least one of: an identification of the AI/ML model, a selection of an AI/ML model, an activation of the AI/ML model, a deactivation of the AI/ML, a fallback from the AI/ML model to a measurement procedure, a switching from a measurement procedure to the AI/ML model, a switch from the AI/ML model to another AI/ML model, a release of the AL/ML model, a monitoring of the AI/ML model, and a modification of one or more parameters of the AI/ML model.

In an example, a wireless device may use a measurement procedure for obtaining a measurement. In an example, a base station may use a measurement procedure for obtaining a measurement. The using the measurement procedure may also be referred to as applying the measurement procedure. The obtaining a measurement may also be referred to as performing the measurement. In an example, a measurement procedure may comprise performing a measurement based on a signal. In an example, a measurement procedure in a wireless device may comprise performing a measurement based on a signal transmitted by and/or received by the wireless device. In an example, the signal may comprise a reference signal. In an example, a measurement procedure in a base station may comprise performing a measurement based on a signal transmitted by and/or received by the base station. In an example, the signal may comprise a reference signal.

In an example, performing an LCM procedure may comprise: identifying an AI/ML model; and/or selecting an AI/ML model; and/or activating an AI/ML model; and/or deactivating an AI/ML model; and/or falling back from an AI/ML model to using a measurement procedure; and/or switching from using a measurement procedure to an AI/ML model; and/or switching from an AI/ML model to another AI/ML model; monitoring an AI/ML model; releasing an AI/ML model; and/or modifying one or more parameters of an AI/ML model.

In an example, a wireless device may perform an LCM procedure on an AI/ML model stored in the wireless device.

In an example, a base station may perform an LCM procedure on an AI/ML model stored in the base station.

The LCM procedure may be a functionality-based LCM. Corresponding to the functionality-based LCM procedure, a base station may configure a wireless device to perform the LCM procedure for an AI/ML model stored in the wireless device. In an example, a base station may configure a wireless device to perform the LCM procedure by RRC. In an example, a base station may configure a wireless device to perform the LCM procedure by MAC-CE. In an example, a base station may configure a wireless device to perform the LCM procedure by DCI. In some aspects, a mechanism for the base station to configure the wireless device with the LCM procedure may also be referred to as the functionality based LCM. The mechanism for the base station to configure the wireless device with the LCM procedure may also be referred as a procedure or protocol.

In an example, a wireless device may interrupt a communication between the wireless device and a base station (e.g., at least partially) during an LCM procedure. In an example, an interruption of the communication may comprise, the wireless device not receiving a signal from the base station, and/or the wireless device not transmitting a signal to the base station. In an example, a wireless device not transmitting a signal may also be referred to as dropping, discarding, or cancelling a signal.

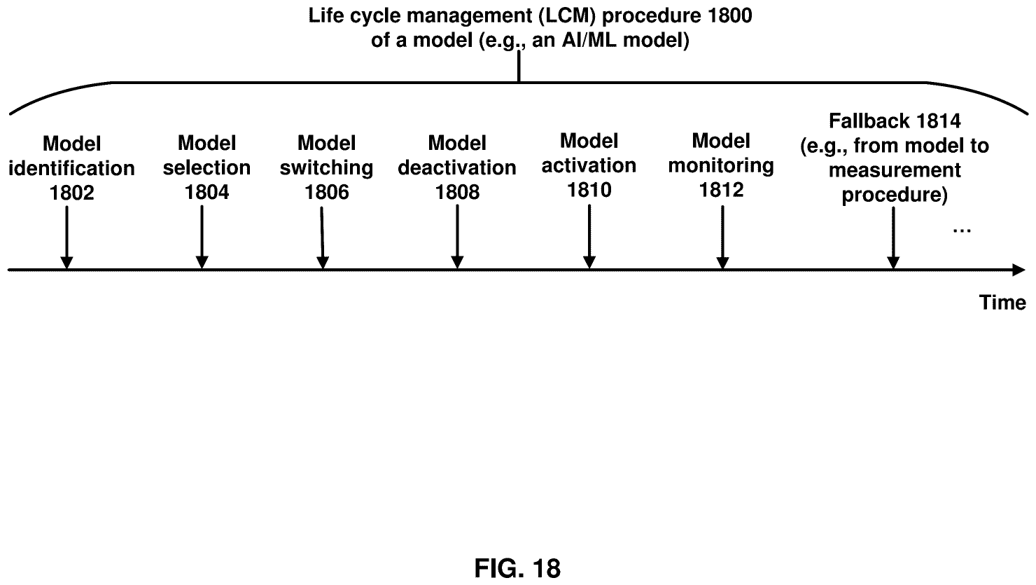

FIG. 18 illustrates an example of an LCM procedure 1800 of a model, such as an AI/ML model, per an aspect of the present disclosure. In an example, a wireless device may autonomously perform LCM procedure 1800 for a model. Additionally or alternatively, a base station may autonomously perform LCM procedure 1800 for a model. In the example of FIG. 18, LCM procedure 1800 may comprise one or more of: a model identification 1802 (e.g., identification of an AI/ML model), a model selection 1804 (e.g., selection of the AI/ML model), a model switching 1806 (e.g., switching of the AI/ML model to another AI/ML model), a model deactivation 1808 (e.g., deactivating the AI/ML model), a model activation (e.g., activating the AI/ML model), model monitoring 1812 (e.g., monitoring the AI/ML model), and/or fallback 1814 (e.g., determining to fallback from the AI/ML model to a measurement procedure).

For example, LCM procedure 1800 may be performed prior to a cell reselection procedure, a handover procedure, a positioning procedure, a radio link procedure (RLM) procedure, or a link recovery procedure (LRP) (e.g., a beam failure recovery (BFR) procedure). In an example, a wireless device may perform LCM procedure 1800 to fine tune/update/modify/activate the AI/ML mode for performing the cell reselection/handover/RLM/LRP or the like. In another example, a base station may perform LCM procedure 1800 to fine tune/update/modify/activate the AI/ML mode for performing the handover of a wireless device.

In another example, LCM procedure 1800 may be performed by a wireless device after a cell reselection procedure, a handover procedure, a positioning procedure, an RLM procedure, or a LRP (e.g., a BFR procedure). Based on/in response to the cell reselection/handover/RLM/LRP procedure, the wireless device may select/activate a new AI/ML mode and/or deactivate the AI/ML model. In another example, the LCM procedure 1800 may be performed by a base station after a handover procedure, a radio link recovery procedure, or a beam failure recovery procedure.

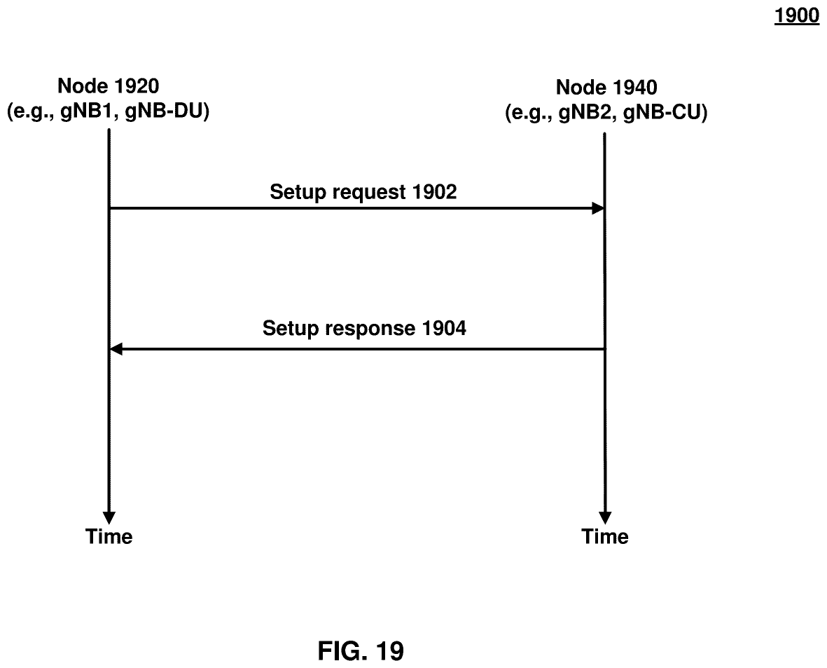

FIG. 19 illustrates an example of a procedure for an interface setup 1900 between a node 1920 and a node 1940 per an aspect of the present disclosure. The procedure for interface setup 1900 may also be referred to as a signaling flow for an interface setup, an interface setup procedure, or a procedure to setup (or establish) an interface. Interface setup 1900 may setup an interface, such as an Xn interface, an F1 interface, or a new generation (NG) interface. Interface setup 1900 may be referred to as an Xn interface setup, an F1 interface setup, or an NG interface setup.

Interface setup 1900 may be performed by node 1920. During interface setup 1900, node 1920 may communicate with node 1940. In an example, node 1920 may be a RAN node. In an example, node 1940 may be another RAN node, or a core network node. The RAN node may also be referred to as a next generation RAN (NG-RAN) node. Examples of the RAN node may be a base station (e.g., a gNB), a base station distributed unit (e.g., a gNB distribution unit (gNB-DU)), etc. An example of the core network node is an access and mobility management function (AMF). Node 1920 may communicate with the node 1940 over the interface that is setup based on interface setup 1900. Examples of an interface between the node 1920 and the node 1940 may be an Xn interface, an F1 interface, or an NG interface.

Communications between node 1920 and node 1940 may be based on an AI/ML model e.g., AI/ML model 1700 of FIG. 17. In an example, the communications may comprise node 1920 inferring (determining, predicting, and/or estimating) one or more measurements. For example, the one or more measurements may be, or comprise, a gNB Rx-Tx time difference, an AoA, a RSRP, a pathloss, a CPP, an UL SRS-RSRP, an UL SRS-RSRPP, a round trip time, a timing advance, an UL RSCP, a CIR, a DP, a PDP, a SNR, and/or a SINR. The communications may further comprise node 1920 transmitting, to node 1940, the one or more measurements based on the inferring.

In an example of FIG. 19, node 1920 may setup, establish, or configure an interface (e.g., Xn, F1, NG etc.) between node 1920 and node 1940 based on interface setup 1900. For example, node 1920 and node 1940 may exchange configuration data based on interface setup 1900. The configuration data may also be referred to as application-level configuration data. For example, node 1920 and node 1940 may interoperate over the interface (e.g., Xn, F1, NG etc) based on the configuration data.

As shown in FIG. 19, node 1920 may transmit, to node 1940, a setup request 1902. Setup request 1902 may be an Xn application protocol (XnAP), an F1 application protocol (F1AP), or a next generation application protocol (NGAP) message. Setup request 1902 may comprise configuration data associated with node 1920. For example, the configuration data may comprise a list of one or more cells associated with node 1920. In an example, the one or more cells may be associated with one or more wireless devices. The one or more cells may also be referred to as serving cells, such as, e.g., a special cell (spCell), a primary cell (PCell), a primary secondary cell (PSCell), a secondary cell (SCell), etc.

The list of the one or more cells may further include information associated with the one or more cells. The information may also be referred to as cell information or serving cell information. Examples of the information associated with the one or more cells may be a transmission bandwidth, a bandwidth of a reference signal, an antenna configuration, a numerology, a frequency band, a carrier frequency, a cell identifier (e.g., a physical cell ID (PCI), a cell global ID (CGI) etc.

The numerology, indicated by the information, may comprise one or more of a subcarrier spacing, a slot duration, a symbol duration, a subframe duration, or a cyclic prefix (CP) length (in time). Examples of the reference signals, indicated by the information, may be a positioning reference signal, a sounding reference signal, channel state information reference signal (CSI-RS), a primary synchronization signal (SSS), a secondary synchronization signal (SSS), a demodulation reference signal (DM-RS), a tracking reference signal, a signal in a synchronization signal/physical broadcast channel (SSB) etc.

The carrier frequency (or simply a carrier), indicated by the information, may also be referred to as a carrier, a frequency, a component carrier (CC), a layer, a frequency layer, a frequency channel, a positioning frequency layer (PFL), a positioning frequency, a positioning layer, etc. The carrier frequency may belong to a frequency band. The frequency band may comprise one or multiple carrier frequencies. The number of the carrier frequencies within a frequency band may depend on a passband (e.g., length of the band in frequency domain) and/or a bandwidth of the carrier frequencies and/or a raster (e.g., a point in frequency where a carrier frequency may be centered) etc.

A channel number, or a channel identifier may indicate a carrier frequency in the information. In example, the channel number or the channel identifier may be pre-defined. For example, the channel number may comprise an absolute radio frequency channel number (ARFCN). Examples of the ARFCN are E-UTRA ARFCN (EARFCN), NR ARFCN (NR-ARFCN) etc. For example, the carrier frequency associated with SSB based measurements (e.g., SS-RSRP, SS-RSRQ, SS-SINR, etc.) may be indicated by an SSB ARFCN, in, e.g., the measurement configuration. For example, the SSB ARFCN may indicate a frequency location within a bandwidth of an SSB. For example, an SSB comprises 20 resource blocks enumerated from resource block #0 to resource block #19. In an example, the indicated frequency location (e.g., a SSB ARFCN) may correspond to a resource element #0 within a resource block #0 of the resource blocks of the SSB.

Returning to FIG. 19, node 1920 may receive, from node 1940, a setup response 1904. Setup response 1904 may be in response to setup request 1902. Setup response 1904 may be, e.g., an XnAP, an F1AP, or an NGAP message. The reception of setup response 1904 may indicate successful configuration of the interface (e.g., Xn, F1, or NG) between node 1920 and node 1940. For example, node 1920 may determine (e.g., assume), based on the reception of setup response 1904, that the interface between node 1920 and node 1940 is (e.g., has been) successfully configured (e.g., by interface setup 1900).

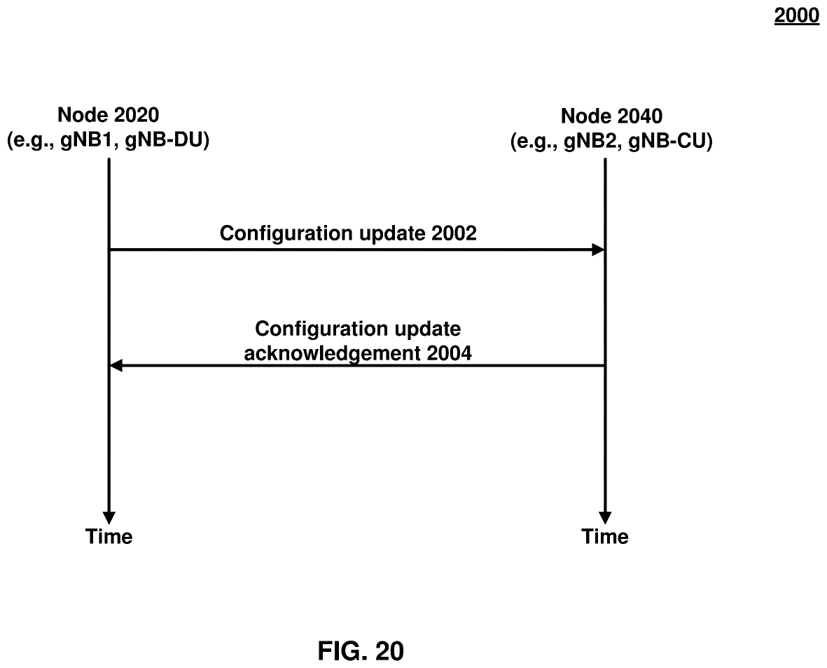

FIG. 20 illustrates an example of a configuration update procedure 2000 between a node 2020 and a node 2040 per an aspect of the present disclosure. Configuration update procedure 2000 may also be referred to as a signaling flow for configuration update, an interface configuration update procedure, or a procedure to update, upgrade, modify or enhance an interface. Configuration update procedure 2000 may update the configuration associated with an interface, such as an Xn interface, an F1 interface, or a new generation (NG) interface. Configuration update procedure 2000 may be referred to as an Xn configuration update procedure, an F1 configuration update procedure, or an NG configuration update procedure.

Configuration update procedure 2000 may be performed by node 2020. During the configuration update procedure 2000, node 2020 may communicate with a node 2040. In an example, node 2020 may be a RAN node. In an example, node 1940 may be another RAN node, or a core network node (as discussed above in FIG. 19). The RAN node may also be referred to as an NG-RAN node. Examples of the RAN node may be a base station (e.g., a gNB), a base station distributed unit (e.g., a gNB-DU), etc., (as discussed above in FIG. 19). An example of the core network node may be an AMF (as discussed above in FIG. 19). Node 2020 may communicate with node 2040 over an interface that is updated based on configuration update procedure 2000. Examples of an interface between node 1920 and node 1940 may be referred to as an Xn interface, an F1 interface, an NG interface etc., (as discussed above in FIG. 19).

Communications between node 2020 and node 2040 may be based on an AI/ML model e.g., AI/ML model 1700 of FIG. 17. In an example, the communications may comprise node 2020 inferring (determining, predicting, and/or estimating) one or more measurement. For example, the one or more measurements may be, or comprise, a gNB Rx-Tx time difference, an AoA, an UL SRS-RSRP, an UL SRS-RSRPP, a round trip time, a timing advance, an UL RSCP, a CIR, a DP, a PDP, a SNR, and/or a SINR. The communications may further comprise node 2020 transmitting, to node 2040, the one or more measurements based on the inferring.

In an example of FIG. 20, node 2020 may update or modify configuration data associated with node 2020. For example, node 2020 and node 2040 may exchange configuration data based on configuration update procedure 2000. As shown in FIG. 20, node 2020 may transmit, to node 2040, a configuration update 2002. Configuration update 2002 may be an XnAP, an F1AP, or an NGAP message (as discussed above in FIG. 19). Configuration update 2002 may comprise configuration data associated with node 2020. For example, the configuration data may comprise a list of one or more cells associated with node 2020. For example, the one or more cells may be referred to as a spCell, a PCell, a PSCell, a SCell etc., (as discussed above in FIG. 19). The configuration data may also be referred to as a cell information, or a serving cell information (as discussed above in FIG. 19).

Returning to FIG. 20, node 2020 may receive, from node 2040, a configuration update acknowledgement 2004. Configuration update acknowledgement 2004 may be in response to configuration update 2002. Configuration update acknowledgement 2004 may be, e.g., an XnAP, an F1AP, or an NGAP message. The reception of configuration update acknowledgement 2004 may indicate successful update of the configuration data associated with node 2020. For example, node 2020 may determine (e.g., assume), based on the reception of configuration update acknowledgement 2004, that node 2040 has successfully received the updated configuration data associated with node 2020 (e.g., by configuration update procedure 2000).

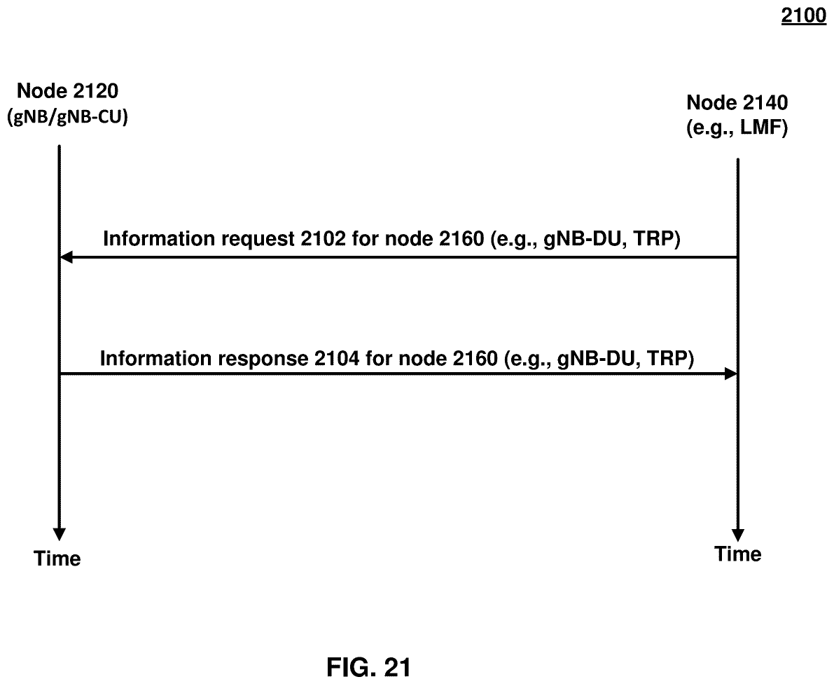

FIG. 21 illustrates an example of an information request procedure 2100 between a node 2120 and a node 2140 per an aspect of the present disclosure. Information request procedure 2100 may also be referred to as a signaling flow for information exchange, an information exchange procedure, a transmission reception point (TRP) information exchange procedure, or a procedure for providing detailed information for a TRP. Information request procedure 2100 may exchange information associated with a TRP.

Information request procedure 2100 may be performed by node 2140. During information request procedure 2100, node 2120 may communicate with node 2140. In an example, node 2120 may be a RAN node. The RAN node may also be referred to as a NG-RAN node. Examples of the RAN node may be a base station (e.g., a gNB), a base station control unit (e.g., a gNB control unit (gNB-CU)), etc. In an example, node 2140 may be a location sever. The location server may also be referred to as a positioning node, or a positioning server. An example of the location server is a location management function (LMF).

Node 2120 may communicate with the node 2140 via a positioning protocol e.g., new radio positioning protocol A (NRPPa). Node 2120 may host (e.g., manage) a node 2160. Node 2120 may contain (e.g., store, maintain, etc.) information about node 2160. In an example, node 2120 may be pre-configured with information about node 2160. In another example, node 2120 may receive from node 2160, information about node 2160. Node 2160 may be a radio node. Node 2160 may also be associated with a cell. Node 2160 (or the radio node) may also be referred to as a TRP. The TRP may also be referred to as an antenna, a radio unit (RU), a radio remote unit (RRU), or a radio remote head (RRH). The antenna may also be referred to as an antenna port, an antenna array, an antenna panel, or a radiating element.

Communications between node 2120 and node 2140 may be based on an AI/ML model e.g., AI/ML model 1700 of FIG. 17. In an example, the communications may comprise node 2120 inferring (determining, predicting, and/or estimating) one or more measurements. For example, the one or more measurements may be, or comprise, a gNB Rx-Tx time difference, an AoA, a RSRP, a path loss, a CPP, an UL SRS-RSRP, an UL SRS-RSRPP, a round trip time, a timing advance, an UL RSCP, a CIR, a DP, a PDP, a SNR, and/or a SINR. The communications may further comprise node 2120 transmitting, to node 2140, the one or more measurements based on the inferring.

In an example of FIG. 21, node 2140 may obtain, from node 2120, information about node 2160 based on information request procedure 2100. The information about node 2160 may comprise configuration data of node 2160. For example, node 2120 and node 2140 may exchange configuration data based on information request procedure 2100. The configuration data may also be referred to as application level configuration data, node information, or TRP information. As shown in FIG. 21, node 2140 may transmit, to node 2120, an information request 2102 for node 2160. Information request 2102 may be a positioning protocol message e.g., an NRPPa message. Information request 2102 may include an identifier of node 2160 e.g., an TRP ID. Information request 2102 may further include a type of information (e.g., a bandwidth, an antenna configuration, a transmit power, a numerology, etc.) requested by node 2140 for node 2160.

Returning to FIG. 21, node 2120 may transmit, to node 2140, an information response 2104. Information response 2104 may be in response to information request 2102. Information response 2104 may be a positioning protocol message e.g., an NRPPa message. Information response 2104 may include the identifier (e.g., the TRP ID) of node 2160, and values of one or more types of information requested by node 2140. Examples of the type of information may comprise a cell ID (e.g., a PCI, a CGI, etc.), a numerology, a bandwidth of a reference signal, an antenna configuration, a carrier frequency, a frequency band, etc. For example, information response 2104 may include an identifier (e.g., a PCI, a CGI, etc.) of a cell associated with node 2160. In an example, the cell may be associated with one or more wireless devices. The cell may also be referred to as a serving cell, e.g., a spCell, a PCell, a PSCell, a SCell, etc.

For example, node 2140 may determine (e.g., assume), based on the reception of information response 2104, that the acquisition of the information associated with node 2160 is (e.g., has been) successful.

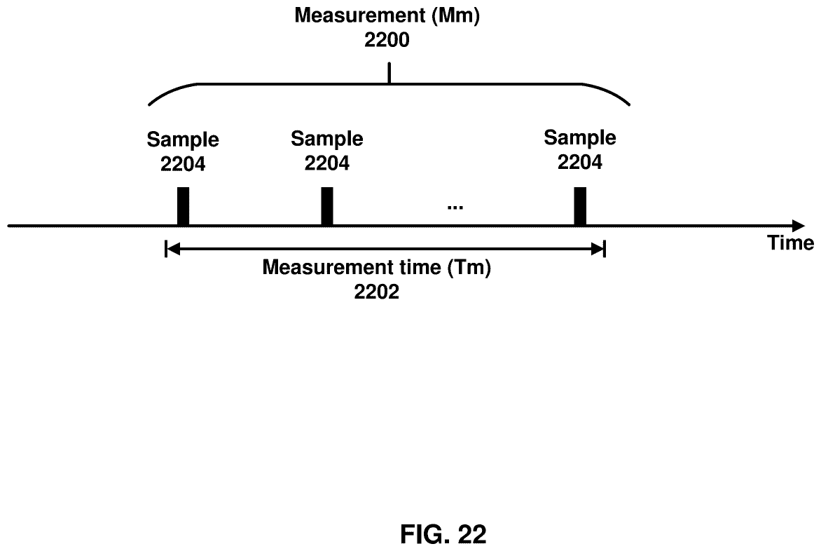

FIG. 22 illustrates an example of a measurement (Mm) 2100, over a measurement time (Tm) 2202, of one or more samples 2204 per an aspect of the present disclosure. In the example of FIG. 22, a node (e.g., a base station, a gNB, a gNB-DU, a TRP, etc.) may perform the measurement Mm 2200 based on a reference signal. The reference signal may be an uplink reference signal (UL RS), and/or a downlink reference signal (DL RS). For example, the node may obtain one or more samples 2204 based on the reference signal. For example, the node may obtain each one of the one or more samples 2204 by measuring the reference signal. In an example, the node may obtain one or more samples 2204 periodically, e.g., once every 40 ms, etc. One or more samples 2204 may also be referred to as a snapshot.

In an example, the periodicity of obtaining one or more samples 2204 may correspond to a periodicity of the UL RS (e.g., a periodicity of a SRS, and/or a periodicity of the DL RS (e.g., a periodicity of an SSB). The node may configure a wireless with an UL RS using a reference signal configuration e.g., via RRC message. The reference signal configuration may comprise one or more parameters, e.g., a reference signal index or identifier, a reference signal duration or occasion or window, a reference signal periodicity, a time offset, etc. The wireless device may transmit the UL RS.

The node may further configure the wireless device with a discontinuous reception (DRX) cycle via RRC, e.g., to reduce power consumption of the wireless device. For example, the wireless device may transmit the UL RS once every DRX cycle. In an example, the node may obtain sample 2204 based on the DRX cycle. For example, the node may obtain sample 2204 once every K11*Tdrx, where Tdrx is a length of the DRX cycle. In an example, K11=1. In another example, K11>1, e.g., K11=4.

The node may obtain each sample 2204 over at least one time-frequency resource comprising the reference signal. For example, the time-frequency resource may comprise a duration of the reference signal and a bandwidth of the reference signal. In an example, the time-frequency resource may comprise one or more resource elements, e.g., one or more subcarriers within a symbol. In an example, the time-frequency resource may comprise one or more resource blocks within a slot.

As illustrated in the example of FIG. 22, the node may obtain, determine, estimate, or calculate measurement Mm 2200 over Tm 2202 based on the obtained one or more samples. Measurement time Tm 2202 may also be referred to as a measurement period, a physical layer measurement period, a positioning measurement period, an observation time, a calculation time, or an estimation time. For example, the node may obtain Mm 2200 by combining two or more samples, of one or more samples 2204, over Tm 2202. In an example, the node may combine two or more samples, of one or more samples 2204, over Tm 2202 based on a function. The function may also be referred to as an operation or a relation. Examples of the function may be a sum, an average (or a mean), a median, a product, a ratio, an X11^{th} percentile, etc. Examples of X11 are 90^{th} percentile, 95^{th} percentile, etc.

In the example of FIG. 22, in an example, Tm 2202 may correspond to a duration over which the node may obtain one or more samples 2204. For example, Tm 2202 may be 200 ms based on five samples of one or more samples 2204. Each one of the five samples may be obtained with a periodicity of 40 ms. In another example, Tm 2202 may further include a processing time, e.g., for combining the samples. The processing time may also be referred to as a margin or an implementation margin. For example, Tm 2202 may be 250 ms based on the five samples, of one or more samples 2204, each having a periodicity of 40 ms and Tm 2202 comprising the processing time of 50 ms.

In the example of FIG. 22, the node may perform Mm 2200 over Tm 2202 with a certain measurement accuracy. An example of the measurement accuracy of Mm 2200 over Tm 2202 may be ±X12 dB (e.g., +3 dB) compared to an ideal signal measurement. Another example of the measurement accuracy of Mm 2200 over Tm 2202 may be ±X13 ns (e.g., ±100 ns) compared to an ideal timing measurement. The ideal signal measurement, or the ideal timing measurement, may also be referred to as a baseline measurement or a perfect measurement. The ideal signal measurement, or the ideal timing measurement may not include estimation errors, or impairments associated with the node (e.g., a measuring node such as a base station). Examples of the estimation errors, or impairments, are channel estimation errors, computational errors (e.g., when combining two or more samples, of one or more samples 2204), etc.

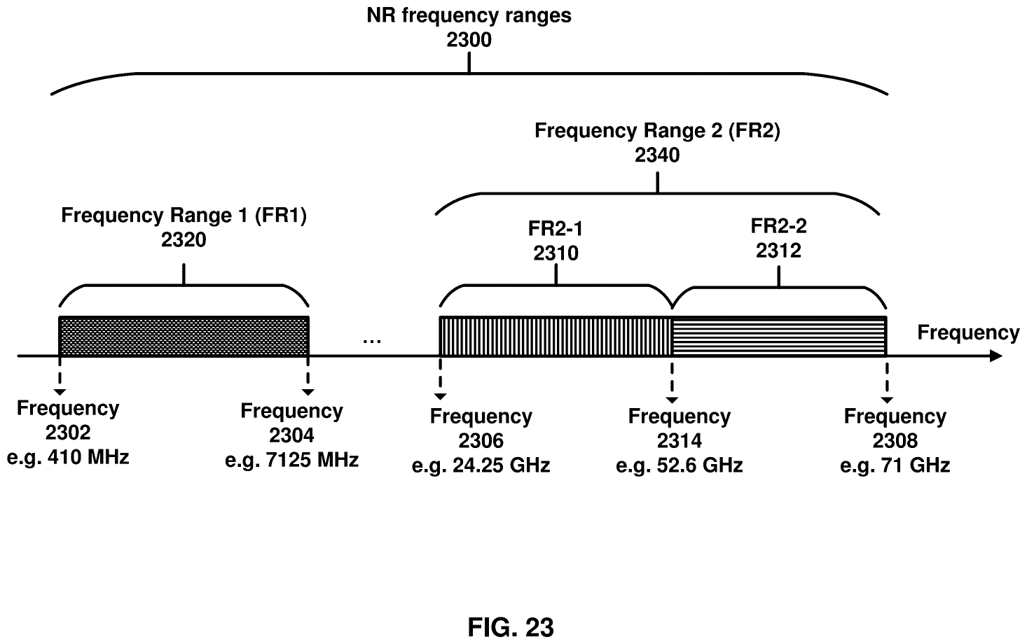

FIG. 23 illustrates an example of NR frequency ranges 2300, comprising Frequency Range 1 (FR1) 2320 and Frequency Range 2 (FR2) 2340, per an aspect of the present disclosure.

In the example of FIG. 23, the frequencies within FR1 2320 are lower than frequencies within FR2 2340. FR1 2320 may be referred to as a low band or a mid-band frequency range. FR2 2340 may be referred to as a millimeter wave frequency range or simply a millimeter frequency range.

In the example of FIG. 23, FR1 2320 includes frequencies from a frequency 2302 (e.g., 410 MHz) up to a frequency 2304 (e.g., 7125 MHz). Frequency 2302 may be referred to as a starting frequency of FR1 2320, and frequency 2304 may be referred to as an ending frequency of FR1 2320.

In the example of FIG. 23, FR2 2340 includes frequency from a frequency 2306 (e.g., 24.25 GHZ) up to a frequency 2308 (e.g., 71 GHZ). Frequency 2306 may be referred to as a starting frequency of FR2 2340, and frequency 2308 may be referred to as an ending frequency of FR2 2308.

In an example, FR2 2340 may further comprise sub-FR2 frequency ranges. For example, FR2 2340 may comprise a FR2-1 2310 and a FR2-2 2312. The frequencies within FR2-1 2310 are lower than frequencies in FR2-2 2312. In an example, FR2-1 2310 includes frequencies from frequency 2306 (e.g., 24.25 GHZ) up to a frequency 2314 (e.g., 52.6 GHZ). In an example, FR2-2 2312 includes frequencies from frequency 2314 (e.g., 52.6 GHZ) up to frequency 2308 (e.g., 71 GHZ).

Although FIG. 23 illustrates an example in which NR frequency ranges 2300 comprises FR1 2320 and FR2 2340, the present disclosure is not particularly limited to this example. For example, there may be other frequencies between FR1 2320 and FR2 2340. In an example, one or more frequencies between FR1 2320 and FR2 2340 may belong to another frequency range, such as Frequency Range 3 (FR3). In another example, FR2 2340 may be extended to include one or more frequencies between FR1 2320 and FR2 2340.

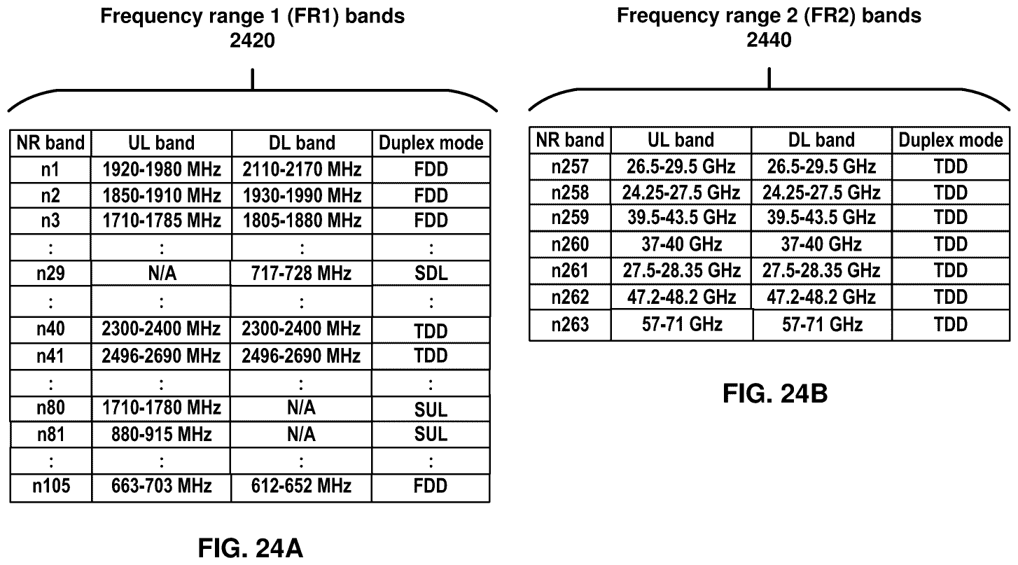

FIGS. 24A and 24B illustrate examples of FR1 bands 2420 and FR2 bands 2440 per an aspect of the present disclosure. FR1 bands 2420 belong to, or are within, FR1 2320, e.g., in FIG. 23. FR1 bands 2440 belong to, or are within, FR2 2340, e.g., in FIG. 23.

In the example of FIG. 24A, FR1 bands 2420 may be identified by their respective identifiers e.g., n1, n2, n3, and so on. The identifier (e.g., n1, n2, etc) may also be referred to as a band indicator, a band identifier, a band number, etc. A band may also be referred to as a frequency band, an operating band, an operating frequency band, a transmission band, etc. A wireless device may receive, from a base station, an identifier of a band, e.g., via RRC signaling message. A node (e.g., a base station, a gNB, a gNB-DU, a gNB-CU, a TRP, etc.) may transmit, to another node (e.g., a base station, a gNB, a gNB-DU, a gNB-CU, a TRP, a location server, a core network node, etc.), an identifier of a band, e.g., via an XnAP, an F1AP, an NGAP, or an NRPPa signaling message.

As discussed above, FR1 bands 2420 belong to or are within the FR1 2320 (e.g., in FIG. 23). A wireless device may communicate (e.g., transmit and/or receive signals) with a base station on a carrier frequency within FR1 2320 belonging to one or more FR1 bands 2420. A wireless device may further perform a measurement on one or more cells of a carrier frequency within FR1 2320 belonging to one or more FR1 bands 2420. A node may further perform a measurement on a signal (e.g., UL RS, DL RS, etc.) transmitted in a cell of a carrier frequency within FR1 2320 (e.g., in FIG. 23) belonging to one or more FR1 bands 2420.

In the example of FIG. 24A, a band in FR1 bands 2420 may be a frequency division duplex (FDD) band, a supplemental downlink (SDL) band, a time division duplex (TDD) band, or a supplemental uplink (SUL) band. The FDD band may also be a half-duplex FDD (HD-FDD) band. A wireless device may simultaneously transmit an UL signal on an uplink carrier frequency, and receive a downlink signal on a downlink carrier frequency in an FDD band. A wireless device may transmit an UL signal on an uplink carrier frequency, and receive a downlink signal on a downlink carrier frequency at different times in an HD-FDD band. A wireless device may transmit an UL signal, and receive a downlink signal on the same carrier frequency, and at different times in a TDD band. A wireless device may only receive signals on an SDL band. A wireless device may only transmit signals on a SUL band. A wireless device may use an SDL band, and/or an SUL band with a FDD, or a TDD band in a multicarrier operation. Examples of the multicarrier operation may be a carrier aggregation, a multi-connectivity, a dual connectivity, etc.

In the example of FIG. 24B, similar to FR1 bands 2420, FR2 bands 2440 may also be identified by their respective identifiers, e.g., n257, n258, n259, and so on. A wireless device may communicate (e.g., transmit, and/or receive signals) with a base station on a carrier frequency within FR2 2340 (e.g., in FIG. 23) belonging to one or more FR2 bands 2440. A wireless device may further perform a measurement on one or more cells of a carrier frequency within FR2 2340 (e.g., in FIG. 23) belonging to one or more FR2 bands 2440. A node may further perform a measurement on a signal (e.g., an UL RS, a DL RS, etc.) transmitted in a cell of a carrier frequency within FR2 2340 (e.g., in FIG. 23) belonging to one or more FR2 bands 2440.

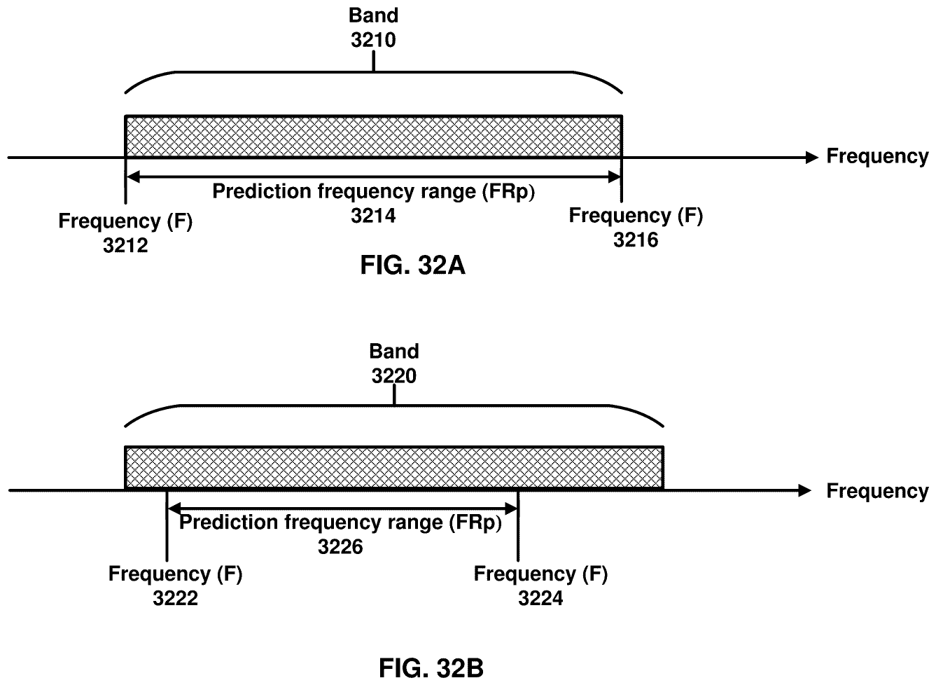

In the example of FIG. 24B, FR2 bands 2440 are TDD bands. In an example, an FR2 band, of FR2 bands 2440, may also be a FDD band, a HD-FDD band, an SDL band, or an SUL band. As discussed above, FR2 bands 2440 belong to, or are within the FR2 2340 (e.g., in FIG. 22). In the example of FIG. 24B, bands with identifiers from n257 to n262 in FR2 bands 2440 belong to, or are within the FR2-1 2310 (e.g., in FIG. 32). In the example of FIG. 24B, band n263 in the FR2 bands 2440 belongs to, or is within, the FR2-2 2312 (e.g., in FIG. 23).

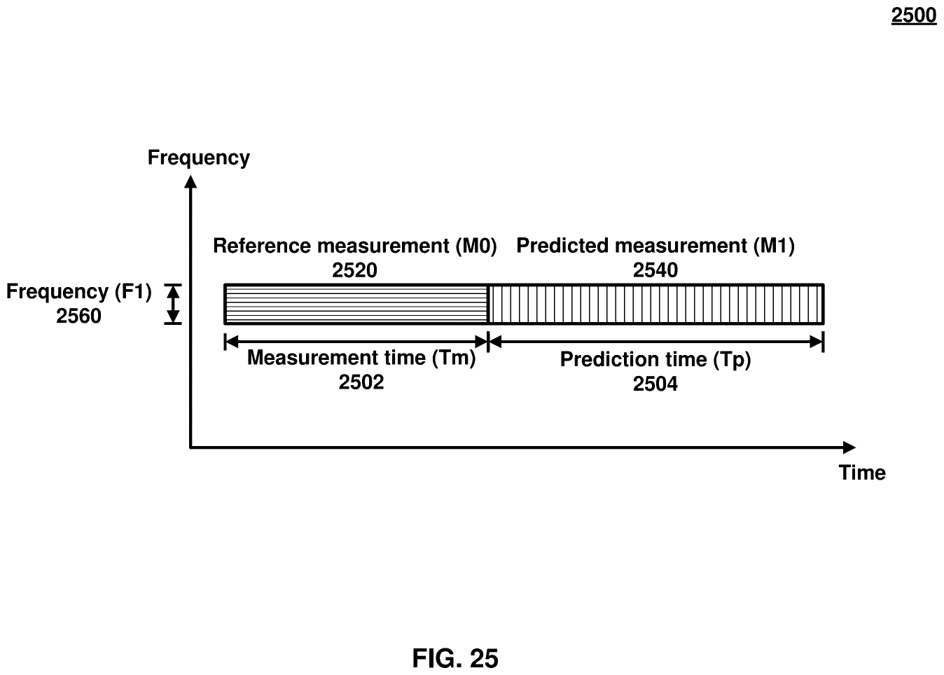

FIG. 25 illustrates an example of a measurement prediction procedure 2500 as per an aspect of an embodiment of the present disclosure. In measurement prediction procedure 2500, a reference measurement 2520 is used to predict a predicted measurement 2540 over a frequency 2560.

In the example of FIG. 25, a node (e.g., a base station, a gNB, a gNB-DU, a TRP, etc.) may perform M0 2520 over a reference signal. M0 2520 may be performed over a measurement time (Tm) 2502 and over F1 2560. For example, the reference signal may be transmitted by the node, and/or by a wireless device. The node may determine M1 2540 based on M0 2520 and over F1 2560. The node may predict M1 2540 over a prediction time (Tp) 2504. For example, M1 2540 may be valid over Tp 2504. M0 2520 is according to the example embodiments in FIG. 22 (e.g., Mm 2200). Tm 2502 is according to the example embodiments in FIG. 22 (e.g., Tm 2202). For example, the node may determine, based on M0 2520, M1 2540 over F1 2560 for a validity time of Tp 2504. For example, the validity time of Tp 2504 for M1 2540, may be used for a procedure, e.g., a handover, a positioning, etc. For example, M1 2540 may become invalid (or unreliable). For example, the node may discard (or abandon) M1 2540 after Tp 2504.

In an example, the node may support multiple frequency bands (e.g., FR1 bands 2420 in FIG. 24A, and/or FR2 bands 2440 in FIG. 24B) for communications with a wireless device. The communications may comprise a transmission of data to a wireless device, and/or a reception of data from a wireless device. In an example, the node may support frequency bands across one or multiple NR frequency ranges (e.g., FR1 2320, and FR2 2340 in FIG. 23). For example, F1 2560 in FIG. 25 may belong to any of the bands supported by the node.

Radio characteristics (e.g., a delay spread, a Doppler frequency, a Doppler spread, a channel coherence time, etc.) of a channel vary with frequency. For example, a Doppler frequency may increase with the increase in the frequency. For example, the radio characteristics of frequencies across FR1 2320 (e.g., FIG. 23) may be different. For example, the radio characteristics of frequencies FR2 2340 (e.g., FIG. 23) may be different.

A node (e.g., a base station, a gNB, a gNB-DU, a TRP, etc.) may use internal resources of the node for determining a predicted measurement (e.g., M1 2504) based on a reference measurement (e.g., M0 2502). For example, the node may use memory, and/or processor resources for determining a predicted measurement (e.g., M1 2504). For example, the node may store a model for determining a predicted measurement. The node may train a model based on the training data, e.g., M0 2502. In an example, the node may train a model periodically, e.g., to enhance accuracy of the predicted measurement. The model training may increase the complexity of the node, e.g., due to storage of input data, and/or processing input data. The node may have to maintain, and train multiple models for predicting a measurement on all bands, or multiple bands. In an example, the bands may be spread across FR1 2320 and FR2 2340 (e.g., in FIG. 23). In another example, the bands may be spread across FR2-1 2310 and FR2-2 2312 (e.g., in FIG. 23). Predicting a measurement on all bands, or on multiple bands supported by the node may further increase the complexity, and/or the cost of the node. For example, the node may share the internal resources for determining a predicted measurement (e.g., M1 2504), and for performing one or more additional tasks. The one or more additional tasks may comprise at least one of processing data, receiving signal, transmitting signal, performing online services, and/or offline services. The services may also be referred to as functionalities, or applications. The one or more additional tasks may correspond to cell change procedure; and/or a handover procedure; and/or a link recovery procedure; and/or a data transmission; and/or a data reception.

In an example, the node may support a band (e.g., FR2 bands 2440 in FIG. 24B) larger than a threshold, e.g., 500 MHz. For example, determining a predicted measurement on the entire band (e.g., which is larger than a threshold) supported by the node may further increase the complexity, and/or the cost of the node. In another example, determining a predicted measurement on the entire band (e.g., which is larger than a threshold) supported by the node may degrade performance (e.g., an accuracy) of the predicted measurement.

In the existing technologies, determining a predicted measurement over an entire range of frequencies within a band, or across all bands supported by a node (e.g., a base station, a gNB, a gNB-DU, a TRP, etc.) may increase the complexity of the node; and/or increase the cost of the node; and/or may degrade performance (e.g., an accuracy) of the predicted measurement. The performance of a radio procedure (e.g., a cell change of a wireless device, a positioning of a wireless device, etc.) based on the predicted measurement may further degrade. For example, a node (e.g., a base station, a gNB, a gNB-CU, etc.) may perform a cell change (e.g., a handover, an RRC connection release with redirection, etc.) based on the predicted measurement. In an example, the cell change may fail e.g., may result in a loss of a connection. The loss of the connection may further result in a loss of data, and/or a loss of control signaling.

Embodiments of the present disclosure are related to an approach for solving the problems described above. These and other features of the present disclosure are described further below.

In an example embodiment, a first node may transmit, to a second node, a configuration message indicating a first frequency range over which the first node is capable of determining a predicted measurement. The first node may receive, from the second node, an acknowledgement message in response to the configuration message.

By indicating the first frequency range over which the first node is capable of determining the predicted measurement, the complexity of the first node may be reduced (e.g., the first node may be capable of predicting less than the entire carrier bandwidth) and/or the reliability of a radio procedure may be improved (e.g., based on predicting outside of the capable frequency range and/or performing actions based on the capable frequency range).

In an example embodiment, a first node may receive, from a second node, an information request for a third node hosted by the first node. The first node may transmitted, to the second node, an information response indicating a first frequency range over which the third node is capable of determining a predicted measurement.

In an example embodiment, a first node may transmit, to a second node, a configuration message indicating a first frequency range over which the first node is capable of determining a predicted measurement. The first node may receive, from the second node, an acknowledgement message in response to the configuration message. The configuration message may further indicate that the first node is capable of using a reference measurement, performed on a reference signal received on a first frequency within the first frequency range, to determine a predicted measurement on a second frequency within the first frequency range. The first node may receive one or more configuration parameters for determining the predicted measurement.

In an example embodiment, a first node may transmit, to a second node, a configuration message indicating a first frequency range over which the first node is capable of determining a predicted measurement. The first node may receive, from the second node, an acknowledgement message in response to the configuration message. The configuration message may further indicate a second frequency range over which the first node is capable of using a reference measurement, performed on a reference signal received on a second frequency within the second frequency range, to determine a predicted measurement on a first frequency within the first frequency range. The first node may receive one or more configuration parameters for determining the predicted measurement.

In an example embodiment, a first node may transmit, to a second node, a configuration message indicating a first band over which the first node is capable of determining a predicted measurement. The first node may receive, from the second node, an acknowledgement message in response to the configuration message. The configuration message may further indicate that the first node is capable of using a reference measurement, performed on a reference signal received on a first frequency within the first band, to determine a predicted measurement on a second frequency within the first band. The first node may receive one or more configuration parameters for determining the predicted measurement.

In an example embodiment, a first node may transmit, to a second node, a configuration message indicating a first band over which the first node is capable of determining a predicted measurement. The first node may receive, from the second node, an acknowledgement message in response to the configuration message. The configuration message may further indicate a second band over which the first is capable of using a reference measurement, performed on a reference signal received on a second frequency within the second band, to determine a predicted measurement on a first frequency within the first band. The first node may receive one or more configuration parameters for determining the predicted measurement.

In an example embodiment, a first node may receive, from a second node, an information request for a third node hosted by the first node. The first node may transmit, to the second node, an information response indicating a first frequency range over which the third node is capable of determining a predicted measurement. The information response may further indicate that the third node is capable of using a reference measurement, performed on a reference signal received on a first frequency within the first frequency range, to determine a predicted measurement on a second frequency within the first frequency range. The first node may receive one or more configuration parameters for the third node for determining the predicted measurement.

In an example embodiment, a first node may receive, from a second node, an information request for a third node hosted by the first node. The first node may transmit, to the second node, an information response indicating a first frequency range over which the third node is capable of determining a predicted measurement. The information response may further indicate a second frequency range over which the third node is capable of using a reference measurement, performed on a reference signal received on a second frequency within the second frequency range, to determine a predicted measurement on a first frequency within the first frequency range. The first node may receive one or more configuration parameters for the third node for determining the predicted measurement.

In an example embodiment, a first node may receive, from a second node, an information request for a third node hosted by the first node. The first node may transmit, to the second node, an information response indicating a first band over which the third node is capable of determining a predicted measurement. The information response may further indicate a second band over which the third node is capable of using a reference measurement, performed on a reference signal received on a second frequency within the second band, to determine a predicted measurement on a first frequency within the first band. The first node may receive one or more configuration parameters for the third node for determining the predicted measurement.

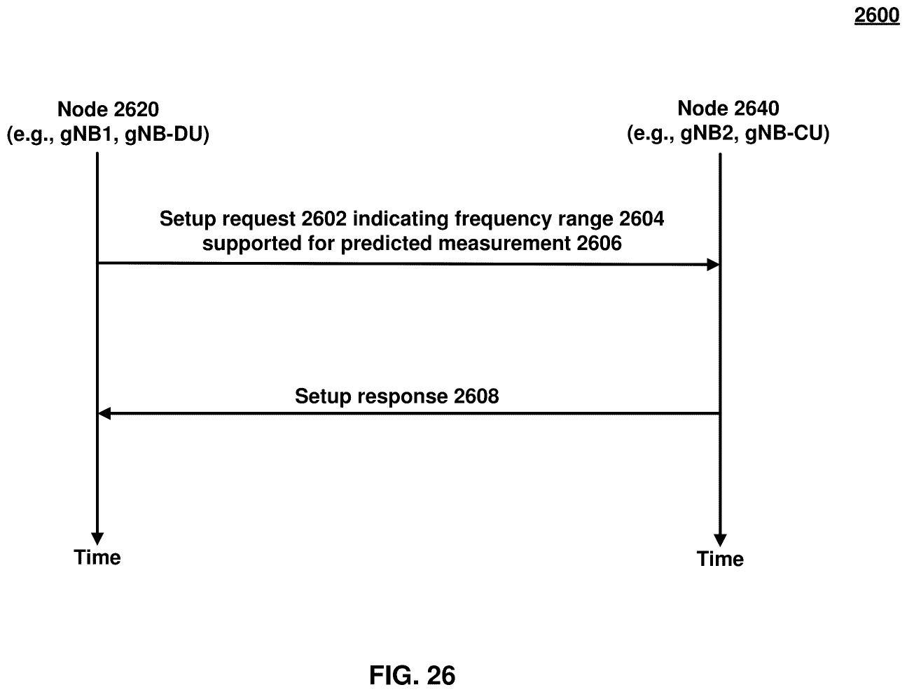

FIG. 26 illustrates an example of a procedure for an interface setup 2600 between a node 2620 and a node 2640 per an aspect of the present disclosure. Interface setup 2600 may be used by node 2620, to provide node 2640, one or more configuration parameters (e.g., a bandwidth, a band, a number of carriers, an antenna configuration, a transmit power, etc.) associated with (or supported by) node 2620. The features illustrated in FIG. 26 may be combined with the features previously discussed with reference to FIGS. 17, 18, 19, 20, 21, 22, 23, 24A, 24B, and/or 25.

For example, example embodiments in FIG. 26 may comprise node 2620 transmitting, to node 2640, a setup request 2602 indicating a frequency range 2604 over which node 2620 is capable of determining a predicted measurement 2606. For example, example embodiments in FIG. 26 may comprise node 2620 receiving, from node 2640, a setup response 2608 in response to setup request 2602. The reception of setup response 2608 may indicate successful delivery of setup request 2602 to node 2640. For example, node 2620 may determine (e.g., assume), based on the reception of setup response 2608, that node 2640 has received information indicating frequency range 2604 supported by node 2620. In an example, setup response 2608 may also indicate frequency range 2604.

In an example, node 2620 may transmit, to node 2640, setup request 2602 indicating frequency range 2604 via an XnAP, an F1AP, or an NGAP message.

In an example, node 2620 may receive, from node 2640, setup response 2608 via an XnAP, an F1AP, or an NGAP message.

In an example, node 2620 may be a RAN node. In an example, node 2640 may be a RAN node, or a core network node. The RAN node may also be referred to as an NG-RAN node. Examples of the RAN node may be a base station (e.g., a gNB), a base station distributed unit (e.g., a gNB-DU), etc., (as discussed above in FIG. 19). An example of the core network node may be an AMF (as discussed above in FIG. 19).

Predicted measurement 2606 may also be referred to as an inferred measurement, or a measurement based on a model, a measurement based on a reference measurement, or a measurement derived or determined based on a model. In an example, the reference measurement may be a historical measurement, or a measurement performed by node 2620 prior to determining predicted measurement 2606. The historical measurement may be included in a model for determining predicted measurement 2606. The model is according to the example embodiments in FIG. 17.

Predicted measurement 2606 may be performed for a load balancing procedure (e.g., a path loss, a SNR, a SINR, SSS transmit power, etc.), a positioning procedure (e.g., an uplink Relative Time of Arrival, an RTT, a gNB Rx-Tx time difference, an SRS-RSRPP, an SRS-RSRP, an AaD, an AoA, a CIR, a CPP, an UL RSCP, a PDP, a DP, timing advance, etc.), or a propagation delay compensation (e.g., a gNB Rx-Tx time difference, etc.).

In an example, setup request 2602 may comprise an identifier indicating frequency range 2604. The identifier may also be referred to as an ID, a tag, an identity, or an index. For example, one or more identifiers may be associated with (or corresponding to) one or more values of frequency range 2604. In an example, the association may be pre-defined. For example, each one of the one or more values of frequency range 2604 may be expressed in terms of a frequency unit (e.g., Y11 MHz, Y12 GHZ, etc.), a number of frequency channels (e.g., Y13 number of resource blocks, etc.), or an indicator (or identifier) of a band (e.g., FR1 bands 2420 in the examples in FIG. 24A, or FR2 bands 2440 in the examples in FIG. 24B). For example, the identifiers may comprise Y14 number of bits e.g., 2 bits. In an example, bits 00, 01, 10, and 11 may indicate frequency range 2604 corresponding to 50 MHz, 100 MHz, 150 MHz, and 200 MHz, respectively.

In an example, setup request 2602 may further include a reliability level. In an example, the reliability level may indicate accuracy or precision of predicted measurement 2606. In an example, the reliability level may indicate accuracy or precision of predicted measurement 2606 compared to an ideal measurement over frequency range 2604. In an example, the reliability level may comprise a confidence interval. For example, the confidence interval may indicate the accuracy of predicted measurement 2606 compared to an ideal measurement over frequency range 2604. The ideal measurement may be a hypothetical measurement. In an example, the ideal measurement may not include implementations error, or impairments associated with predicting, by node 2620, predicted measurement 2606. For example, the reliability level may indicate that node 2620 is capable of predicting predicted measurement 2606 over frequency range 2604. For example, the confidence interval may be expressed in terms of percentage (e.g., Y15%) of the confidence interval. In an example, the information may include one of the two or more values of the confidence intervals. For example, values of the confidence intervals may comprise 2 bits e.g., 4 possible values. Examples of the pre-defined values of the confidence interval corresponding to bits 00, 01, 10, and 11 may be 80%, 85%, 90%, and 95%, respectively. For example, node 2620 may indicate that node 2620 is capable of predicting predicted measurement 2606 over frequency range 2604 with a confidence interval of Y15% (e.g., 99%).

In an example, setup request 2602 may further include information associated with (or related to) predicted measurement 2606 to be predicted by node 2620. Node 2620 may determine predicted measurement 2606 based on the information about predicted measurement 2606 included in setup request 2602.

In an example, the information associated with predicted measurement 2606 may include a type of predicted measurement 2606. For example, frequency range 2604 may be associated with (or applicable to) the type of predicted measurement 2606 indicated in setup request 2602. For example, the type of predicted measurement 2606 may be a received signal level (RSL) measurement, a timing measurement, an orientation measurement, etc. The RSL may further comprise a received signal strength (RSS), or a received signal quality (RSQ). Examples of the RSS may be (or referred to as) an RSRP, a path loss, a path gain, etc. Examples of the RSQ may be (or referred to as) an SINR, an SNR, etc. Examples of the timing measurement may be (or referred to as), an UL time of arrival, a round trip time (RTT), a timing advance, a gNB Rx-Tx time difference, etc. The orientation measurement may also be referred to as a directional measurement, or an angular measurement. Examples of the orientation measurement may be (or referred to as) an angle of arrival (AoA), an angle of departure (AoD), etc.

In another example, the information associated with predicted measurement 2606 may include a type of a reference signal. Examples of the type of reference signal may be a TRS, an SSB, a CSI-RS, a PRS, a SRS, a DMRS, etc. In an example, the type of the reference signal may be associated with (or used for) a type of a radio procedure. For example, one type of the reference signal may be used for a positioning measurement, e.g., a PRS, an SRS, etc. Another type of the reference signal may be used for a mobility measurement, e.g., an SSB, a CSI-RS, etc. Yet another type of the reference signal may be used for a synchronization procedure, e.g., a TRS, etc. Yet another type of the reference signal may be used for a channel estimation, e.g., a DMRS, etc.

In another example, the information associated with predicted measurement 2606 may include a purpose (e.g., a use case, or an application) of predicted measurement 2606. Examples of the purpose of predicted measurement 2606 may be a mobility (e.g., a cell change such as a handover, a RRC connection release with redirection, etc.) of a wireless device, a positioning of a wireless device, a self-organizing network (SON) operation, etc. For example, the SON operation may be used for tuning, adapting, modifying, or adjusting one or more parameters. The one or more parameters may be associated with node 2620, and/or with node 2640. Examples of the one or more parameters may be a transmit power, a number of bands, a number of carriers, a transmission bandwidth, a bandwidth of a reference signal, a number of transmit antennas, and/or a number of receive antennas, etc.

Referring to the example embodiments in FIG. 26, frequency range 2604 may depend on (or be associated with) the type of predicted measurement 2606 (as described above), the type of a reference signal (as described above) associated with predicted measurement 2606, the reliability of predicted measurement 2606 (e.g., the confidence interval), and/or a radio channel characteristic. Examples of the radio channel characteristic may be (or referred to as) a Doppler frequency, a Doppler spread (or Doppler spectrum), a multipath delay spread, or a channel coherence time.

Referring to the example embodiments in FIG. 26, node 2620 (e.g., a base station, a gNB-DU, etc.) may be capable of communicating with a wireless device within frequency range 2604. In an example, node 2620 (e.g., a base station, a gNB-DU, etc.) may further be capable of communicating with a wireless device outside frequency range 2604, e.g., over one or more bands supported by node 2620.

In an example, communications may comprise, a wireless device receiving a signal from node 2620 (e.g., a base station, a gNB-DU, etc.), and/or a wireless device transmitting a signal to node 2620 (e.g., a base station, a gNB-DU, etc.). The signal may be referred to as a physical signal, and/or a physical channel. A physical signal may comprise a reference signal (RS). In an example, a downlink RS may comprise a Primary Synchronization Signal (PSS), a Secondary Synchronization Signal (SSS), Channel Status Information-RS (CSI-RS), Demodulation Reference Signal (DMRS), Synchronization Signal/PBCH block (SSB), a Positioning Reference Signal (PRS), etc. In an example, an uplink RS may comprise a Demodulation Reference Signal (DMRS), a Sounding Reference Signal (SRS), etc. A physical channel may include higher layer information. The physical channel may also be referred to as a data channel or a control channel. The data channel may carry (or contain) user data (or traffic). The control channel may carry (or contain) control information such as an RRC message. In an example, the higher layer information may comprise a logical channel, a transport channel, etc. Examples of the logical channel may be (or referred to as) a Broadcast Control Channel (BCCH), a Paging Control Channel (PCCH), a Common Control Channel (CCCH), a Dedicated Control Channel (DCCH), a Multi-cast Control Channel (MCCH), a Dedicated Traffic Channel (DTCH), a Multicast Traffic Channel (MTCH), etc. In an example, a downlink physical channel may be (or referred to as) a Physical Downlink Shared Channel (PDSCH), a Physical Downlink Control Channel (PDCCH), a Physical Broadcast Channel (PBCH), etc. In an example, an uplink physical channel may be (or referred to as) a Physical Uplink Shared Channel (PUSCH), a Physical Uplink Control Channel (PUCCH), a Physical Random Access Channel (PRACH), etc.

In an example, node 2620 may further receive, from node 2640, a measurement request. The measurement request may indicate, node 2620, to determine a predicted measurement e.g., predicted measurement 2606. Node 2620 may receive the measurement request via an XnAP, an F1AP, or an NGAP message. An example of the measurement request may be a positioning measurement request.

In an example, the measurement request may comprise an information associated with a carrier frequency. For example, the carrier frequency may be indicated by a frequency channel number. Examples of the frequency channel number may be an absolute frequency number, an ARFCN, or an NR-ARFCN. Node 2620 may predict predicted measurement 2606 over the carrier frequency.

In an example, the measurement request may further indicate a reliability level of predicted measurement 2606 to be predicted by node 2620. For example, the reliability level is according to the example associated with the reliability level included in setup request 2602. The reliability level included in the measurement request may also comprise a confidence interval. The confidence interval may be according to the examples associated with the confidence interval included in setup request 2602. For example, node 2620 may predict predicted measurement 2606 provided that node 2620 can predict predicted measurement 2606 with the confidence interval included in the measurement request. In another example, node 2620 may not predict predicted measurement 2606 (or cancel, discard, or abandon predicted measurement 2606) if the confidence interval included in the measurement request being higher than the confidence interval supported by node 2620 (e.g., the confidence interval included in setup request 2602). In another example, node 2620 may not predict predicted measurement 2606 (or cancel, discard predicted measurement 2606) if the confidence interval included in the measurement request being higher than the confidence interval supported by node 2620 (e.g., the confidence interval included in setup request 2602) by certain threshold (THC). In an example, THC may be pre-defined, e.g., THC=5%.

Referring to the example embodiments in FIG. 26, node 2620 may predict predicted measurement 2606 based on a model. In an example, the model is according to the example embodiments in FIG. 17.

Referring to the example embodiments in FIG. 26, node 2620 may further use a result of predicted measurement 2606 for one or more tasks. In an example, one of the one of more tasks may comprise transmitting, to node 2640, the result of predicted measurement 2606. In an example, node 2620 may transmit, to node 2640, the result of predicted measurement 2606 in a measurement response. Node 2620 may transmit the measurement response via an XnAP, an F1AP, or an NGAP message. The measurement response may be in response to the measurement request. An example of the measurement response may be a positioning measurement response. In another example, one of the one of more tasks may comprise using the result of predicted measurement 2606 for a cell change procedure. Examples of the cell change procedure may be a handover, a change of an SCell, an RRC connection release with redirection, etc. In another example, one of the one of more tasks may comprise using the result of predicted measurement 2606 for a positioning procedure e.g., for determining a geographical position (or location) of a wireless device.

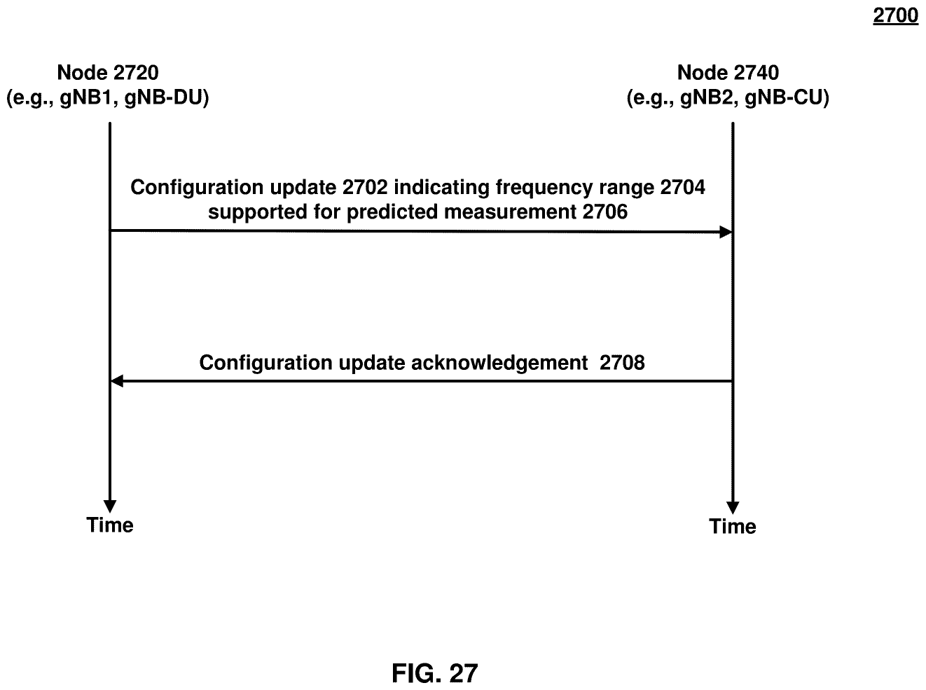

FIG. 27 illustrates an example of a configuration update procedure 2700 between a node 2720 and a node 2740 per an aspect of the present disclosure. Configuration update procedure 2700 may be used by node 2720, to update node 2740, about a change (or modification), an addition, or a removal of one or more configuration parameters (e.g., a bandwidth, a band, a number of carriers, an antenna configuration, a transmit power, etc.) associated with (or supported by) node 2720. The features illustrated in FIG. 27 may be combined with the features previously discussed with reference to FIGS. 17, 18, 19, 20, 21, 22, 23, 24A, 24B, 25, and/or 26.

For example, example embodiments in FIG. 27 may comprise node 2720 transmitting, to node 2740, a configuration update 2702 indicating a frequency range 2704 over which node 2720 is capable of determining a predicted measurement 2706. For example, example embodiments in FIG. 27 may comprise node 2720 receiving, from node 2740, a configuration update acknowledgement 2708 in response to configuration update 2702. The reception of configuration update acknowledgement 2708 may indicate successful delivery of configuration update 2702 to node 2740. For example, node 2720 may determine (e.g., assume), based on the reception of configuration update acknowledgement 2708, that node 2740 has received information indicating frequency range 2704 supported by node 2720.

In an example, configuration update acknowledgement 2708 may also indicate frequency range 2704.

In an example, node 2720 may transmit, to node 2740, configuration update 2702 indicating frequency range 2704 via an XnAP, an F1AP, or an NGAP message.

In an example, node 2720 may receive, from node 2740, configuration update acknowledgement 2708 via an XnAP, an F1AP, or an NGAP message.

In an example, node 2720 may be a RAN node. In an example, node 2740 may be a RAN node or a core network node. The RAN node may also be referred to as an NG-RAN node. Examples of the RAN node may be a base station (e.g., a gNB), a base station distributed unit (e.g., a gNB-DU), etc. (as discussed in FIG. 19). An example of the core network node may be an AMF (as discussed above in FIG. 19).

Predicted measurement 2706 may also be referred to as an inferred measurement, a measurement based on a model, a measurement based on a reference measurement, or a measurement derived (or determined) based on a model. In an example, the reference measurement may be a historical measurement, or the reference measurement may be a measurement performed by node 2720 prior to determining predicted measurement 2706. The historical measurement may be included in a model for determining predicted measurement 2706. The model is according to the example embodiments in FIG. 17.

Predicted measurement 2706 may be performed for a load balancing procedure (e.g., a path loss, a SNR, a SINR, SSS transmit power, etc.), a positioning procedure (e.g., an uplink Relative Time of Arrival, an RTT, a gNB Rx-Tx time difference, an SRS-RSRPP, an SRS-RSRP, an AaD, an AoA, a CIR, a CPP, an UL RSCP, a PDP, a DP, timing advance, etc.), or a propagation delay compensation (e.g., a gNB Rx-Tx time difference, etc.).

In an example, configuration update 2702 may include an identifier (or an ID, an identity, a tag, etc.) indicating frequency range 2704. The identifier is according to the example embodiments in FIG. 26 (e.g., the identifier).

In an example, configuration update 2702 may further include a reliability level. The reliability level is according to the example embodiments in FIG. 26 (e.g., the reliability level).

In an example, configuration update 2702 may further include information associated with (or related to) predicted measurement 2706 to be predicted by node 2720. Node 2720 may be capable of determining predicted measurement 2706 based on the information (about predicted measurement 2706) included in configuration update 2702.

In an example, the information associated with predicted measurement 2706 may include a type of predicted measurement 2706. For example, frequency range 2704 may be associated with (or applicable to) the type of predicted measurement 2706 (as described above) indicated in configuration update 2702. The type of predicted measurement 2706 is according to the example embodiments in FIG. 26 (e.g., the type of predicted measurement 2606).

In another example, the information associated with predicted measurement 2706 may include a purpose (e.g., a use case or an application) of predicted measurement 2706. The purpose of predicted measurement 2706 is according to the example embodiments in FIG. 26 (e.g., the purpose of predicted measurement 2606).

Referring to the example embodiments in FIG. 27, frequency range 2704 may depend on (or be associated with) the type of predicted measurement 2706, the type of a reference signal associated with predicted measurement 2706, the reliability of predicted measurement 2706 (e.g., the confidence interval), and/or a radio channel characteristic. Examples of the radio channel characteristic may be (or referred to as) a Doppler frequency, a Doppler spread (or Doppler spectrum), a multipath delay spread, or a channel coherence time.

Referring to the example embodiments in FIG. 27, node 2720 (e.g., a base station, a gNB-DU, etc.) may be capable of communicating with a wireless device within frequency range 2704. In an example, node 2720 (e.g., a base station, a gNB-DU, etc.) may further be capable of communicating with a wireless device outside frequency range 2704, e.g., over one or more bands supported by node 2720.

In an example, communications may comprise, a wireless device receiving a signal from node 2720 (e.g., a base station, a gNB-DU, etc.), and/or a wireless device transmitting a signal to node 2720 (e.g., a base station, a gNB-DU, etc.). The signal may be referred to as a physical signal, and/or a physical channel. The physical signal and the physical channel are according to the example embodiments in FIG. 26 (e.g., the physical signal and the physical channel).

In an example, node 2720 may further receive, from node 2740, a measurement request. The measurement request may indicate (for node 2720) to determine a predicted measurement e.g., predicted measurement 2706. Node 2720 may receive the measurement request via an XnAP, an F1AP, or an NGAP message. An example of the measurement request may be a positioning measurement request. The measurement request is according to the example embodiments in FIG. 26 (e.g., the measurement request).

In an example, the measurement request may comprise information associated with a carrier frequency. The information associated with the carrier frequency is according to the example embodiments in FIG. 26 (e.g., the information associated with the carrier frequency).

In an example, the measurement request may further indicate a reliability level of predicted measurement 2706 to be predicted by node 2720. The reliability level is according to the example embodiments in FIG. 26 (e.g., the reliability level).

Referring to the example embodiments in FIG. 27, node 2720 may predict predicted measurement 2706 based on a model. In an example, the model is according to the example embodiments in FIG. 17.

Referring to the example embodiments in FIG. 27, node 2720 may further use a result of predicted measurement 2706 for one or more tasks. The one or more tasks are according to the example embodiments in FIG. 26 (e.g., the one or more tasks).

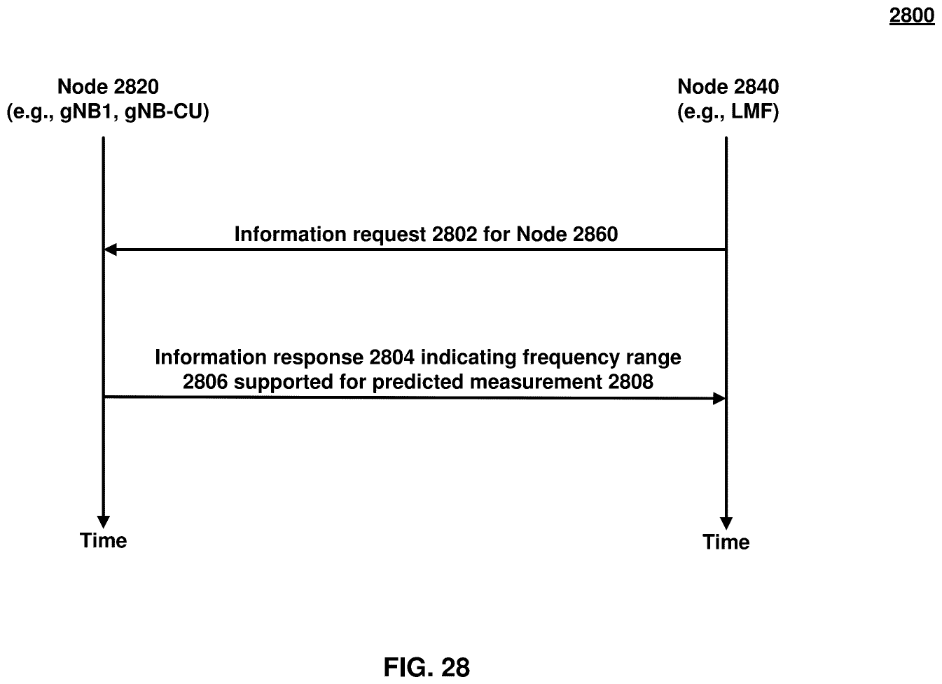

FIG. 28 illustrates an example of an information request procedure 2800 between a node 2820 and a node 2840 per an aspect of the present disclosure. Information request procedure 2800 may also be used for exchanging, between a node 2820 and a node 2840, information associated with a node 2860.

The information may comprise one or more configuration parameters (e.g., a bandwidth, a band, a number of carriers, an antenna configuration, a transmit power, etc.) associated with (or supported by) node 2860. Node 2820 may host (or manage, control, serve, support, etc.) node 2860. The features illustrated in FIG. 28 may be combined with the features previously discussed with reference to FIGS. 17, 18, 19, 20, 21, 22, 23, 24A, 24B, 25, 26, and/or 27.

For example, example embodiments in FIG. 28 may comprise node 2820 receiving, from node 2840, an information request 2802 for node 2860. For example, example embodiments in FIG. 28 may comprise node 2820 transmitting, to node 2840, an information response 2804 indicating a frequency range 2806 over which node 2860 is capable of determining a predicted measurement 2808. In an example, node 2820 may transmit information response 2804 in response to (or corresponding to) information request 2802. In an example, information request 2802 may indicate (or include) a request for a frequency range over which node 2860 is capable of determining a predicted measurement (e.g., predicted measurement 2808).

Information request procedure 2800 may be performed (or initiated, triggered, etc.) by node 2840. During information request procedure 2800, node 2820 may communicate with node 2840.

In an example, node 2820 may receive, from node 2840, information request 2802 for node 2860 via a positioning protocol e.g., an NRPPa message.

In an example, node 2820 may transmit, to node 2840, information response 2804 indicating frequency range 2806 supported by node 2860 via a positioning protocol e.g., an NRPPa message.

In an example, node 2820 may be a RAN node. The RAN node may also be referred to as a NG-RAN node. Examples of the RAN node may be a base station (e.g., a gNB), a base station control unit (e.g., a gNB control unit (gNB-CU), etc. In an example, node 2840 may be a location sever. The location server may also be referred to as a positioning node, or a positioning server. An example of the location server is a location management function (LMF). In an example, node 2860 may be a radio node. Node 2860 may be associated with a cell, e.g., a neighbor cell, an spCell, a PCell, a PSCell, an SCell, etc. Examples of node 2860 (or the radio node) may be (or referred to as) a TRP, an RRH, a radio unit, an RRU, or an antenna (e.g., the radio node in example embodiments of FIG. 21).

Predicted measurement 2808 may also be referred to as an inferred measurement, or a measurement based on a model, a measurement based on a reference measurement, or a measurement derived or determined based on a model. In an example, the reference measurement may be a historical measurement, or the reference measurement may be a measurement performed by node 2860 prior to determining predicted measurement 2808. The historical measurement may be included in a model for determining predicted measurement 2808. The model is according to the example embodiments in FIG. 17.

Predicted measurement 2808 may be performed for a load balancing procedure (e.g., a path loss, a SNR, a SINR, SSS transmit power, etc.), a positioning procedure (e.g., an uplink Relative Time of Arrival, an RTT, a gNB Rx-Tx time difference, an SRS-RSRPP, an SRS-RSRP, an AaD, an AoA, a CIR, a CPP, an UL RSCP, a PDP, a DP, timing advance, etc.), or a propagation delay compensation (e.g., a gNB Rx-Tx time difference, etc.).

In an example, information response 2804 may include an identifier (or an ID, an identity, a tag, etc.) indicating frequency range 2806. The identifier is according to the example embodiments in FIG. 26 (e.g., the identifier).

In an example, information response 2804 may further include a reliability level. The reliability level is according to the example embodiments in FIG. 26 (e.g., the reliability level).

In an example, information response 2804 may further include an information associated with (or related to) predicted measurement 2808 to be predicted by node 2860. Node 2860 may be capable of determining predicted measurement 2808 based on the information (about predicted measurement 2808) included in information response 2804.

In an example, the information associated with predicted measurement 2808 may include a type of predicted measurement 2808. For example, frequency range 2806 may be associated with (or applicable to) the type of predicted measurement 2808 indicated in information response 2804. The type of predicted measurement 2808 is according to the example embodiments in FIG. 26 (e.g., the type of predicted measurement 2606).

In another example, the information associated with predicted measurement 2808 may include a purpose (e.g., a use case, or an application) of predicted measurement 2808. The purpose of predicted measurement 2808 is according to the example embodiments in FIG. 26 (e.g., the purpose of predicted measurement 2606).

Referring to the example embodiments in FIG. 28, frequency range 2806 may depend on (or associated with) the type of predicted measurement 2808, the type of a reference signal associated with predicted measurement 2808, the reliability of predicted measurement 2808 (e.g., the confidence interval), and/or a radio channel characteristic. Examples of the radio channel characteristic may be (or referred to as) a Doppler frequency, a Doppler spread (or Doppler spectrum), a multipath delay spread, or a channel coherence time.

Referring to the example embodiments in FIG. 28, node 2860 (e.g., a base station, a gNB-DU, a TRP, an RRH, an RRU, etc.) may be capable of communicating with a wireless device within frequency range 2806. In an example, node 2860 (e.g., a base station, a gNB-DU, a TRP, an RRH, an RRU, etc.) may further be capable of communicating with a wireless device outside frequency range 2806, e.g., over one or more bands supported by node 2820.

In an example, communications may comprise a wireless device receiving a signal from node 2860 (e.g., a base station, a gNB-DU, a TRP, an RRH, an RRU, etc.) and/or a wireless device transmitting a signal to node 2860 (e.g., a base station, a gNB-DU, a TRP, an RRH, an RRU, etc). The signal may be referred to as a physical signal and/or a physical channel. The physical signal and the physical channel are according to the example embodiments in FIG. 26 (e.g., the physical signal and the physical channel).

In an example, node 2820 may further receive, from node 2840, a measurement request. The measurement request may indicate, node 2860 hosted by node 2820, to determine a predicted measurement e.g., predicted measurement 2808. Node 2820 may receive the measurement request via an NRPPa message. An example of the measurement request may be a positioning measurement request. The measurement request is according to the example embodiments in FIG. 26 (e.g., the measurement request).

In an example, the measurement request may comprise information associated with a carrier frequency. The information associated with the carrier frequency is according to the example embodiments in FIG. 26 (e.g., the information associated with the carrier frequency).

In an example, the measurement request may further indicate a reliability level of predicted measurement 2808 to be predicted by node 2860 (hosted by node 2820). The reliability level is according to the example embodiments in FIG. 26 (e.g., the reliability level).

Referring to the example embodiments in FIG. 28, node 2860 (hosted by node 2820) may predict predicted measurement 2808 based on a model. In an example, the model is according to the example embodiments in FIG. 17. Node 2820 may obtain, from node 2860, a result of predicted measurement 2808. In one example, node 2820 may receive, from node 2860, the result predicted measurement 2808. In another example, node 2820 and node 2860 may be geographically located at the same site or same location. In this example, node 2820 may retrieve, from a memory of node 2860, the result of predicted measurement 2808.

Referring to the example embodiments in FIG. 28, node 2820 may further use the result of predicted measurement 2808 for one or more tasks. The one or more tasks are according to the example embodiments in FIG. 26 (e.g., the one or more tasks).

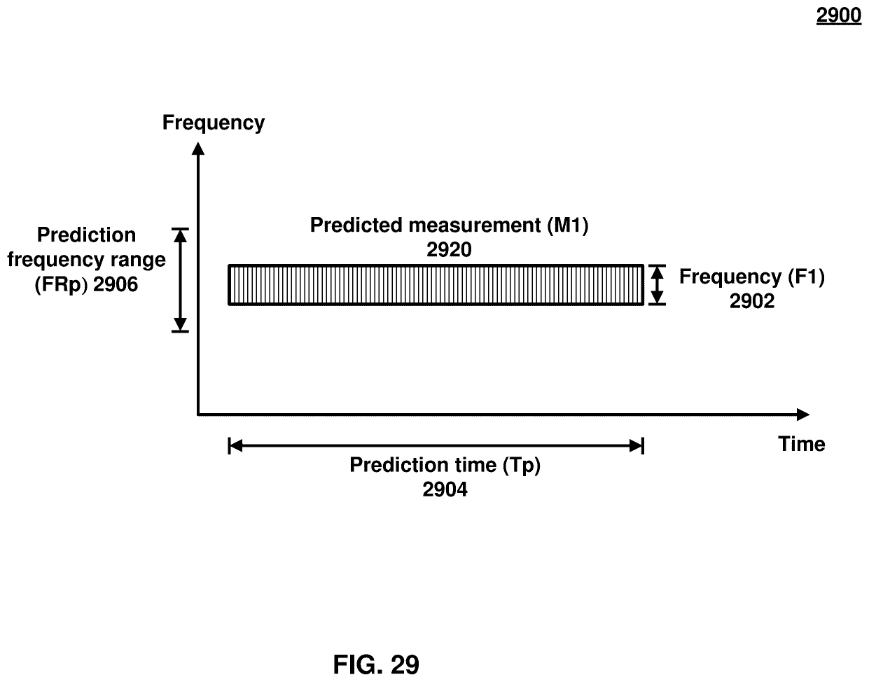

FIG. 29 illustrates an example of a predicted measurement procedure 2900 as per an aspect of an embodiment of the present disclosure. The features illustrated in FIG. 29 may be combined with the features previously discussed with reference to FIGS. 17, 18, 19, 20, 21, 22, 23, 24A, 24B, 25, 26, 27, and/or 28.

For example, example embodiments in FIG. 29 illustrate an example of a predicted measurement (M1) 2920. For example, M1 2920 may be predicted over a frequency (F1) 2902 and over a prediction time (Tp) 2904. F1 2902 may be within a prediction frequency range (FRP) 2906. In an example, M1 2920 is according to the example embodiments in FIGS. 26, 27, and/or 28 (e.g., predicted measurement 2606, predicted measurement 2706, and/or predicted measurement 2808). In an example, FRp 2906 is according to the example embodiments in FIGS. 26, 27, and/or 28 (e.g., frequency range 2604, frequency range 2704, and/or frequency range 2806).

In an example, Tp 2904 may be associated with or depend on a type of M1 2920. In another example, Tp 2904 may be associated with (or depend on) the type of a reference signal associated with M1 2604. In another example, Tp 2904 may be associated with (or depend on or related to) a purpose or an application of M1 2920. In another example, Tp 2904 may be associated with or depend on a confidence interval of M1 2920. In an example, the type of M1 2920, the type of the reference signal associated with the M1 2920, the purpose or use or application of M1 2920, and the confidence interval are according to the example embodiments in FIGS. 26, 27, and/or 28 (e.g., the type of predicted measurement 2606, the type of the reference signal associated with predicted measurement 2606, the purpose of predicted measurement 2606, the confidence interval associated with predicted measurement 2606).

Referring to FIG. 29, in an example, Tp 2904 may be pre-defined. In another example, setup request 2602 (e.g., in FIG. 26), configuration update 2702 (e.g., in FIG. 27), or information response 2804 (e.g., in FIG. 28) may further include information about Tp 2904.

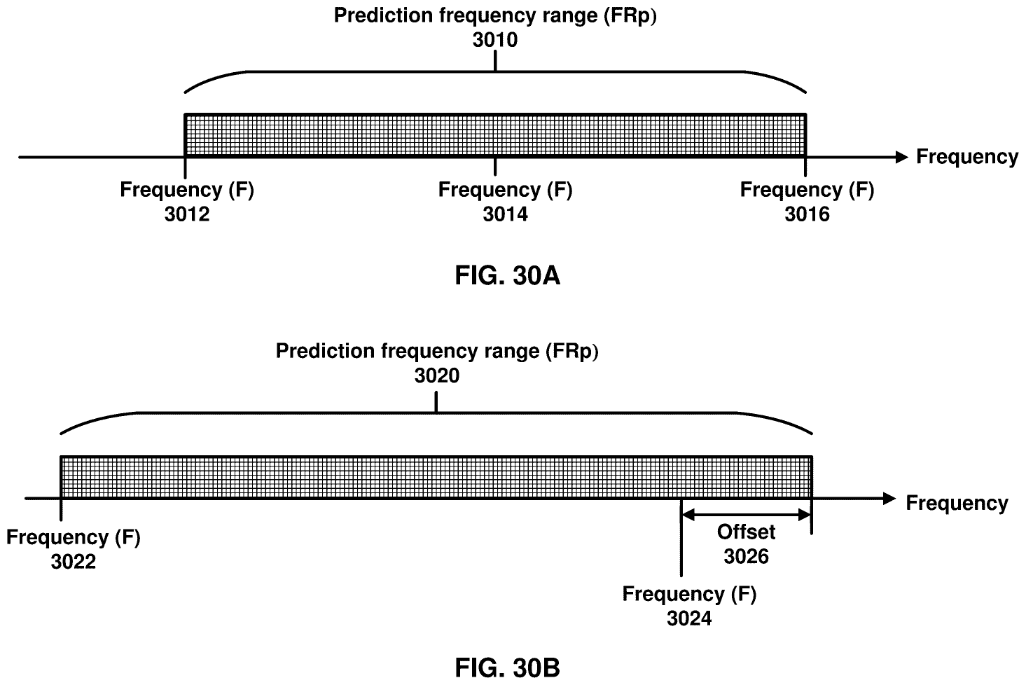

FIG. 30A illustrates an example of a prediction frequency range (FRp) 3010 as per an aspect of an embodiment of the present disclosure. The features illustrated in FIG. 30A may be combined with the features previously discussed with reference to FIGS. 17, 18, 19, 20, 21, 22, 23, 24A, 24B, 25, 26, 27, 28, and/or 29.

For example, example embodiments in FIG. 30A illustrate an example of a location of FRp 3010 over a frequency, e.g., in a frequency domain. FIG. 30A illustrates an example indicating a bandwidth of FRp 3010. In an example, a Frequency (F) 3012 indicates the lowest frequency of FRp 3010. In an example, a Frequency (F) 2716 indicates the highest frequency of FRp 3010. In an example, a Frequency (F) 3014 indicates the center frequency of FRp 3010. For example, the bandwidth of FRp 3010 may be determined based on a function of (or a relation between) F 3012, F 3016, and/or F 3014. For example, the bandwidth of FRp 3010 may be a difference between F 3012 and F 3016. In another example, the bandwidth of FRp 3010 may be a magnitude of a difference between F 3012 and F 3016.

Referring to FIG. 30A, in an example, setup request 2602 (e.g., in FIG. 26), configuration update 2702 (e.g., in FIG. 27), or information response 2804 (e.g., in FIG. 28) may indicate FRp 3010 and F 3014. In another example, setup request 2602 (e.g., in FIG. 26), configuration update 2702 (e.g., in FIG. 27), or information response 2804 (e.g., in FIG. 28) may indicate FRp 3010, F 3012, and F 3016. In another example, setup request 2602 (e.g., in FIG. 26), configuration update 2702 (e.g., in FIG. 27), or information response 2804 (e.g., in FIG. 28) may indicate FRp 3010, F 3012, F 3014, and F 3016. An indication indicating F 3012, F 3014, and/or F 3016 may comprise their respective frequency channel numbers e.g., their respective ARFCNs, or NR-ARFNCs. In an example, the indication indicating FRp 3010 may be a bandwidth, or a band, of FRp 3010. In an example, FRp 3010 is according to the example embodiments in FIGS. 26, 27, and/or 28 (e.g., frequency range 2604, frequency range 2704, and/or frequency range 2806).

FIG. 30B illustrates an example of a prediction frequency range (FRp) 3020 as per an aspect of an embodiment of the present disclosure. The features illustrated in FIG. 30B may be combined with the features previously discussed with reference to FIGS. 17, 18, 19, 20, 21, 22, 23, 24A, 24B, 25, 26, 27, 28, 29 and/or 30A.

For example, example embodiments in FIG. 30B illustrate an example of a location of FRp 3020 over a frequency, e.g., in a frequency domain. FIG. 30B illustrates an example indicating a bandwidth of FRp 3020. In an example, a Frequency (F) 3022 indicates the lowest frequency of FRp 3020. In an example, a Frequency (F) 3024 indicates a frequency that is higher than F 3022 and that is within FRp 3020. In an example, an offset 3026 indicates an offset (or a frequency offset) relative to (e.g., from or with respect to) F 3024. For example, the bandwidth of FRp 3020 may be determined based on F 3022, F 3024, and offset 3026. For example, the bandwidth of FRp 3020 may be determined based on a function of F 3022, F 3024, and offset 3026. In another example, the bandwidth of FRp 3020 may be a summation of offset 3026 and a difference between F 3022 and F 3024 (e.g., BW of FRp 3020=offset 3026+F 3022-F 3024). In another example, the bandwidth of FRp 3020 may be a summation of offset 3026 and a magnitude of a difference (e.g., an absolute value of the difference) between F 3022 and F 3024, and offset 3026 (e.g., BW of FRp 3020=offset 3026+|F 3022-F 3024|).

Referring to FIG. 30B, setup request 2602 (e.g., in FIG. 26), configuration update 2702 (e.g., in FIG. 27), or information response 2804 (e.g., in FIG. 28) may indicate FRp 3020, F 3024, and/or offset 3026. In another example, offset 2026 may be pre-defined. In an example, offset 3026 may depend on (or be associated with) a frequency band (e.g., FR1 bands 2420 in FIG. 24A, or FR2 bands 2440 in FIG. 24B). In another example, offset 3026 may depend on (or be associated with) NR frequency ranges 2300 (e.g., FR1 2320, FR2 2340, FR2-1 2310, or FR2-2 2312 in FIG. 23). An indication indicating F 3022 and F 3024 may include their respective frequency channel numbers e.g., their respective ARFCNs, NR-ARFCNs etc. The indication indicating FRp 3020 may comprise a bandwidth, or a band. The indication indicating offset 3026 may comprise a bandwidth, e.g., in terms of frequency units (e.g., K11 MHz), or a number of resource blocks (e.g., a K12 number of resource blocks). FRp 3020 is according to the example embodiments in FIGS. 26, 27, and/or 28 (e.g., frequency range 2604, frequency range 2704, and/or frequency range 2806).

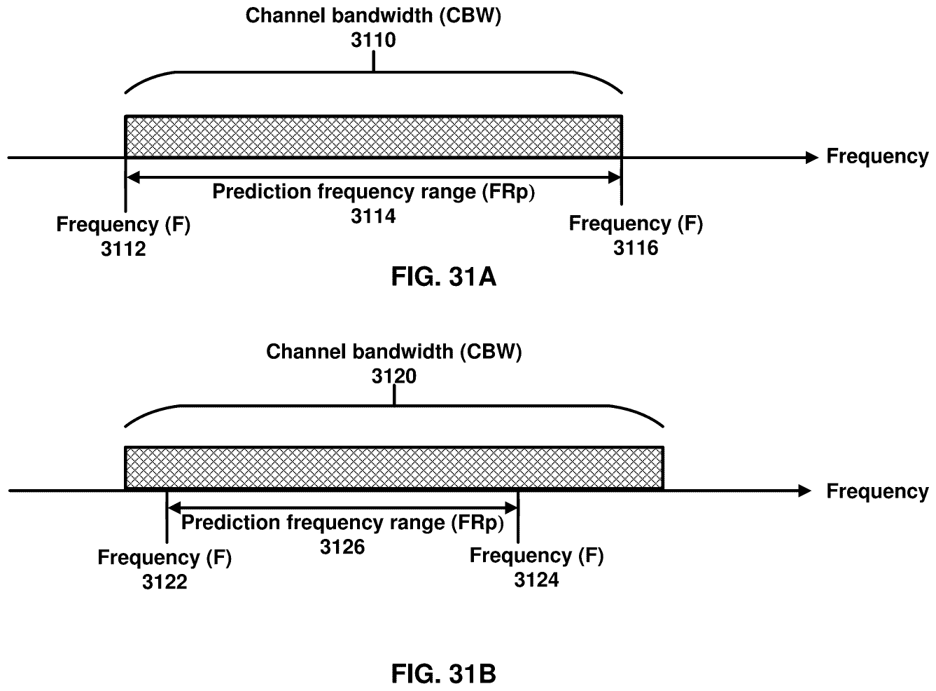

FIG. 31A illustrates an example of a relation between a channel bandwidth (CBW) 3110 and a prediction frequency range (FRp) 3114 as per an aspect of an embodiment of the present disclosure. The features illustrated in FIG. 31A may be combined with the features previously discussed with reference to FIGS. 17, 18, 19, 20, 21, 22, 23, 24A, 24B, 25, 26, 27, 28, 29, 30A, and/or 30B.

For example, example embodiments in FIG. 31A illustrate an example of a bandwidth of FRp 3114 being equal to CBW 3110. For example, a frequency (F) 3112 may be the starting frequency of CBW 3110 and the starting frequency of FRp 3114. For example, a frequency (F) 3116 may be the last (or ending) frequency of CBW 3110 and the last (or ending) frequency of FRp 3114. In an example, CBW 3110 may be a channel bandwidth of a node (e.g., node 2620 in FIG. 26, node 2720 in FIG. 27, or node 2860 in FIG. 28). In an example, CBW 3110 may start at a frequency 2000 MHz and may end at a frequency 2100 MHz. In this example, CBW 3110 corresponds to 100 MHz. In an example, FRp 3114 may also start at 2000 MHz and may end at 2100 MHz. In this example, a bandwidth of FRp 3114 corresponds to CBW 3110, e.g., 100 MHz.

In an example, FRp 3114 is according to the example embodiments in FIGS. 26, 27, and/or 28 (e.g., frequency range 2604, frequency range 2704, and/or frequency range 2806). For example, FRp 3114 may correspond to frequency range 2604, frequency range 2704, and/or frequency range 2806 in the example embodiments in FIGS. 26, 27, and/or 28, respectively. For example, setup request 2602 (e.g., in FIG. 26) may indicate that FRp 3114 corresponds to CBW 3110 (e.g., of node 2620). For example, configuration update 2702 (e.g., in FIG. 27) may indicate that FRp 3114 corresponds to CBW 3110 (e.g., of node 2720). For example, information response 2804 (e.g., in FIG. 28) may indicate that FRp 3114 corresponds to CBW 3110 (e.g., of node 2860).

FIG. 31B illustrates an example of a relation between a channel bandwidth (CBW) 3120 and a prediction frequency range (FRp) 3126 as per an aspect of an embodiment of the present disclosure. The features illustrated in FIG. 31B may be combined with the features previously discussed with reference to FIGS. 17, 18, 19, 20, 21, 22, 23, 24A, 24B, 25, 26, 27, 28, 29, 30A, 30B, and/or 31A.

For example, example embodiments in FIG. 31B illustrate an example of FRp 3126 being within CBW 3120. CBW 3120 is according to the example embodiments in FIG. 31A (e.g., CBW 3110). As shown in FIG. 31B, a frequency (F) 2822 is the lowest frequency of FRp 3126, and a frequency (F) 3124 is the highest frequency of FRp 3126. FRp 3126 may be a difference between F 3122 and F 3124. As shown in FIG. 31B, FRp 3126 being smaller than CBW 3120. In one example, FRp 3126 may be located anywhere (in frequency domain) within CBW 3120. In another example, F 3122 may be the starting frequency of CBW 3120. In this example, the starting frequencies of FRp 3126 and CBW 3120 are the same. In another example, F 3124 may be the last (or ending) frequency of the CBW 3120. In this example, the last (or ending) frequencies of the FRp 3126 and CBW 3120 are the same. FRp 3126 may comprise a bandwidth e.g., in number of resource blocks or in a unit of frequency (e.g., Z11 MHz). The frequencies F 3122 and F 3124 may be indicated by their respective frequency channel numbers e.g., by their respective ARFCNs, NR-ARFNCs etc.

In an example, setup request 2602 (e.g., in FIG. 26) may indicate frequency range 2604 (e.g., in FIG. 26) by including a bandwidth of FRp 3126 and F 3122, a bandwidth of FRp 3126 and F 3124, or a bandwidth of F 3122 and the F 3124. In an example, configuration update 2702 (e.g., in FIG. 27) may indicate frequency range 2704 (e.g., in FIG. 27) by including a bandwidth of FRp 3126 and F 3122, a bandwidth of FRp 3126 and F 3124, or a bandwidth of F 3122 and the F 3124. In an example, information response 2804 (e.g., in FIG. 28) may indicate frequency range 2806 (e.g., in FIG. 28) by including a bandwidth of FRp 3126 and F 3122, a bandwidth of FRp 3126 and F 3124, or a bandwidth of F 3122 and F 3124.

FIG. 32A illustrates an example of a relation between a band 3210 and a prediction frequency range (FRp) 3212 as per an aspect of an embodiment of the present disclosure. The features illustrated in FIG. 32A may be combined with the features previously discussed with reference to FIGS. 17, 18, 19, 20, 21, 22, 23, 24A, 24B, 25, 26, 27, 28, 29, 30A, 30B, 31A, and/or 31B.

For example, example embodiments in FIG. 32A illustrate an example of a bandwidth of FRp 3214 being equal to band 3210. For example, a frequency (F) 3212 may be the starting frequency of band 3210, and as well as the starting frequency of FRp 3214. For example, a frequency (F) 3216 may be the last (or ending) frequency of band 3210, and as well as the last (or ending) frequency of FRp 3214. In an example, band 3210 may be a band supported by a node (e.g., node 2620 in FIG. 26, node 2720 in FIG. 27, or node 2860 in FIG. 28). Band 3210 is according to the example embodiments in FIG. 24A (e.g., FR1 bands 2420) or in FIG. 24B (e.g., FR2 bands 2440). The indication of band 3210 is according to the example embodiments in FIGS. 24A, and/or 24B (e.g., the band identifier or the band indicator).

In an example, FRp 3214 is according to the example embodiments in FIGS. 26, 27, and/or 28 (e.g., frequency range 2604, frequency range 2704, and/or frequency range 2806). In an example, setup request 2602 (e.g., in FIG. 26), configuration update 2702 (e.g., in FIG. 27), or information response 2804 (e.g., in FIG. 28) may indicate band 3210 as FRp 3214.

FIG. 32B illustrates an example of a relation between a band 2920 and a prediction frequency range (FRp) 3226 as per an aspect of an embodiment of the present disclosure. The features illustrated in FIG. 32B may be combined with the features previously discussed with reference to FIGS. 17, 18, 19, 20, 21, 22, 23, 24A, 24B, 25, 26, 27, 28, 29, 30A, 30B, 31A, 31B, and/or 32A.

For example, example embodiments in FIG. 32B illustrate FRp 3226 being within band 3220. For example, a frequency (F) 3222 may be the starting (or lowest) frequency of FRp 3226, and a frequency (F) 3224 may be the last (or ending) frequency of FRp 3226. Band 3220 is according to the example embodiments in FIG. 24A (e.g., FR1 bands 2420), or FIG. 24B (e.g., FR2 bands 2440). In an example, FRp 3226 may be determined based on F 3222 and F 3224. In an example, FRp 3226 may be a difference between F 3222 and F 3224. In an example, FRp 3226 may be a magnitude of a difference between F 3222 and F 3224. In an example, band 3220 may be a band supported by a node (e.g., node 2620 in FIG. 26, node 2720 in FIG. 27, or node 2860 in FIG. 28). The indication indicating band 3220 is according to the example embodiments in FIG. 23A or FIG. 23B (e.g., the band identifier or the band indicator). FRp 3226 may comprise a bandwidth e.g., in number of resource blocks, in a unit of frequency (e.g., Z11 MHz). The indication indicating F 3222 and F 3224 may comprise their respective frequency channel numbers e.g., their respective ARFCNs, NR-ARFCNs, etc.

In an example, setup request 2602 (e.g., in FIG. 26), configuration update 2702 (e.g., in FIG. 27), and/or information response 2804 (e.g., in FIG. 28) may indicate band 3220, F 3222, and F 3224. In another example, setup request 2602 (e.g., in FIG. 26), configuration update 2702 (e.g., in FIG. 27), and/or information response 2804 (e.g., in FIG. 28) may indicate band 3220, a bandwidth of FRp 3226, and F 3222. In another example, setup request 2602 (e.g., in FIG. 26), configuration update 2702 (e.g., in FIG. 27), and/or information response 2804 (e.g., in FIG. 28) may indicate band 3220, a bandwidth of FRp 3226, and F 3224.

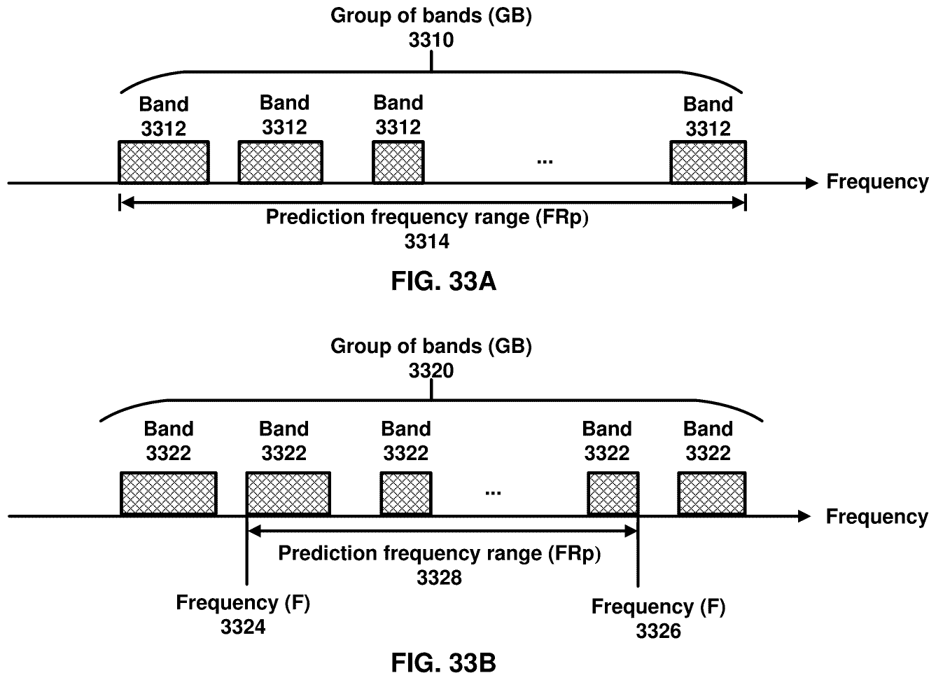

FIG. 33A illustrates an example of a relation between a group of bands (GB) 3310 and a prediction frequency range (FRP) 3314 as per an aspect of an embodiment of the present disclosure. The features illustrated in FIG. 33A may be combined with the features previously discussed with reference to FIGS. 17, 18, 19, 20, 21, 22, 23, 24A, 24B, 25, 26, 27, 28, 29, 30A, 30B, 31A, 31B, 32A, and/or 32B.

For example, example embodiments in FIG. 33A illustrate FRp 3314 comprising a GB 3310. FIG. 33A illustrates GB 3310 comprising two or more bands, of two or more bands 3312. Band 3312 is according to the example embodiments in FIG. 24A (e.g., FR1 bands 2420), or FIG. 24B (e.g., FR2 bands 2440). In an example, the indication indicating GB 3310 may comprise identifiers (or band indicators) of the two or more bands, of two or more bands 3312. The information about band 3312 is according to the example embodiments in FIG. 24A, or FIG. 24B (e.g., the band identifier or the band indicator).

In an example, FRp 3314 is according to the example embodiments in FIGS. 26, 27, and/or 28 (e.g., frequency range 2604, frequency range 2704, and/or frequency range 2806). In an example, setup request 2602 (e.g., in FIG. 26), configuration update 2702 (e.g., in FIG. 27), or information response 2804 (e.g., in FIG. 28) may indicate GB 3310 as FRp 3314.

FIG. 33B illustrates an example of a relation between a group of bands (GB) 3120 and a prediction frequency range (FRp) 3328 as per an aspect of an embodiment of the present disclosure. The features illustrated in FIG. 33B may be combined with the features previously discussed with reference to FIGS. 17, 18, 19, 20, 21, 22, 23, 24A, 24B, 25, 26, 27, 28, 29, 30A, 30B, 31A, 31B, 32A, 32B, and/or 33A.

For example, example embodiments in FIG. 33B illustrate FRp 3328 being within GB 3320. FIG. 33B illustrates GB 3320 may comprise two or more bands, of two or more bands 3322. FIG. 33B illustrates, a frequency (F) 3324 being the starting frequency of FRp 3328, and a frequency (F) 3326 being the last (or ending) frequency of FRp 3328. In an example, FRp 3328 may be determined based on F 3324 and F 3326. For example, FRp 3328 may comprise two or more bands, of two or more bands 3322 within F 3324 and F 3326. In an example, FRp 3328 may be a difference between F 3324 and F 3326. In an example, FRp 3328 may be a magnitude of a difference between F 3324 and F 3326.

The indication of F 3324 and F 3326 may comprise their respective frequency channel numbers e.g., their respective ARFCNs, NR-ARFCNs, etc. Band 3322 is according to the example embodiments in FIG. 24A (e.g., FR1 bands 2420), or FIG. 24B (e.g., FR2 bands 2440). In another example, the indication indicating GB 3320 may comprise identifiers (or band indicators) of the two or more bands, of two or more bands 3322. In another example, the indication indicating GB 3320 may comprise identifiers (or band indicators) of the two or more bands, of two or more bands 3322, and the frequency channel numbers (e.g., ARFCNs. NR-ARFCNs, etc.) of F 3324 and F 3326.

In an example, FRp 3328 is according to the example embodiments in FIGS. 26, 27, and/or 28 (e.g., frequency range 2604, frequency range 2704, and/or frequency range 2806). In an example, setup request 2602 (e.g., in FIG. 26), configuration update 2702 (e.g., in FIG. 27), or information response 2804 (e.g., in FIG. 28) may indicate F 3324 and F 3326 as FRp 3328.

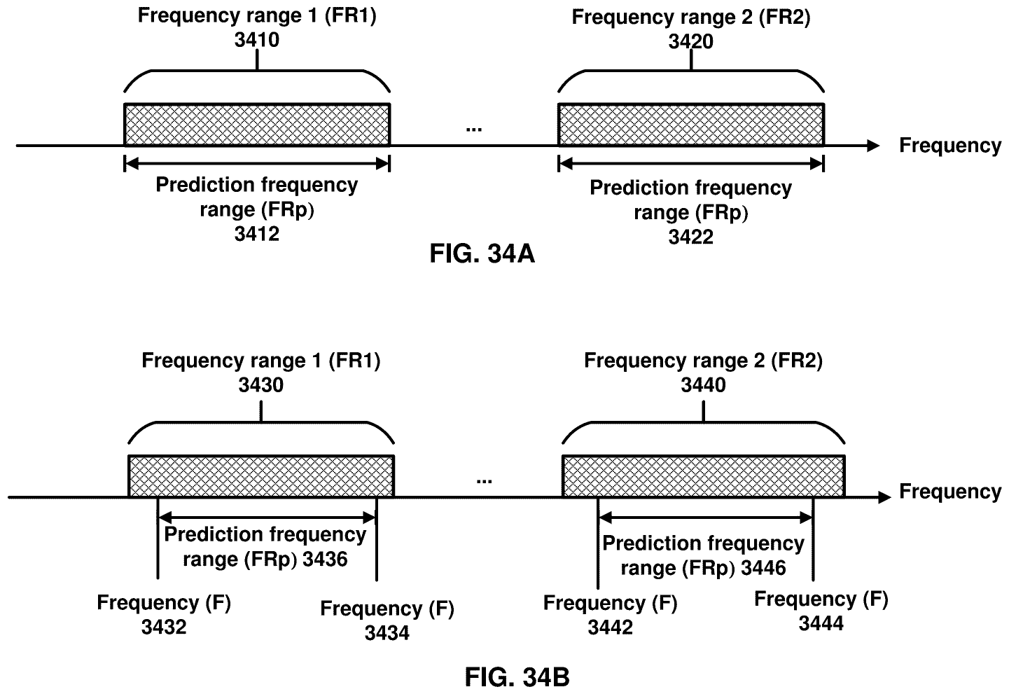

FIG. 34A illustrates an example of a relation between a frequency range 1 (FR1) 3410 and a prediction frequency range (FRp) 3412, or between a frequency range 2 (FR2) 3420 and a prediction frequency range (FRp) 3422 as per an aspect of an embodiment of the present disclosure. The features illustrated in FIG. 34A may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, and/or 33B.

For example, example embodiments in FIG. 34A illustrate FRp 3412 corresponding to FR1 3410, or FRp 3422 corresponding to FR2 3420. FR1 3410 is according to the example embodiments in FIG. 23 (e.g., FR1 2320). FR2 3420 is according to the example embodiments in FIG. 23 (e.g., FR2 2340). For example, FRp 3412 may span over the entire FR1 3410, and FRp 3422 may span over the entire FR2 3440.

In an example, FRp 3412, and/or FRp 3422 are according to the example embodiments in FIGS. 26, 27, and/or 28 (e.g., frequency range 2604, frequency range 2704, and/or frequency range 2806). In an example, setup request 2602 (e.g., in FIG. 26), configuration update 2702 (e.g., in FIG. 27), or information response 2804 (e.g., in FIG. 28) may indicate a relation between FRp 3412 and FR1 3410, and/or a relation between FRp 3422 and FR2 3420. For example, the relation may indicate that FRp 3412 is over the entire FR1 3410, and/or FRp 3422 is over the entire FR2 3420.

FIG. 34B illustrates an example of a relation between a frequency range 1 (FR1) 3430 and a prediction frequency range (FRp) 3436, or between a frequency range 2 (FR2) 3440 and a prediction frequency range (FRp) 3446 as per an aspect of an embodiment of the present disclosure. The features illustrated in FIG. 34B may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, and/or 34A.

For example, example embodiments in FIG. 34B illustrate FRp 3436 being within FR1 3430, or FRp 3446 being within FR2 3440. For example, a frequency (F) 3432 may be the starting frequency of FRp 3436, and a frequency (F) 3434 may be the last (or ending) frequency of FRp 3436. For example, a frequency (F) 3442 may be the starting frequency of the FRp 3446, and a frequency (F) 3444 may be the last (or ending) frequency of FRp 3446. In an example, FRp 3436 may be determined based on F1 3432 and F 3434. In an example, FRp 3436 may be a difference between F1 3432 and F 3434. In an example, FRp 3436 may be a magnitude of a difference between F1 3432 and F 3434. In an example, FRp 3446 may be determined based on F1 3442 and F 3444. In an example, FRp 3446 may be a difference between F1 3442 and F 3444. In an example, FRp 3446 may be a magnitude of a difference between F1 3442 and F 3444. FR1 3430 is according to the example embodiments in FIG. 23 (e.g., FR1 2320). FR2 3440 is according to the example embodiments in FIG. 23 (e.g., FR2 2340). An indication indicating FRp 3436, or FRp 3446 may comprise a bandwidth e.g., in number of resource blocks, in a unit of frequency (e.g., Z11 MHz). An indication indicating frequencies F 3432, F 3434, F 3442, and F 3444 may comprise their respective frequency channel numbers e.g., their respective ARFCNs, NR-ARFCNs, etc.

In an example, FRp 3436, and/or FRp 3446 are according to the example embodiments in FIGS. 26, 27, and/or 28 (e.g., frequency range 2604, frequency range 2704, and/or frequency range 2806). In an example, setup request 2602 (e.g., in FIG. 26), configuration update 2702 (e.g., in FIG. 27), or information response 2804 (e.g., in FIG. 28) may indicate a bandwidth of FRp 3436 and F 3432. In an example, setup request 2602 (e.g., in FIG. 26), configuration update 2702 (e.g., in FIG. 27), or information response 2804 (e.g., in FIG. 28) may indicate a bandwidth of FRp 3436 and F 3434. In an example, setup request 2602 (e.g., in FIG. 26), configuration update 2702 (e.g., in FIG. 27), or information response 2804 (e.g., in FIG. 28) may indicate F 3432 and F 3434. In an example, setup request 2602 (e.g., in FIG. 26), configuration update 2702 (e.g., in FIG. 27), or information response 2804 (e.g., in FIG. 28) may indicate a bandwidth of FRp 3446 and F 3442. In an example, setup request 2602 (e.g., in FIG. 26), configuration update 2702 (e.g., in FIG. 27), or information response 2804 (e.g., in FIG. 28) may indicate a bandwidth of FRp 3446 and F 3444. In an example, setup request 2602 (e.g., in FIG. 26), configuration update 2702 (e.g., in FIG. 27), or information response 2804 (e.g., in FIG. 28) may indicate F 3442 and F 3444.

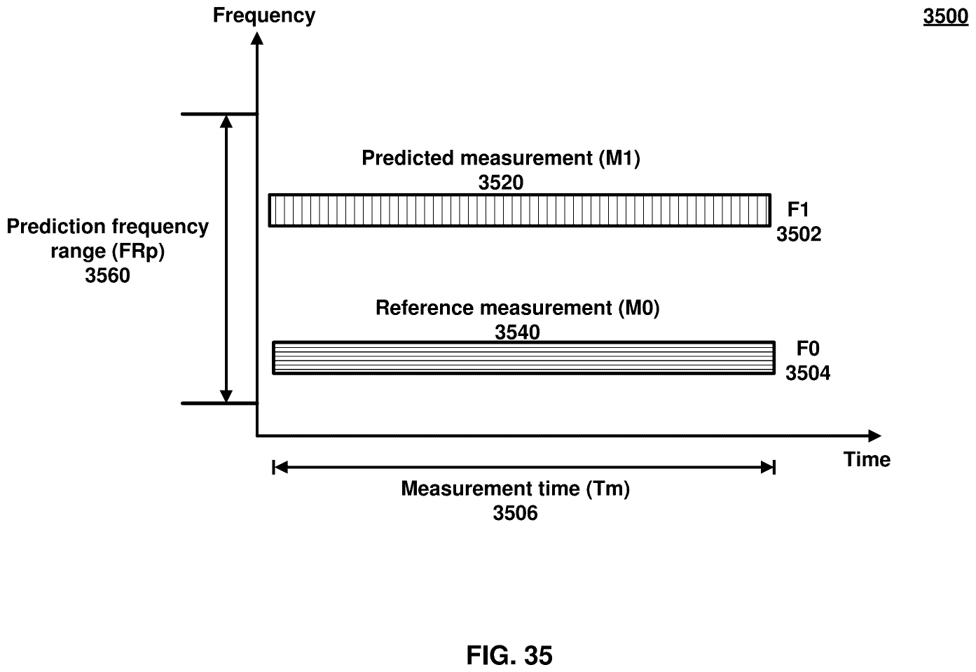

FIG. 35 illustrates an example of a predicted measurement (M1) 3520 and a reference measurement (M0) 3540 as per an aspect of an embodiment of the present disclosure. The features illustrated in FIG. 35 may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, and/or 34B.

For example, example embodiments in FIG. 35 illustrates M1 3520 being predicted on a frequency F1 3502 within a prediction frequency range (FRp) 3560. FIG. 35 illustrates M0 3540 being performed on a frequency F0 3504, and over a measurement time (Tm) 3506. In this example, F0 3508 being also within FRp 3560. M1 3520 is according to the example embodiments in FIG. 26 (e.g., predicted measurement 2606), in FIG. 27 (e.g., predicted measurement 2706), and/or in FIG. 28 (e.g., predicted measurement 2808). M0 3540 is according to the example embodiments in FIG. 22 (e.g., Mm 2200). Tm 3506 is according to the example embodiments in FIG. 22 (e.g., Tm 2202). For example, a node (e.g., node 2620 in FIG. 26, node 2720 in FIG. 27, or node 2860 in FIG. 28) may perform M0 3540 on a reference signal on F0 3504 within FRp 3560, and over Tm 3506.

In the example embodiments in FIG. 35, setup request 2602 (e.g., in FIG. 26) may indicate that node 2620 (e.g., in FIG. 26) is capable of using M0 3540 performed on F0 3504 within FRp 3560, to predict (or determine or infer) M1 3520 on F1 3502 within FRp 3560.

In the example embodiments in FIG. 35, configuration update 2702 (e.g., in FIG. 27) may indicate that node 2720 (e.g., in FIG. 27) is capable of using M0 3540 performed on F0 3504 within FRp 3560, to predict (or determine or infer) M1 3520 on F1 3502 within FRp 3560.

In the example embodiments in FIG. 35, information response 2804 (e.g., in FIG. 28) may indicate that node 2860 (e.g., in FIG. 28) is capable of using M0 3540 performed on F0 3504 within FRp 3560, to predict (or determine or infer) M1 3520 on F1 3502 within FRp 3560.

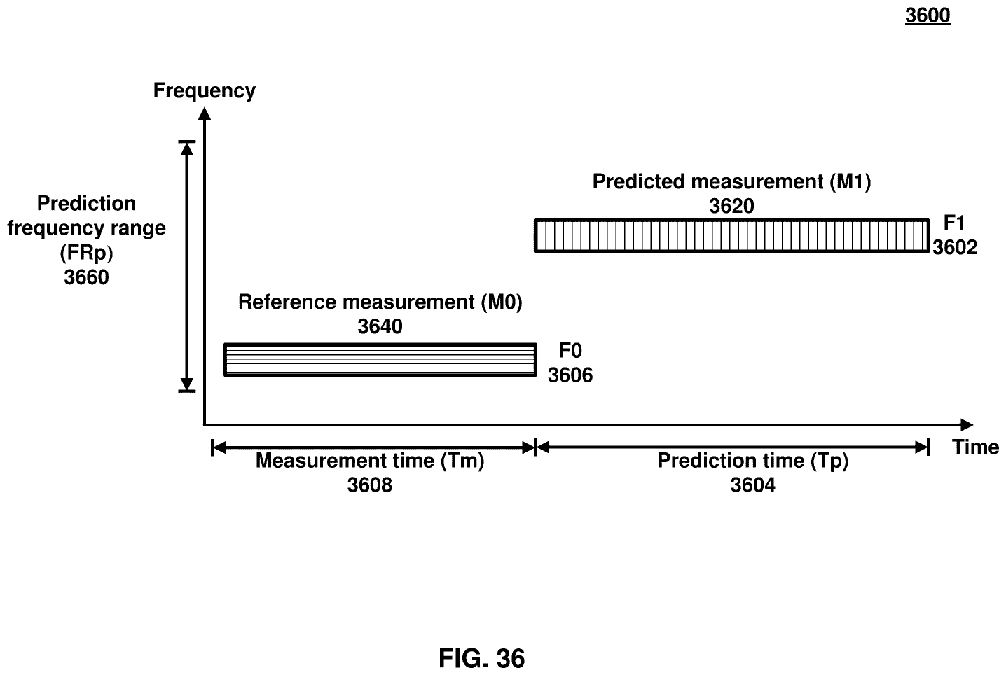

FIG. 36 illustrates an example of a predicted measurement (M1) 3620 and a reference measurement (M0) 3640 as per an aspect of an embodiment of the present disclosure. The features illustrated in FIG. 36 may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, and/or 35.

For example, example embodiments in FIG. 36 illustrate M1 3620 being predicted on a frequency F1 3602 within a prediction frequency range (FRp) 3660. FIG. 36 further illustrates M1 3620 being predicted over a prediction time (Tp) 3604. FIG. 36 illustrates a reference measurement (M0) 3640 being performed on a frequency F0 3606, and over measurement time (Tm) 3608. In this example, F0 3606 being also within FRp 3660. For example, a node (e.g., node 2620 in FIG. 26, node 2720 in FIG. 27, or node 2860 in FIG. 28) may perform M0 3640 on F0 3606, over Tm 3608. Tm 3608 is according to the example embodiments in FIG. 22 (e.g., the Tm 2202). M1 3620 is according to the example embodiments in FIG. 26 (e.g., predicted measurement 2606), in FIG. 27 (e.g., predicted measurement 2706), and/or in FIG. 28 (e.g., predicted measurement 2808). Tp 3604 may start based on a completion of M0 3640. For example, Tp 3604 may start after Tm 3608. For example, Tp 3604 may start from the completion of M0 3640 e.g., from the end of Tm 3608. Tp 3604 is according to the example embodiments in FIG. 25 (e.g., Tp 2504). M0 3640 is according to the example embodiments in FIG. 22 (e.g., Mm 2200). For example, a node (e.g., node 2620 in FIG. 26, node 2720 in FIG. 27, or node 2860 in FIG. 28) may perform M0 3240 on a reference signal on F0 within FRp 3660, and over Tm 3208.

In the example embodiments in FIG. 36, setup request 2602 (e.g., in FIG. 26) may indicate that node 2620 (e.g., in FIG. 26) is capable of using M0 3640 performed on F0 3606 within FRp 3660, to predict (or determine or infer) M1 3620 on F1 3602 within FRp 3660, and over Tp 3604.

In the example embodiments in FIG. 36, configuration update 2702 (e.g., in FIG. 27) may indicate that node 2720 (e.g., in FIG. 27) is capable of using M0 3640 performed on F0 3606 within FRp 3660, to predict (or determine or infer) M1 3620 on F1 3602 within FRp 3660, and over Tp 3604.

In the example embodiments in FIG. 36, information response 2804 (e.g., in FIG. 28) may indicate that node 2860 (e.g., in FIG. 28) is capable of using M0 3540 performed on F0 3504 within FRp 3560, to predict (or determine or infer) M1 3520 on F1 3502 within FRp 3560, and over Tp 3604.

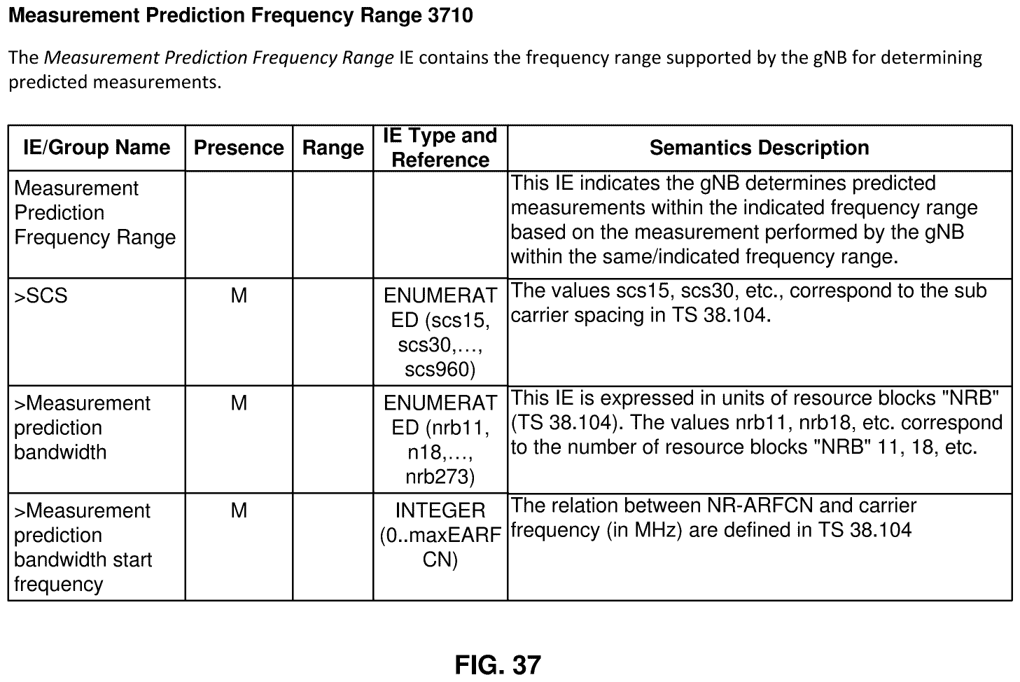

FIG. 37 illustrates an example of Measurement Prediction Frequency Range 3710 as per an aspect of an embodiment of the present disclosure. The features illustrated in FIG. 37 may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, 35, and/or 36.

For example, example embodiments in FIG. 37 illustrate an example of a definition of a frequency range for a predicted measurement (e.g., Measurement Prediction Frequency Range in FIG. 37). For example, Measurement Prediction Frequency Range 3710 may indicate a subcarrier spacing (SCS), a measurement prediction bandwidth and a measurement prediction start frequency. For example, a frequency range for a predicted measurement may correspond to the measurement prediction bandwidth (e.g., in FIG. 37). The starting frequency of the frequency range for the predicted measurement may be determined based on the measurement prediction start frequency (e.g., in FIG. 37). The subcarrier spacing of the frequency range for the predicted measurement may be determined based on the SCS (e.g., in FIG. 37). The definition of the frequency range for the predicted measurement (e.g., Measurement Prediction Frequency Range 3710) may be defined (or specified or included) in TS 38.473, TS 38.455, TS 38.423, and/or TS 38.413. For example, Measurement Prediction Frequency Range 3710 may be an XnAP, an F1AP, an NGAP, or an NRPPa message.

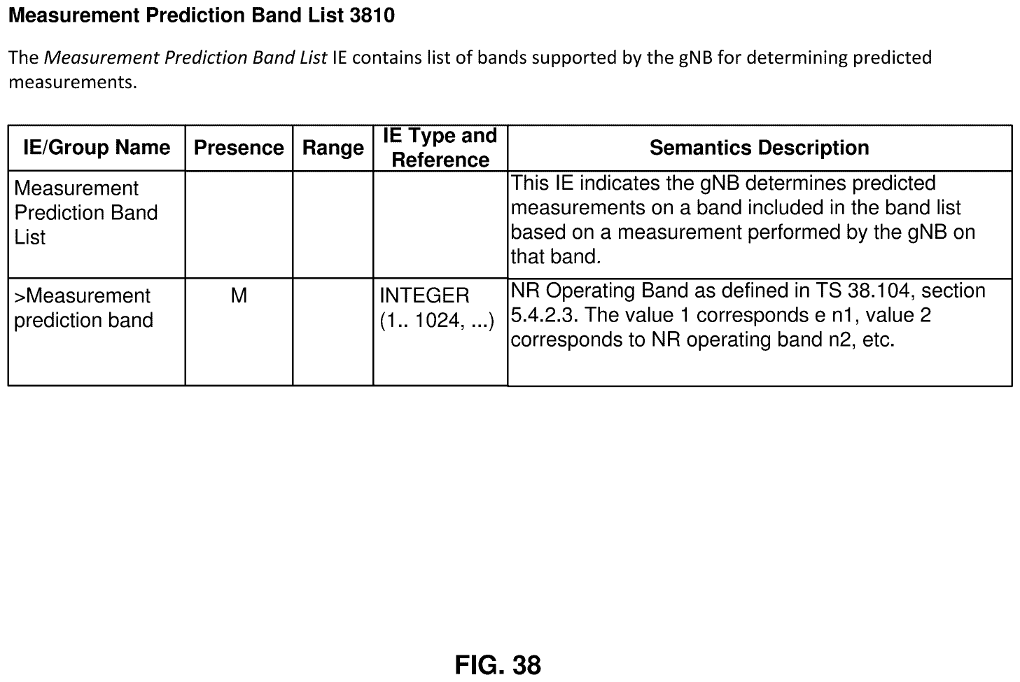

FIG. 38 illustrates an example of Measurement Prediction Band List 3810 as per an aspect of an embodiment of the present disclosure. The features illustrated in FIG. 38 may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, 35, 36, and/or 37.

For example, example embodiments in FIG. 38 illustrate an example of a definition of a frequency range for a predicted measurement (e.g., Measurement Prediction Band List in FIG. 38). For example, Measurement Prediction Band List 3810 may indicate one or more bands e.g., measurement prediction band (e.g., in FIG. 38). For example, the frequency range for the predicted measurement may correspond to one or more bands included in the measurement prediction band (e.g., in FIG. 38). The definition of the frequency range for the predicted measurement (e.g., Measurement Prediction Band List 3810) may be defined (or specified or included) in TS 38.473, TS 38.455, TS 38.423, and/or TS 38.413. For example, Measurement Prediction Band List 3810 may be an XnAP, an NGAP, an F1AP, or an NRPPa message.

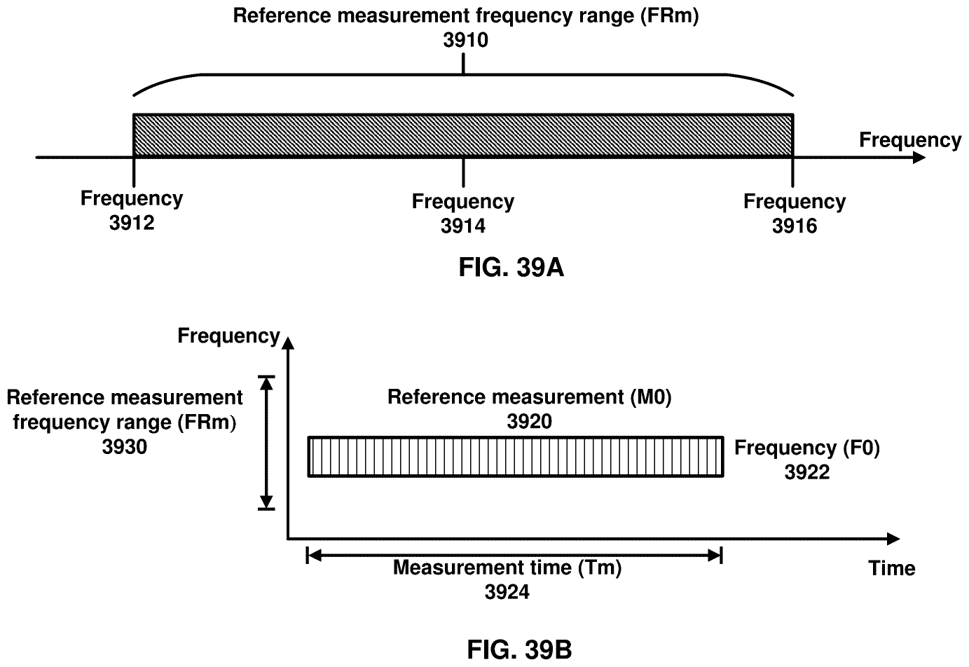

FIG. 39A illustrates an example of a reference measurement frequency range (FRm) 3910 as per an aspect of an embodiment of the present disclosure. The features illustrated in FIG. 39A may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, 35, 36, 37, and/or 38.

For example, example embodiments in FIG. 39A illustrate an example of a location of FRm 3910 over a frequency e.g., in a frequency domain. FIG. 39A illustrates an example indicating a bandwidth of FRm 3910. In an example, a frequency (F) 3912 indicates the lowest/starting frequency of FRm 3910. In an example, a frequency (F) 3916 indicates the highest/ending/last frequency of FRm 3910. In an example, a frequency (F) 3914 indicates the center frequency of FRm 3910. For example, the bandwidth of FRm 3910 may be determined based on F 3912, F 3916, and/or F 3914. For example, the bandwidth of FRm 3910 may be a difference between F 3912 and F 3916. In another example, the bandwidth of FRm 3910 may be a magnitude of a difference between the F 3912 and the F 3916. In an example, the bandwidth of FRm 3910 may correspond to a band.

In the example embodiments in FIG. 39A, setup request 2602 (e.g., in FIG. 26) may indicate F 3912 and F 3916, or a bandwidth of FRm 3910 and F 3914, or a bandwidth of FRm 3910 and F 3912, or a bandwidth of FRm 3910 and F 3916.

In the example embodiments in FIG. 39A, configuration update 2702 (e.g., in FIG. 27) may indicate F 3912 and F 3916, or a bandwidth of FRm 3910 and F 3914, or a bandwidth of FRm 3910 and F 3912, or a bandwidth of FRm 3910 and F 3916.

In the example embodiments in FIG. 39A, information response 2804 (e.g., in FIG. 28) may indicate F 3912 and F 3916, or a bandwidth of FRm 3910 and F 3914, or a bandwidth of FRm 3910 and F 3912, or a bandwidth of FRm 3910 and F 3916.

FIG. 39B illustrates an example of a reference measurement frequency range (FRm) 3930 for a reference measurement (M0) 3920 as per an aspect of an embodiment of the present disclosure. The features illustrated in FIG. 39B may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, 35, 36, 37, 38, and/or 39A.

For example, example embodiments in FIG. 39B illustrate an example of M0 3920 being performed by a node. A frequency (F0) 3922 may be a carrier frequency. A measurement time (Tm) 3924 may be a measurement time (e.g., Tm 2202 in FIG. 22). For example, the node (e.g., node 2620 in FIG. 26, node 2720 in FIG. 27, and/or node 2860 in FIG. 28) may perform M0 3922 on F0 3922, and over Tm 3924. For example, node 2720 in FIG. 27, and/or node 2860 in FIG. 28) may perform M0 3922 over Tm 3926. As shown in FIG. 39B, F0 3924 may be within FRm 3930. M0 3924 is according to the example embodiments in FIG. 22 (e.g., Mm 2200), and/or in FIG. 25 (e.g., M0 2520), and/or in FIG. 35 (e.g., M0 3540). F0 3922 is according to the example embodiments in FIG. 25 (e.g., F1 2560) and/or in FIG. 35 (e.g., F0 3504). T0 3924 is according to the example embodiments in FIG. 22 (e.g., Tm 2202).

In the example embodiments in FIG. 39A, setup request 2602 (e.g., in FIG. 26) may indicate FRm 3930. In an example, configuration update 2702 (e.g., in FIG. 27) may indicate FRm 3930. In the example, information response 2804 (e.g., in FIG. 28) may indicate FRm 3930.

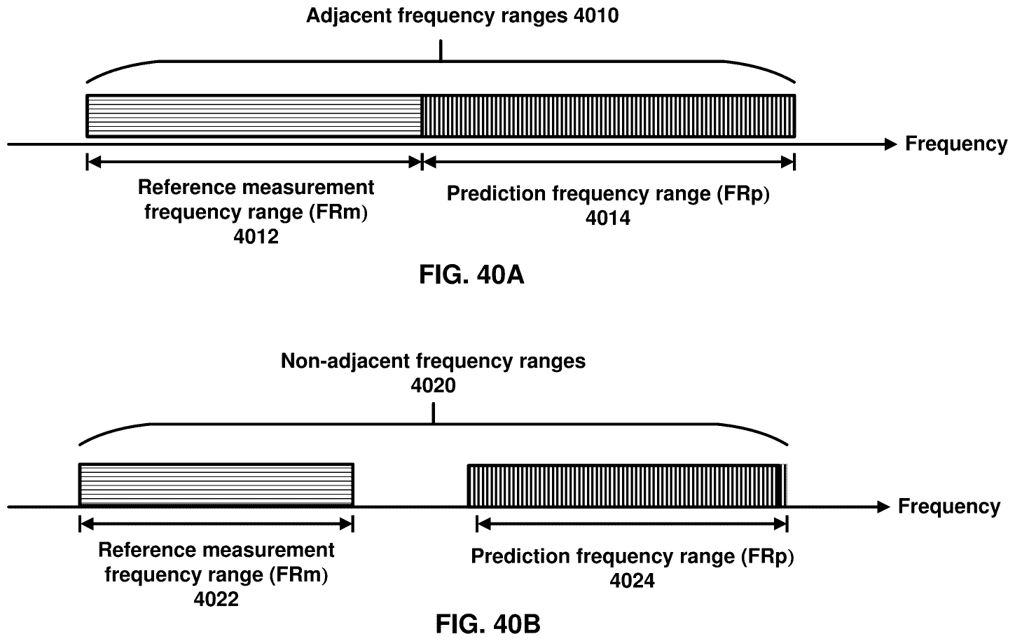

FIG. 40A illustrates an example of an adjacent frequency ranges 4010 for a reference measurement and a predicted measurement as per an aspect of an embodiment of the present disclosure. The features illustrated in FIG. 40A may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, 35, 36, 37, 38, 39A, and/or 39B.

For example, example embodiments in FIG. 40A illustrate an example of a reference measurement frequency range (FRm) 4012 and a prediction frequency range (FRp) 4014. As illustrated in FIG. 40A, FRm 4012 and FRp 4014 may be adjacent (or contiguous or continuous) to each in a frequency domain. In an example, the lowest/starting frequency of the FRp 4014 may be adjacent to the highest/ending/last frequency of FRm 4012 in frequency domain. In another example, the lowest/starting frequency of FRp 4014 may be adjacent to the highest/ending/last frequency of FRm 4012 in frequency domain. Adjacent frequency ranges 4010 may also be referred to as contiguous frequency ranges, or continuous frequency ranges, intra-band contiguous frequency ranges, or intra-band frequency ranges.

Referring to FIG. 40A, FRm 4012 is according to the example embodiments in FIG. 36A (e.g., FRm 3610), in FIG. 36B (e.g., FRm 3620), in FIG. 39A (e.g., FRm 3910), and/or in FIG. 39B (e.g., FRm 3930). Referring to FIG. 40A, FRp 4014 is according to the example embodiments in FIG. 26 (e.g., frequency range 2604), in FIG. 27 (e.g., frequency range 2704), in FIG. 28 (e.g., frequency range 2806), in FIG. 29 (e.g., FRp 2906), in FIG. 30A (e.g., FRp 3010), in FIG. 30B (e.g., FRp 3020), in FIG. 31A (e.g., FRp 3114), in FIG. 31B (e.g., FRp 3126), in FIG. 32A (e.g., FRp 3214), in FIG. 32B (e.g., FRp 3226), in FIG. 33A (e.g., FRp 3314), in FIG. 33B (e.g., FRp 3328), in FIG. 34A (e.g., FRp 3412, and/or FRp 3422), in FIG. 34B (e.g., FRp 3436, and/or FRp 3446), in FIG. 35 (e.g., FRp 3560), in FIG. 36 (e.g., FRp 3660), in FIG. 37 (e.g., Measurement Prediction Frequency Range 3710), and/or in FIG. 38 (e.g., Measurement Prediction Band List 3810).

In the example embodiments in FIG. 40A, setup request 2602 (e.g., in FIG. 26) may indicate FRm 4012, and FRp 4014 may be adjacent to each other in frequency domain. In an example, configuration update 2702 (e.g., in FIG. 27) may indicate FRm 4012, and FRp 4014 may be adjacent to each other in frequency domain. In the example, information response 2804 (e.g., in FIG. 28) may indicate FRm 4012, and FRp 4014 may be adjacent to each other in frequency domain.

FIG. 40B illustrates an example of a non-adjacent frequency ranges 4020 for a reference measurement, and a predicted measurement as per an aspect of an embodiment of the present disclosure. The features illustrated in FIG. 40A may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, 35, 36, 37, 38, 39A, 39B, and/or 40A.

For example, example embodiments in FIG. 40B illustrate an example of a reference measurement frequency range (FRm) 4022 and a prediction frequency range (FRp) 4024. As illustrated in FIG. 40B, FRm 4022 and FRp 4024 may be separated by each other in a frequency domain by a frequence gap. The frequency gap may comprise one or more frequency resources. Examples of the frequency resource may be a subcarrier, a resource block, or a carrier frequency. For example, the lowest/starting frequency of the FRp 4024 may not be adjacent to the highest/ending/last frequency of FRm 4022 in frequency domain. In another example, the lowest/starting frequency of FRp 4024 may not be adjacent to the highest/ending/last frequency of FRm 4022 in frequency domain. Non-adjacent frequency ranges 4020 may also be referred to as non-contiguous frequency ranges, or non-continuous frequency ranges, inter-band contiguous frequency ranges, or inter-band frequency ranges.

Referring to FIG. 40A, FRm 4022 is according to the example embodiments in FIG. 36A (e.g., FRm 3610), in FIG. 36B (e.g., FRm 3620), in FIG. 39A (e.g., FRm 3910), and/or in FIG. 39B (e.g., FRm 3930).

Referring to FIG. 40B, FRp 4024 is according to the example embodiments in FIG. 26 (e.g., frequency range 2604), in FIG. 27 (e.g., frequency range 2704), in FIG. 28 (e.g., frequency range 2806), in FIG. 29 (e.g., FRp 2906), in FIG. 30A (e.g., FRp 3010), in FIG. 30B (e.g., FRp 3020), in FIG. 31A (e.g., FRp 3114), in FIG. 31B (e.g., FRp 3126), in FIG. 32A (e.g., FRp 3214), in FIG. 32B (e.g., FRp 3226), in FIG. 33A (e.g., FRp 3314), in FIG. 33B (e.g., FRp 3328), in FIG. 34A (e.g., FRp 3412, and/or FRp 3422), in FIG. 34B (e.g., FRp 3436, and/or FRp 3446), in FIG. 35 (e.g., FRp 3560), in FIG. 36 (e.g., FRp 3660), in FIG. 37 (e.g., Measurement Prediction Frequency Range 3710), and/or in FIG. 38 (e.g., Measurement Prediction Band List 3810).

In the example embodiments in FIG. 40B, setup request 2602 (e.g., in FIG. 26) may indicate FRm 4022, and FRp 4024 may not be adjacent to each other in frequency domain. In an example, configuration update 2702 (e.g., in FIG. 27) may indicate FRm 4022, and FRp 4024 may not be adjacent to each other in frequency domain. In the example, information response 2804 (e.g., in FIG. 28) may indicate FRm 4022, and FRp 4024 may not be adjacent to each other in frequency domain.

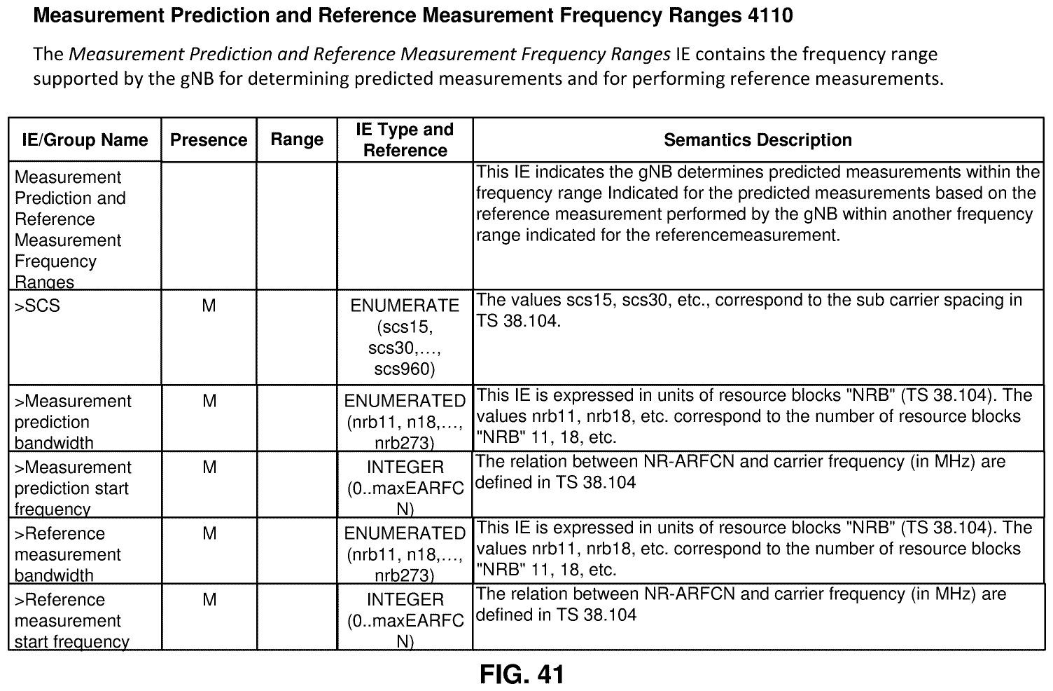

FIG. 41 illustrates an example of Measurement Prediction and Reference Measurement Frequency Ranges 4110 as per an aspect of an embodiment of the present disclosure. The features illustrated in FIG. 41 may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, 35, 36, 37, 38, 39A, 39B, 40A, and/or 40B.

For example, example embodiments in FIG. 41 illustrate an example of a definition of a frequency range for a predicted measurement, and a frequency range for a reference measurement (e.g., Measurement Prediction and Reference Measurement Frequency Ranges in FIG. 41). For example, Measurement Prediction and Reference Measurement Frequency Ranges 4110 may indicate a subcarrier spacing (SCS), a measurement prediction bandwidth, a measurement prediction start frequency, a reference measurement bandwidth and a reference measurement start frequency. For example, a frequency range for a predicted measurement may correspond to the measurement prediction bandwidth (e.g., in FIG. 41). The starting frequency of the frequency range for the predicted measurement (e.g., measurement prediction bandwidth in FIG. 41) may be determined based on the measurement prediction start frequency (e.g., in FIG. 41). The starting frequency of the frequency range for the reference measurement (e.g., reference measurement bandwidth in FIG. 41) may be determined based on the reference measurement start frequency (e.g., in FIG. 41). The subcarrier spacing of the frequency range for the predicted measurement may be determined based on the SCS (e.g., in FIG. 41). The subcarrier spacing of the frequency range for the for the reference measurement may be determined based on the SCS (e.g., in FIG. 41). The definition of the frequency ranges for the predicted measurement and the reference measurement (e.g., Measurement Prediction and Reference Measurement Frequency Ranges 4110) may be defined (or specified or included) in TS 38.473, TS 38.455, TS 38.423, and/or TS 38.413. For example, Measurement Prediction and Reference Measurement Frequency Ranges 4110 may be an XnAP, an F1AP, an NGAP, or an NRPPa message.

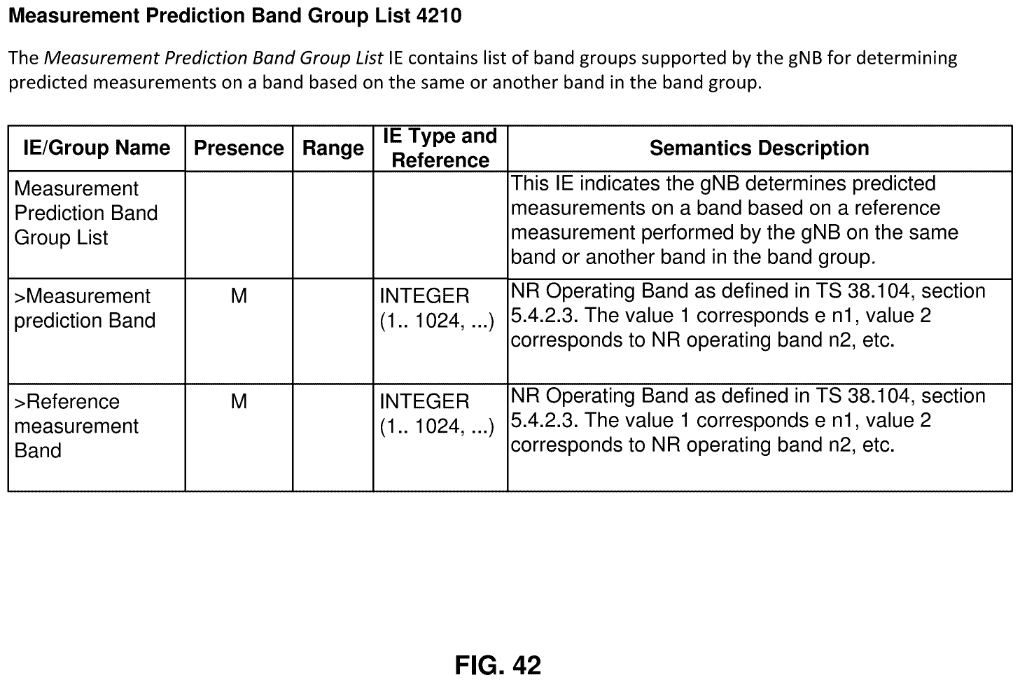

FIG. 42 illustrates an example of Measurement Prediction Band Group List 4210 as per an aspect of an embodiment of the present disclosure. The features illustrated in FIG. 42 may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, 35, 36, 37, 38, 39A, 39B, 40A, 40B, and/or 41.

For example, example embodiments in FIG. 42 illustrate an example of a definition of a frequency range for a predicted measurement, and a frequency range for a reference measurement (e.g., Measurement Prediction Band Group List in FIG. 42). For example, Measurement Prediction Band Group List 4210 may indicate one or more bands for a predicted measurement (e.g., a measurement prediction band in FIG. 42), and one or more bands for a reference measurement (e.g., a reference measurement band in FIG. 42). For example, the frequency range for the predicted measurement may correspond to one or more bands included in the measurement prediction band (e.g., in FIG. 42). For example, the frequency range for the reference measurement may correspond to one or more bands included in the reference measurement band (e.g., in FIG. 42). The definition of the frequency range for the predicted measurement, and the frequency range for the reference measurement (e.g., Measurement Prediction Band Group List 4210) may be defined (or specified or included) in TS 38.473, TS 38.455, TS 38.423, and/or TS 38.413. For example, Measurement Prediction Band Group List 4210 may be an XnAP, an F1AP, an NGAP, or an NRPPa message.

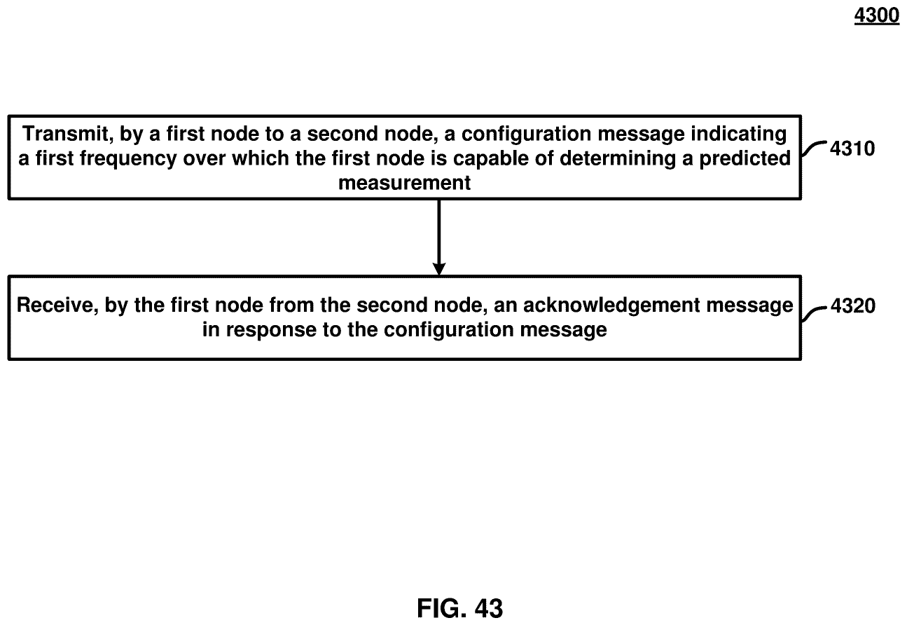

FIG. 43 illustrates an example of a process 4300 as per an aspect of an embodiment of the present disclosure. The features illustrated in FIG. 43 may be combined with the features previously discussed with reference to FIGS. 17, 18, 19, 20, 21, 22, 23, 24A, 24B, 25, 26, 27, 28, 29, 30A, 30B, 31A, 31B, 32A, 32B, 33A, 33B, 34A, 34B, 35, 36, 37, 38, 39A, 39B, 40A, 40B, 41, and/or 42.

Referring to FIG. 43, process 4300 comprises a step 4310 of transmitting, by a first node to a second node, a configuration message indicating a frequency range over which the first node is capable of determining a predicted measurement. Process 4300 further comprises a step 4320 of receiving, by the first node from the second node, an acknowledgment message in response to the configuration message.

Additional aspects, with examples, of step 4310, step 4320, and process 4300 are discussed below. Each of the additional aspects, and examples, below may be considered an embodiment. Each aspect of the embodiments may be combined with, or substituted for, the aspects of the embodiment of process 4300 illustrated in FIG. 43, such as step 4310 and/or step 4320. Furthermore, each of the additional aspects and examples below may be combined with each other.

In an example, process 4300 further comprises receiving, by the first node, one or more configuration parameters for determining the predicted measurement.

In an example, the configuration message is a setup request for an interface between the first node and the second node; and the acknowledgement message is a setup request response.

In an example, the configuration message is a configuration update for the first node; and the acknowledgement message is a configuration update acknowledgement.

In an example, the first frequency range is at least one of: a channel bandwidth of the first node; a first set of frequencies; a first band; a first group of bands; Frequency range 1 (FR1); or Frequency range 2 (FR2).

In an example, the configuration message further indicates a first reference frequency.

In an example, the first frequency range starts from the first reference frequency; ends at the first reference frequency; or is centered around the first reference frequency.

In an example, the configuration message further indicates a first low reference frequency and a first high reference frequency; and wherein the first low reference frequency is smaller than the first high reference frequency.

In an example, the first frequency range is determined based at least one of: a function of the first low reference frequency and the first high reference frequency; a difference between the first low reference frequency and the first high reference frequency; a function of the first low reference frequency, the first high reference frequency, and a first offset; or a sum of a difference between the first low reference frequency and the first high reference frequency, and a first offset.

In an example, the configuration message further indicates the first node is capable of using a reference measurement, performed on a reference signal received on a first frequency within the first frequency range, to determine a predicted measurement on a second frequency within the first frequency range.

In an example, configuration message further indicates a second frequency range over which the first node is capable of using a reference measurement, performed on a reference signal received on a second frequency within the second frequency range, to determine a predicted measurement on a first frequency within the first frequency range.

In an example, the second frequency range indicates at least one of: a channel bandwidth of the first node; a second set of frequencies; a second band; a second group of bands; Frequency Range 1 (FR1); or Frequency Range 2 (FR2).

In an example, the configuration message further indicates a third reference frequency.

In an example, the second frequency range starts from the third reference frequency; ends at the first reference frequency; or is centered around the first reference frequency.

In an example, the configuration message further indicates a second low reference frequency and a second high reference frequency, and wherein the second low reference frequency is smaller than the second high reference frequency.

In an example, the second frequency range is determined based on one or more of: a function of the second low reference frequency and the second high reference frequency; a difference between the second low reference frequency and the second high reference frequency; a function of the second low reference frequency, the second high reference frequency, and a second offset; and a sum of a difference between the second low reference frequency and the second high reference frequency, and a second offset.

In an example, the first frequency range and the second frequency range are adjacent to each other in a frequency domain.

In an example, the first frequency range and the second frequency range are not separated with respect to each other by more than a third offset in a frequency domain.

In an example, the first frequency range and the second frequency range are within Frequency Range 1 (FR1) or within Frequency Range 2 (FR2).

In an example, the configuration message further indicates a time duration for determining the predicted measurement over the first frequency range.

In an example, process 4300 further comprises determining the predicted measurement over the first frequency range during the time duration with at least a predetermined confidence interval.

In an example, process 4300 further comprises determining the at least a predetermined confidence interval based on determining a predicted measurement over the first frequency range and an ideal measurement over the first frequency range.

In an example, process 4300 further comprises determining the time duration, the first offset, the second offset or the third offset based on the first frequency range, the second frequency range, the first band, the second band, the first group of bands or the second group of bands.

In an example, process 4300 further comprises determining the time duration, the first offset, second offset, third offset the first frequency range, the second frequency range, the first band, the second band, the first group of bands or the second group of bands based on a measurement type.

In an example, the measurement type comprises a load measurement, a positioning measurement, a synchronization measurement, a mobility measurement, or a power measurement.

In an example, process 4300 further comprises determining the time duration, the first offset, the second offset, the first frequency range, the second frequency range, the first band, the second band, the first group of bands, or the second group of bands based on a radio channel characteristic.

In an example, the radio channel characteristic comprises a Doppler frequency, a Doppler spread, a multipath delay spread, or a channel coherence time.

In an example, process 4300 further comprises determining the time duration, the first offset, second offset, the first frequency range, the second frequency range, the first band, the second band, the first group of bands or the second group of bands based on a speed of the wireless device.

In an example, the first frequency, the second frequency, the third frequency, the first reference frequency, the first low reference frequency, the first high reference frequency, the second reference frequency, the second low reference frequency, the second high reference frequency, a frequency in the first set of frequencies or a frequency in the second set of frequencies comprises a frequency channel number.

In an example, the frequency channel number is an absolute radio frequency channel number (ARFCN) or an New Radio ARFCN (NR-ARFCN).

In an example, the frequency band identifier indicates the first band or the second band.

In an example, FR1 comprises frequences from 410 MHz to 7125 MHz; and FR2 comprises frequences from 24 GHz to 71 GHz.

In an example, the first node is a base station, a gNB, or a gNB distributed unit (gNB-DU)

In an example, the second node is a base station, a gNB, a gNB control unit (gNB-CU), or a location server.

In an example, the location server comprises a location management function (LMF).

In an example, the configuration message is an Xn setup request, a F1 setup request, a gNB configuration update, or a gNB-DU configuration update.

In an example, the acknowledgement message is an Xn setup request response, a F1 setup request response, a gNB configuration update acknowledgement, or a gNB-DU configuration update acknowledgement.

In an example, process 4300 further comprises determining the predicted measurement over the first frequency range based on a model.

In an example, the model is an artificial intelligence (AI) and/or machine language (ML) (AI/ML) model.

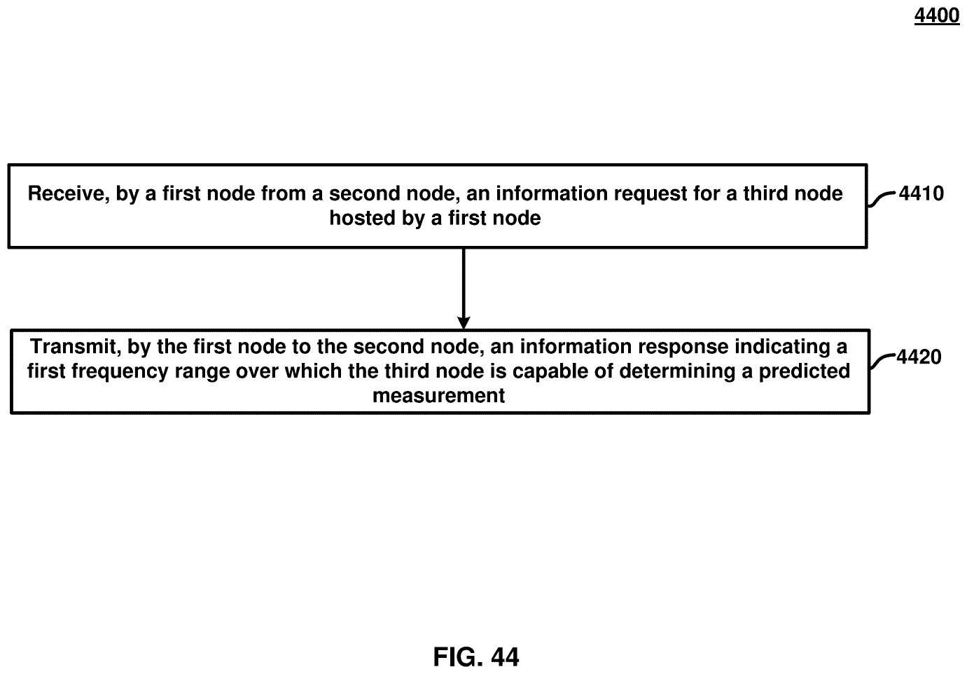

FIG. 44 illustrates an example as per an aspect of an embodiment of the present disclosure. The features illustrated in FIG. 44 may be combined with the features previously discussed with reference to FIG. 43.

Referring to FIG. 44, process 4400 comprises a step 4410 of receiving, by a first node from a second node, an information request for a third node hosted by the first node. Process 4400 further comprises a step 4420 of transmitting, by the first node to the second node, an information response indicating a first frequency range over which the third node is capable of determining a predicted measurement.

Additional aspects, with examples, of step 4410, step 4420, and process 4400 are discussed below. Each of the additional aspects, and examples, below may be considered an embodiment. Each aspect of the embodiments may be combined with, or substituted for, the aspects of the embodiment of process 4400 illustrated in FIG. 44, such as step 4410 and/or step 4420. Furthermore, each of the additional aspects and examples below may be combined with each other.

In an example, process 4400 further comprises receiving, by the first node, one or more configuration parameters for the third node for determining the predicted measurement.

In an example, the first frequency range is at least one of: a channel bandwidth of the third node; a first set of frequencies; a first band; a first group of bands; Frequency range 1 (FR1); or Frequency range 2 (FR2).

In an example, the information response further indicates a first reference frequency.

In an example, the first frequency range starts from the first reference frequency; ends at the first reference frequency; or is centered around the first reference frequency.

In an example, the information response further indicates a first low reference frequency and a first high reference frequency; and wherein the first low reference frequency is smaller than the first high reference frequency.

In an example, the information response further indicates a first low reference frequency and a first high reference frequency; and wherein the first low reference frequency is smaller than the first high reference frequency.

In an example, the first frequency range is determined based at least one of: a function of the first low reference frequency and the first high reference frequency; a difference between the first low reference frequency and the first high reference frequency; a function of the first low reference frequency, the first high reference frequency, and a first offset; or a sum of a difference between the first low reference frequency and the first high reference frequency, and a first offset.

In an example, the information response further indicates the first node is capable of using a reference measurement, performed on a reference signal received on a first frequency within the first frequency range, to determine a predicted measurement on a second frequency within the first frequency range.

In an example, the information response further indicates a second frequency range over which the first node is capable of using a reference measurement, performed on a reference signal received on a second frequency within the second frequency range, to determine a predicted measurement on a first frequency within the first frequency range.

In an example, the second frequency range indicates at least one of: a channel bandwidth of the third node; a second set of frequencies; a second band; a second group of bands; Frequency Range 1 (FR1); or Frequency Range 2 (FR2).

In an example, the information response further indicates a third reference frequency.

In an example, the second frequency range starts from the third reference frequency; ends at the first reference frequency; or is centered around the first reference frequency.

In an example, the configuration message further indicates a second low reference frequency and a second high reference frequency, and wherein the second low reference frequency is smaller than the second high reference frequency.

In an example, the second frequency range is determined based on one or more of: a function of the second low reference frequency and the second high reference frequency; a difference between the second low reference frequency and the second high reference frequency; a function of the second low reference frequency, the second high reference frequency, and a second offset; and a sum of a difference between the second low reference frequency and the second high reference frequency, and a second offset.

In an example, the first frequency range and the second frequency range are adjacent to each other in a frequency domain.

In an example, the first frequency range and the second frequency range are not separated with respect to each other by more than a third offset in a frequency domain.

In an example, the first frequency range and the second frequency range are within Frequency Range 1 (FR1) or within Frequency Range 2 (FR2).

In an example, the information response further indicates a time duration for determining the predicted measurement over the first frequency range.

In an example, process 4400 further comprises determining the predicted measurement over the first frequency range during the time duration with at least a predetermined confidence interval.

In an example, process 4400 further comprises determining the at least a predetermined confidence interval based on determining a predicted measurement over the first frequency range and an ideal measurement over the first frequency range.

In an example, process 4400 further comprises determining the time duration, the first offset, the second offset or the third offset based on the first frequency range, the second frequency range, the first band, the second band, the first group of bands or the second group of bands.

In an example, process 4400 further comprises determining the time duration, the first offset, second offset, third offset the first frequency range, the second frequency range, the first band, the second band, the first group of bands or the second group of bands based on a measurement type.

In an example, the measurement type comprises a load measurement, a positioning measurement, a synchronization measurement, a mobility measurement, or a power measurement.

In an example, process 4400 further comprises determining the time duration, the first offset, the second offset, the first frequency range, the second frequency range, the first band, the second band, the first group of bands, or the second group of bands based on a radio channel characteristic.

In an example, the radio channel characteristic comprises a Doppler frequency, a Doppler spread, a multipath delay spread, or a channel coherence time.

In an example, process 4400 further comprises determining the time duration, the first offset, second offset, the first frequency range, the second frequency range, the first band, the second band, the first group of bands or the second group of bands based on a speed of the wireless device.

In an example, the first frequency, the second frequency, the third frequency, the first reference frequency, the first low reference frequency, the first high reference frequency, the second reference frequency, the second low reference frequency, the second high reference frequency, a frequency in the first set of frequencies or a frequency in the second set of frequencies comprises a frequency channel number.

In an example, the frequency channel number is an absolute radio frequency channel number (ARFCN) or an New Radio ARFCN (NR-ARFCN).

In an example, the frequency band identifier indicates the first band or the second band.

In an example, FR1 comprises frequences from 410 MHz to 7125 MHz; and FR2 comprises frequences from 24 GHz to 71 GHz.

In an example, the first node is a base station, a gNB, or a gNB distributed unit (gNB-DU)

In an example, the second node is a base station, a gNB, a gNB control unit (gNB-CU), or a location server.

In an example, the location server comprises a location management function (LMF).

In an example, the third node is a transmission reception point (TRP), a gNB distributed unit (gNB-DU), or a remote radio head (RRH).

In an example, the information request is a new radio positioning protocol A (NRPPa) message.

In an example, the information response is a new radio positioning protocol A (NRPPa)

In an example, process 4400 further comprises determining the predicted measurement over the first frequency range based on a model.

In an example, the model is an artificial intelligence (AI) and/or machine language (ML) (AI/ML) model.

1. A method comprising:
transmitting, by a first node to a second node, a message indicating one or more of:
a reference frequency, of a reference signal, for a reference measurement by a third node hosted by the first node; and
one or more frequencies for one or more predicted measurements, by the third node, based on the reference measurement; and
receiving, by the first node from the second node, a response to the message.

2. The method of claim 1, comprising:
receiving, by the first node from the second node, an information request for the third node hosted by the first node, wherein:
the message is an information response; and
the information response is transmitted by the first node to the second node, based on receiving the information request.

3. The method of claim 1, wherein:
the message comprises one or more first parameters for the reference measurement; and
the one or more first parameters indicate the reference frequency.

4. The method of claim 3, wherein:
the message comprises one or more second parameters for the one or more predicted measurements;
the one or more second parameters indicate the one or more frequencies; and
the reference frequency and the one or more frequencies are within a channel bandwidth of a cell served by the first node.

5. The method of claim 4, wherein the message comprises a third parameter indicating a type of the one or more predicted measurements.

6. The method of claim 1, wherein the response to the message comprises one or more configuration parameters indicating at least one frequency for a predicted measurement, by the third node, based on the reference measurement.

7. The method of claim 3, wherein the one or more first parameters indicate one or more of:
a channel number of the reference frequency;
a frequency band of the reference frequency;
a cell identifier identifying the cell;
a numerology of the reference signal;
a reference signal (RS) configuration of the reference signal; and/or
an antenna configuration of the third node.

8. The method of claim 4, wherein the one or more second parameters indicate one or more of:
a first frequency range over which the third node is capable of performing the one or more predicted measurements, wherein the first frequency range includes the one or more frequencies;
a prediction capability of the third node;
a frequency band;
a frequency band group; and/or
frequency information.

9. The method of claim 8, wherein:
the one or more second parameters indicate a first reference frequency; and
the first frequency range is determined based on the first reference frequency.

10. The method of claim 5, wherein the type of the predicted measurements is one of:
a received signal level (RSL) measurement;
a timing measurement; and
an orientation measurement.

11. The method of claim 1, wherein:
the first node is a base station, a gNB, or a gNB control unit (gNB-CU);
the second node is a location server; and/or
the third node is a transmission reception point (TRP), a gNB distributed unit (gNB-DU), or a remote radio head (RRH).

12. The method of claim 1, wherein:
the one or more predicted measurements are based on a model; and
the model is an artificial intelligence (AI) and/or machine language (ML) (AI/ML) model.

13. A first node comprising:
one or more processors; and
memory storing instructions that, when executed by the one or more processors, cause the first node to:
transmit, to a second node, a message indicating one or more of:
a reference frequency, of a reference signal, for a reference measurement by a third node hosted by the first node; and
one or more frequencies for one or more predicted measurements, by the third node, based on the reference measurement; and
receiving, from the second node, a response to the message.

14. The first node of claim 13, wherein the instructions further cause the first node to:
receive, from the second node, an information request for the third node hosted by the first node, wherein:
the message is an information response; and
the information response is transmitted by the first node to the second node, based on receiving the information request.

15. The first node of claim 13, wherein:
the message comprises one or more first parameters for the reference measurement; and
the one or more first parameters indicate the reference frequency.

16. The first node of claim 15, wherein:
the message comprises one or more second parameters for the one or more predicted measurements;
the one or more second parameters indicate the one or more frequencies; and
the reference frequency and the one or more frequencies are within a channel bandwidth of a cell served by the first node.

17. The first node of claim 16, wherein the message comprises a third parameter indicating a type of the one or more predicted measurements.

18. The first node of claim 13, wherein the response to the message comprises one or more configuration parameters indicating at least one frequency for a predicted measurement, by the third node, based on the reference measurement.

19. The first node of claim 13, wherein:
the first node is a base station, a gNB, or a gNB control unit (gNB-CU);
the second node is a location server; and/or
the third node is a transmission reception point (TRP), a gNB distributed unit (gNB-DU), or a remote radio head (RRH).

20. A non-transitory computer-readable medium comprising instructions that, when executed by one or more processors of a first node, cause the first node to:
transmit, to a second node, a message indicating one or more of:
a reference frequency, of a reference signal, for a reference measurement by a third node hosted by the first node; and
one or more frequencies for one or more predicted measurements, by the third node, based on the reference measurement; and
receive, from the second node, a response to the message.
